(19) United States
(12) Patent Application Publication
(10) Pub. No.: US 2026/0032702 A1
(43) Pub. Date: Jan. 29, 2026

(54) Cyclic Prefix Extension in Sidelink Operation

(71) Applicant: Ofinno, LLC, Reston, VA (US)

(72) Inventors: Nazanin Rastegardoost, McLean, VA (US); Hyoungsuk Jeon, Centreville, VA (US); Esmael Hejazi Dinan, McLean, VA (US); Ali Cagatay Cirik, Chantilly, VA (US); Taehun Kim, Fairfax, VA (US); Gautham Prasad, Herndon, VA (US)

(73) Assignee: Ofinno, LLC, Reston, VA (US)

(21) Appl. No.: 19/349,352

(22) Filed: Oct. 3, 2025

Related U.S. Application Data
(63) Continuation of application No. PCT/US2024/023154, filed on Apr. 4, 2024.
(60) Provisional application No. 63/457,099, filed on Apr. 4, 2023.

(51) Int. Cl. H04W 72/25; H04L 27/26; H04W 72/232

(52) U.S. Cl. CPC H04W 72/25; H04L 27/2607; H04W 72/232

(57) ABSTRACT

A wireless device receives one or more configuration parameters indicating cyclic prefix extension (CPE) starting positions for physical sidelink shared channel (PSSCH) transmissions and a plurality of priorities for the PSSCH transmissions. The CPE starting positions are configured for each priority. A plurality of CPE durations are based on the CPE starting positions. The wireless device receives a physical downlink control channel (PDCCH) indicating a starting symbol of a PSSCH transmission. The wireless device determines a first symbol based on a first CPE duration. The first symbol is before the first CPE duration from the starting symbol. The first CPE duration is based on a first CPE starting position that is pre-defined. The first symbol is after a processing time from the last symbol of the PDCCH. The wireless device transmits the PSSCH transmission and a CPE with a second CPE duration.

### CROSS-REFERENCE TO RELATED APPLICATIONS

This application is a continuation of International Application No. PCT/US2024/023154, filed Apr. 4, 2024, which claims the benefit of U.S. Provisional Application No. 63/457,099, filed Apr. 4, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 illustrates examples of device-to-device (D2D) communication as per an aspect of an example embodiment of the present disclosure.

FIG. 18 illustrates an example of a resource pool for sidelink operations as per an aspect of an example embodiment of the present disclosure.

FIG. 19 illustrates an example of sidelink symbols in a slot as per an aspect of an example embodiment of the present disclosure.

FIG. 20 illustrates an example of resource indication for a first TB (e.g, a first data packet) and resource reservation for a second TB (e.g., a second data packet) as per an aspect of an example embodiment of the present disclosure.

FIG. 21 illustrates an example of configuration information for sidelink communication as per an aspect of an example embodiment of the present disclosure.

FIG. 22 illustrates an example of configuration information for sidelink communication as per an aspect of an example embodiment of the present disclosure.

FIG. 23 illustrates an example format of a MAC subheader for sidelink shared channel (SL-SCH) an aspect of an example embodiment of the present disclosure.

FIG. 24 illustrates an example time of a resource selection procedure as per an aspect of an example embodiment of the present disclosure.

FIG. 25 illustrates an example timing of a resource selection procedure as per an aspect of an example embodiment of the present disclosure.

FIG. 26 illustrates an example flowchart of a resource selection procedure by a wireless device for transmitting a TB via sidelink as per an aspect of an example embodiment of the present disclosure.

FIG. 27 illustrates an example diagram of the resource selection procedure among layers of the wireless device as per an aspect of an example embodiment of the present disclosure.

FIG. 28 illustrates an example configuration of a sidelink resource pool in a frequency band as per an aspect of an example embodiment of the present disclosure.

FIG. 29 illustrates an example configuration of a sidelink resource pool in a frequency band as per an aspect of an example embodiment of the present disclosure.

FIG. 30A and FIG. 30B and FIG. 30C show examples of supported transmission numerologies as per an aspect of an example embodiment of the present disclosure.

FIG. 31A and FIG. 31B show examples of cyclic prefix extension for transmissions as per an aspect of an example embodiment of the present disclosure.

FIG. 32 shows an example of simultaneous UL and SL transmissions as per an aspect of an example embodiment of the present disclosure.

FIG. 33 shows an example of power reduction for simultaneous UL and SL transmissions as per an aspect of an example embodiment of the present disclosure.

FIG. 34 shows an example of the sidelink CPE (CPE of a SL transmission) overlapping with an UL transmission as per an aspect of an example embodiment of the present disclosure.

FIG. 35 shows an example of sidelink and uplink transmission as per an aspect of an example embodiment of the present disclosure.

FIG. 36 shows an example of UL transmission overlapping with a CPE of a SL transmission as per an aspect of an example embodiment of the present disclosure.

FIG. 37A and FIG. 37B show an example of simultaneous UL transmission and CPE transmission of a SL transmission as per an aspect of an example embodiment of the present disclosure.

FIG. 38 shows an example of puncturing UL transmission overlapping with a SL CPE as per an aspect of an example embodiment of the present disclosure.

FIG. 39 shows an example of puncturing UL transmission overlapping with a SL CPE as per an aspect of an example embodiment of the present disclosure.

FIG. 40 shows an example of UL transmission overlapping with a SL CPE transmission as per an aspect of an example embodiment of the present disclosure.

FIG. 41 shows an example of simultaneous UL and SL transmission with CPE as per an aspect of an example embodiment of the present disclosure.

FIG. 42 shows an example of simultaneous UL and SL transmission with CPE as per an aspect of an example embodiment of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

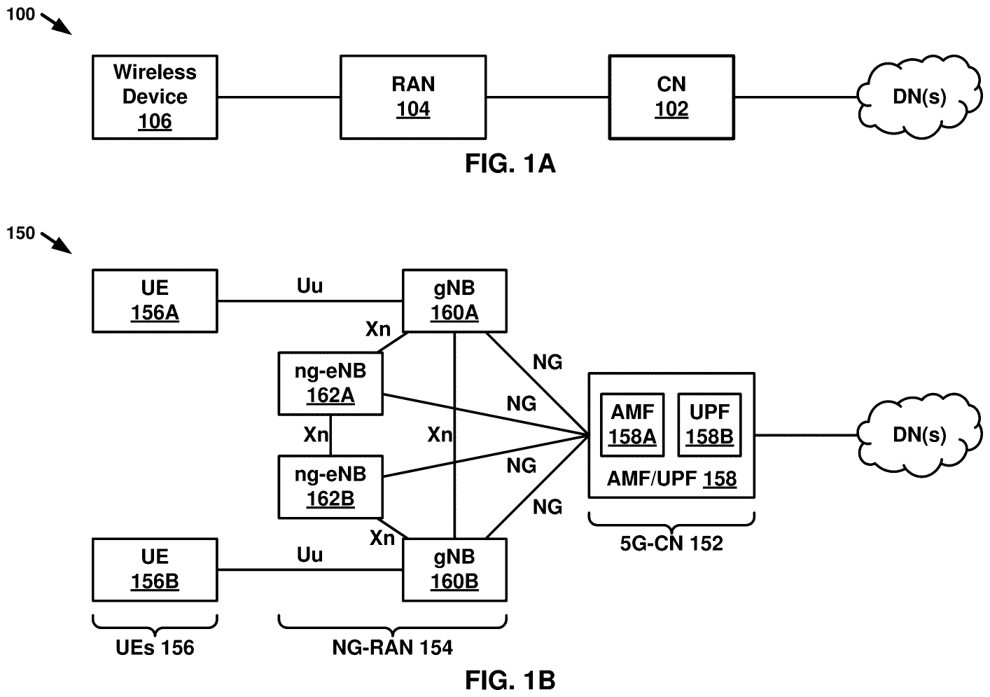

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNS (e.g., the Internet), private DNs, and/or intra-operator DNs. As part of the interface functionality, the CN 102 may set up end-to-end connections between the wireless device 106 and the one or more DNS, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, WiFi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNS, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

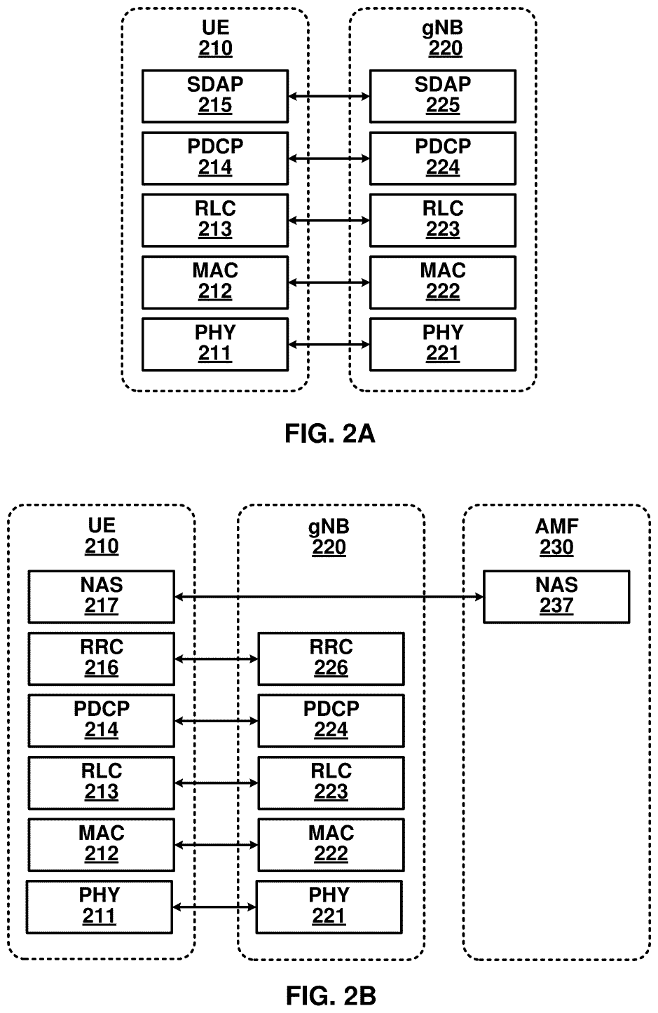

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

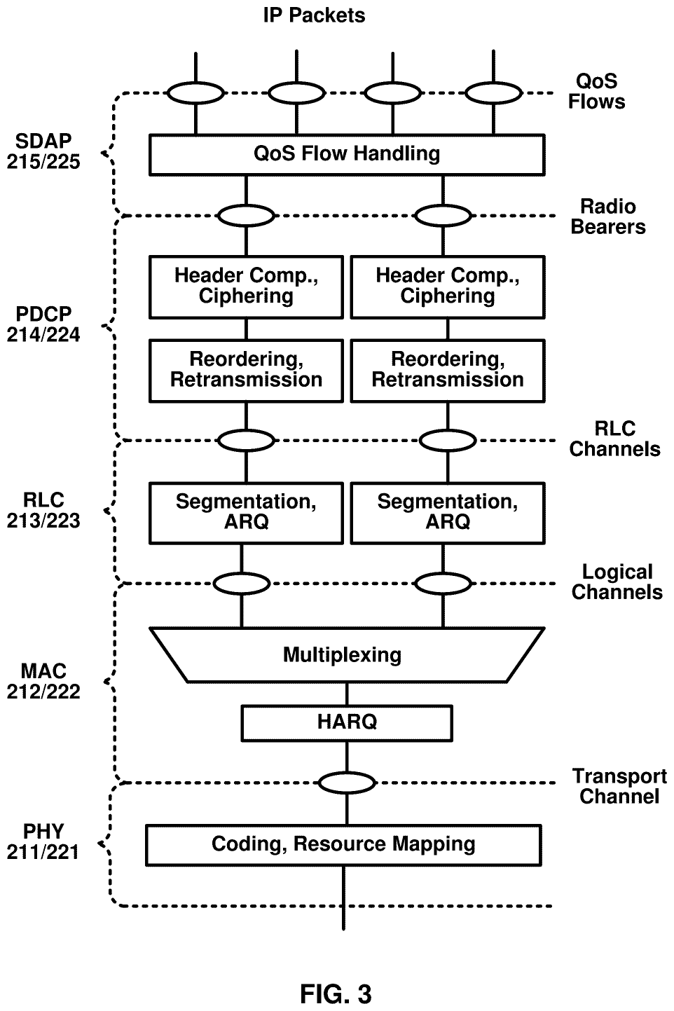

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

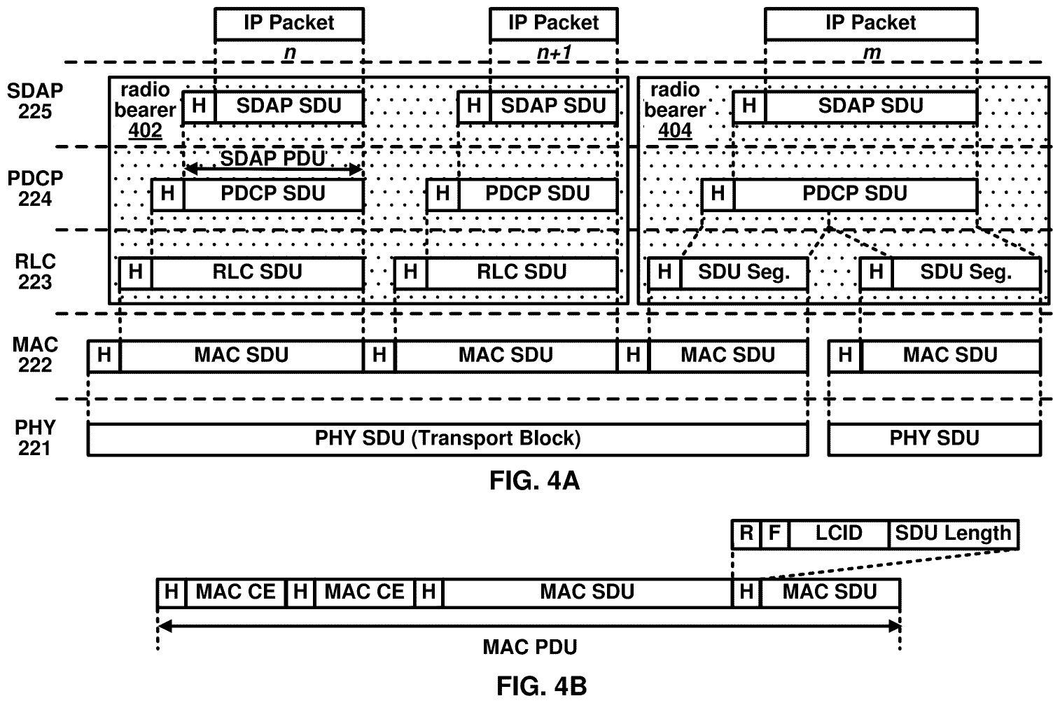

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

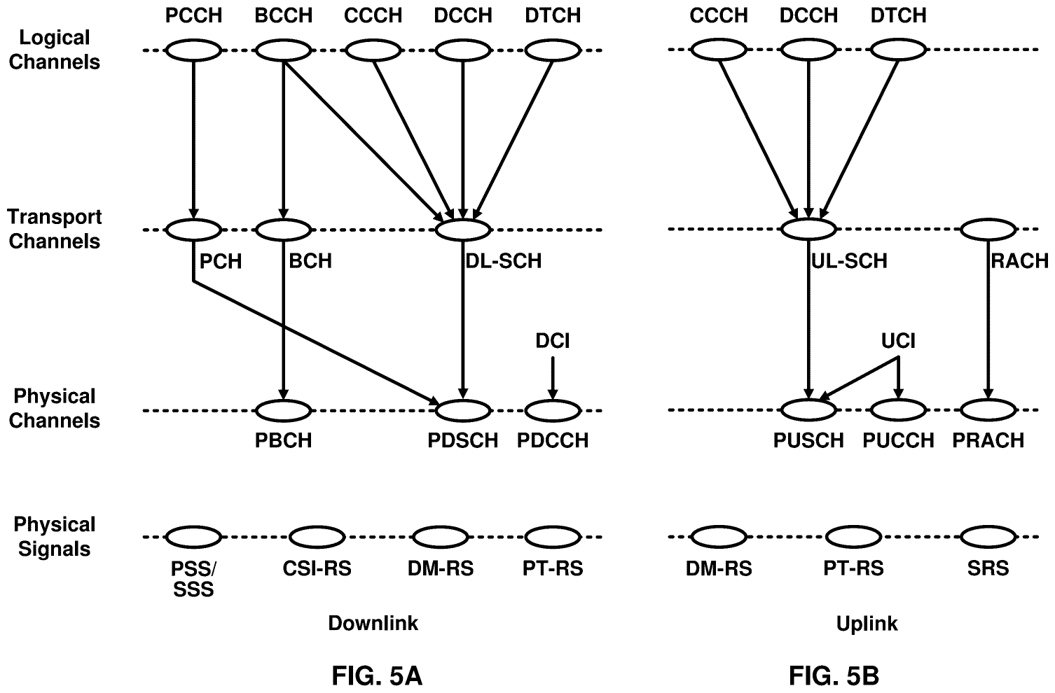

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

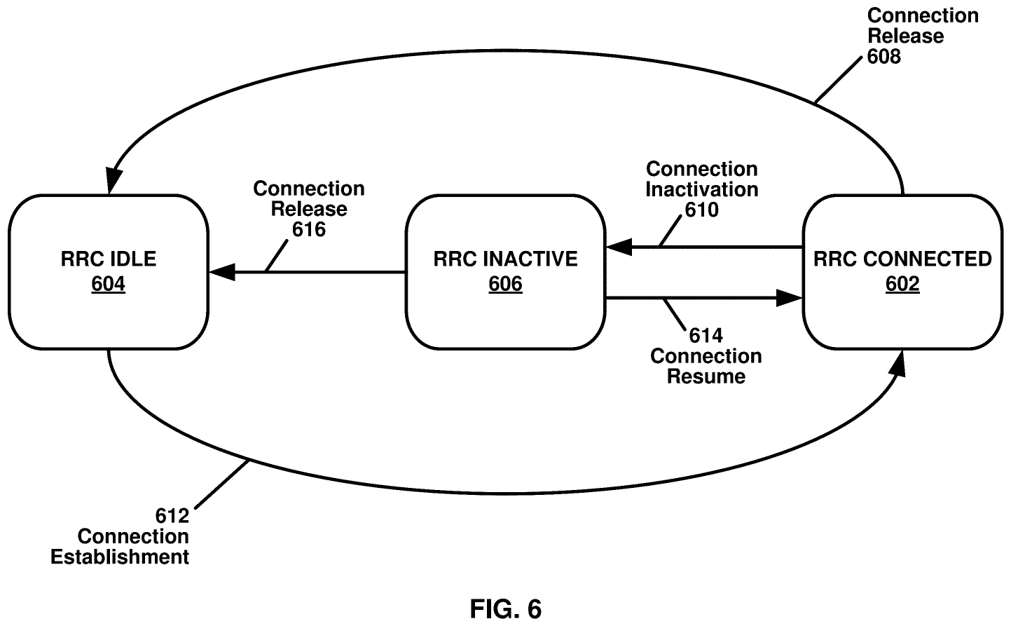

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAls. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split in two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

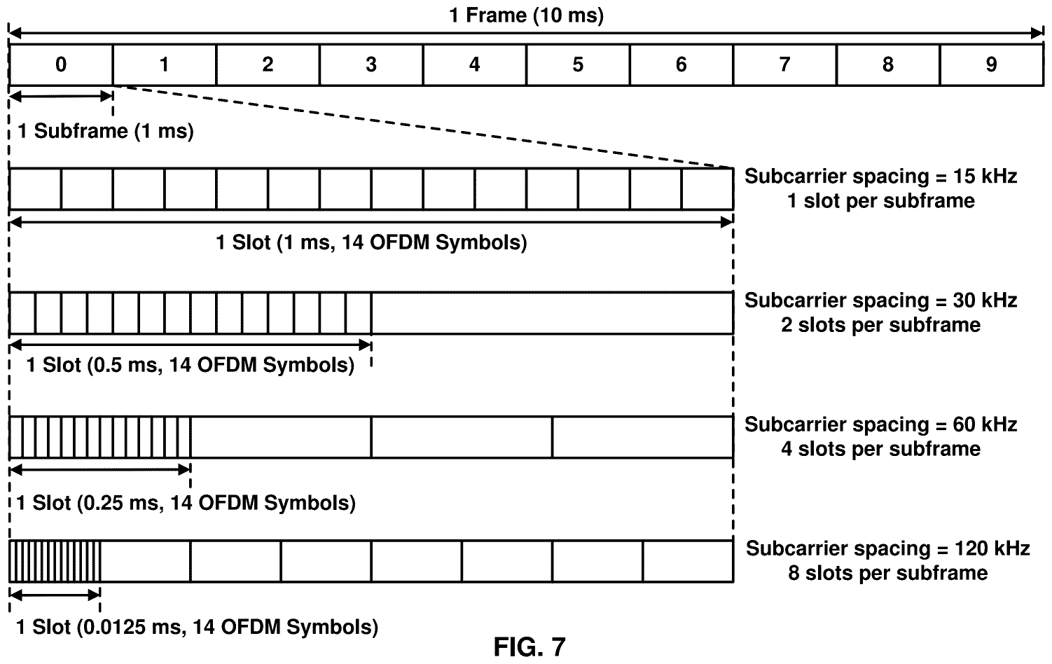

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 KHz/2.3 μs; 60 KHz/1.2 μs; 120 KHz/0.59 μs; and 240 KHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

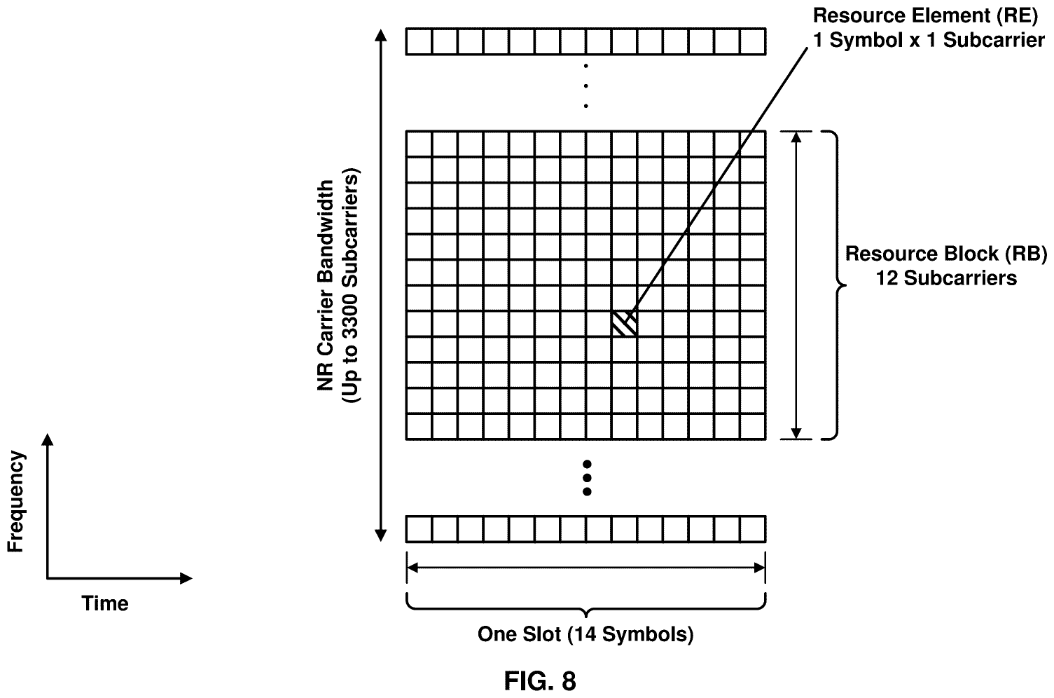

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHZ bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

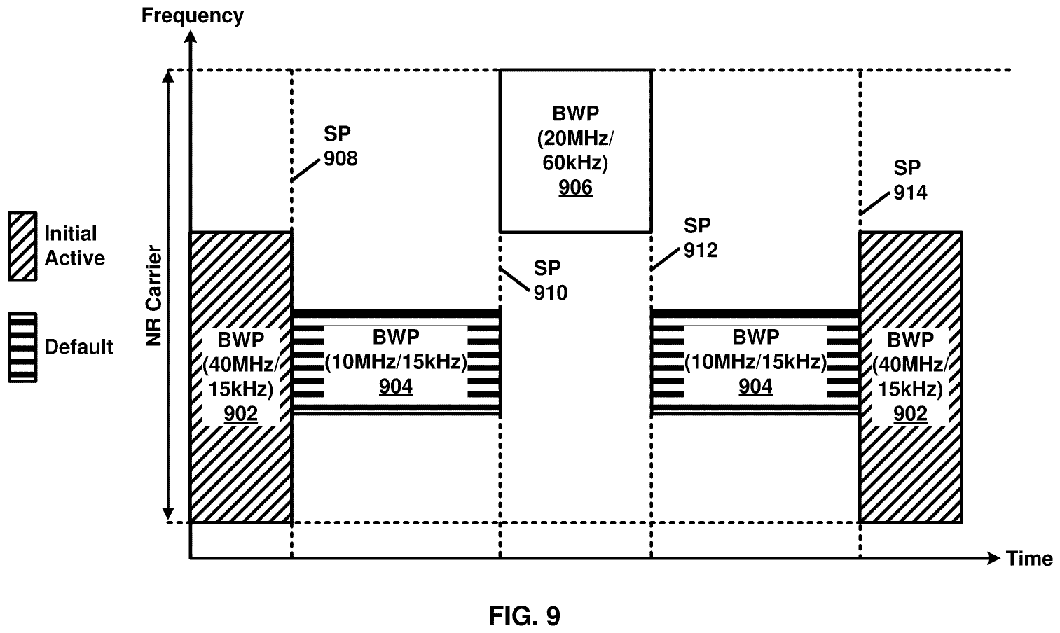

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 KHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response receiving a DCI indicating BWP 906 as the active BWP. The UE may switch at a switching point 912 from active BWP 906 to BWP 904 in response to an expiry of a BWP inactivity timer and/or in response receiving a DCI indicating BWP 904 as the active BWP. The UE may switch at a switching point 914 from active BWP 904 to BWP 902 in response receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

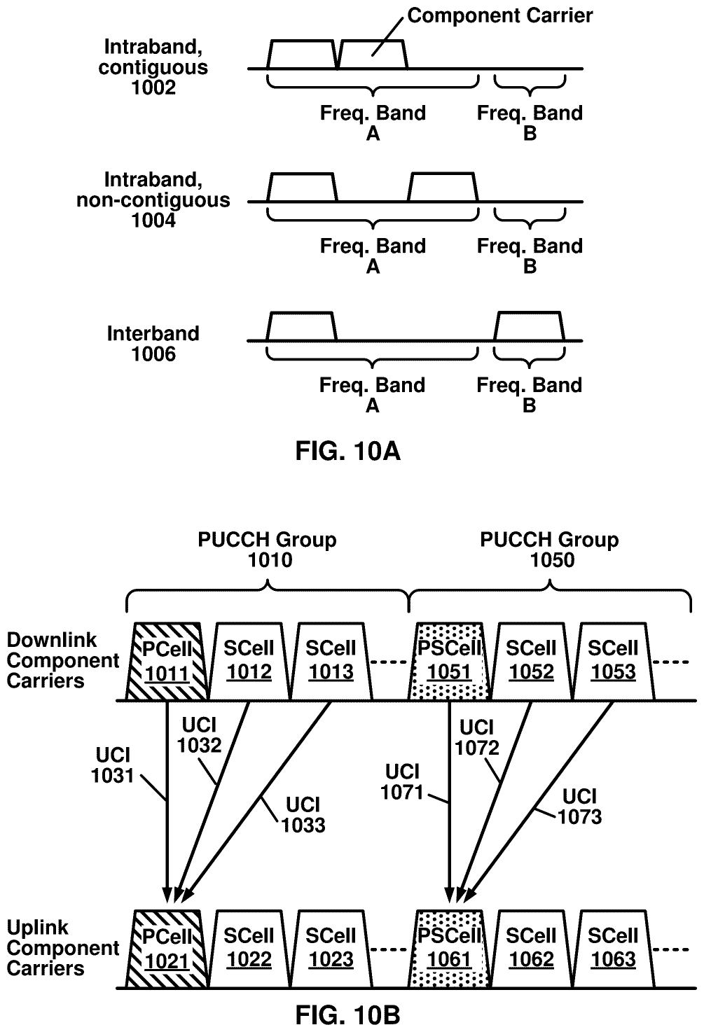

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary Scell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

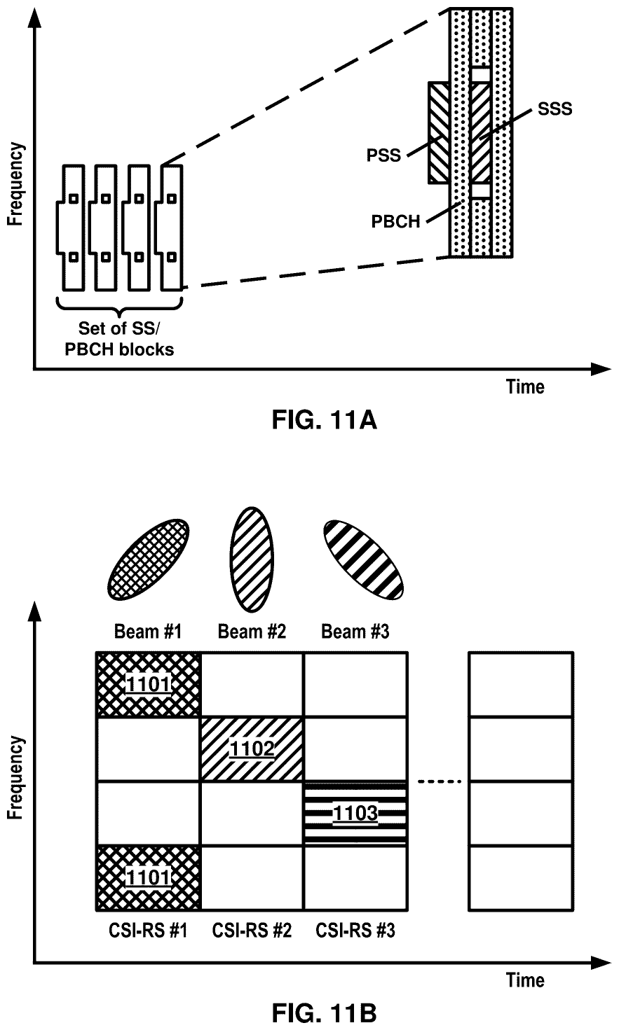

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in a SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

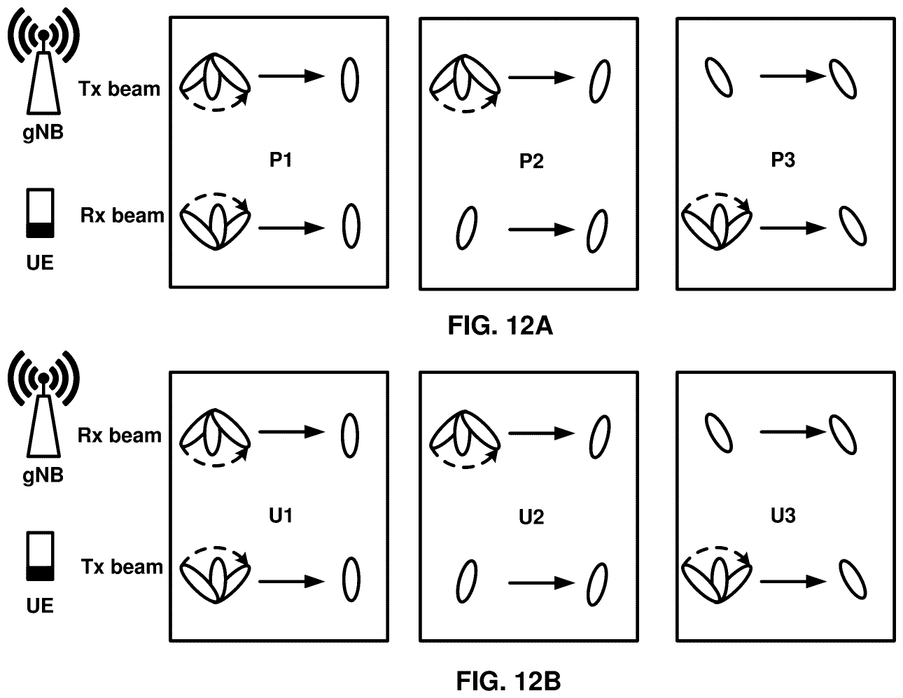

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counter-clockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counter-clockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counter-clockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

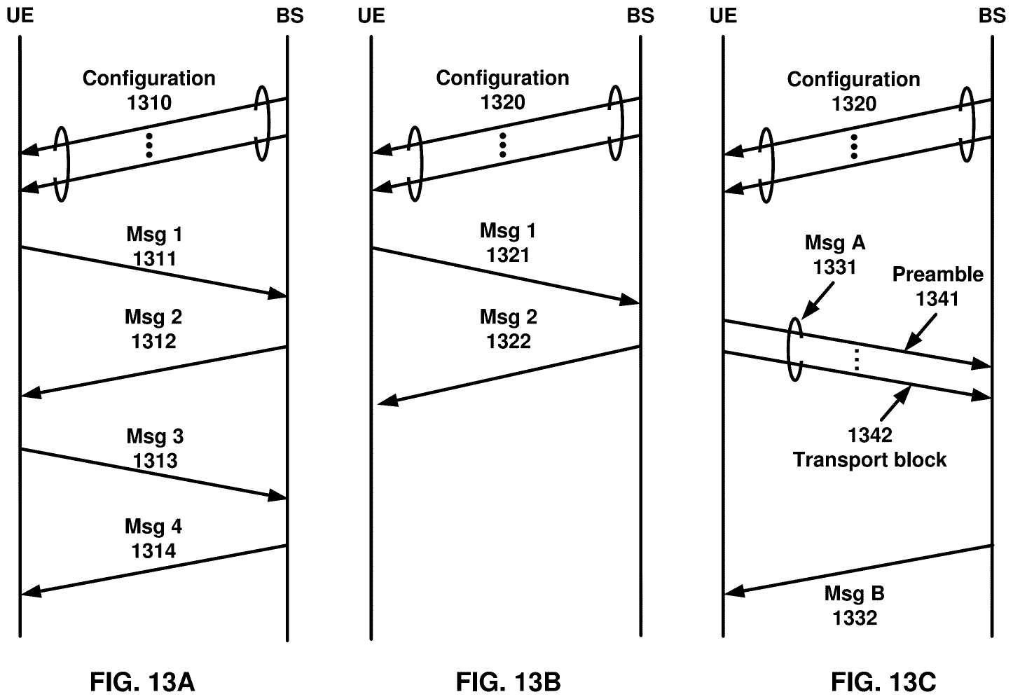

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id

where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

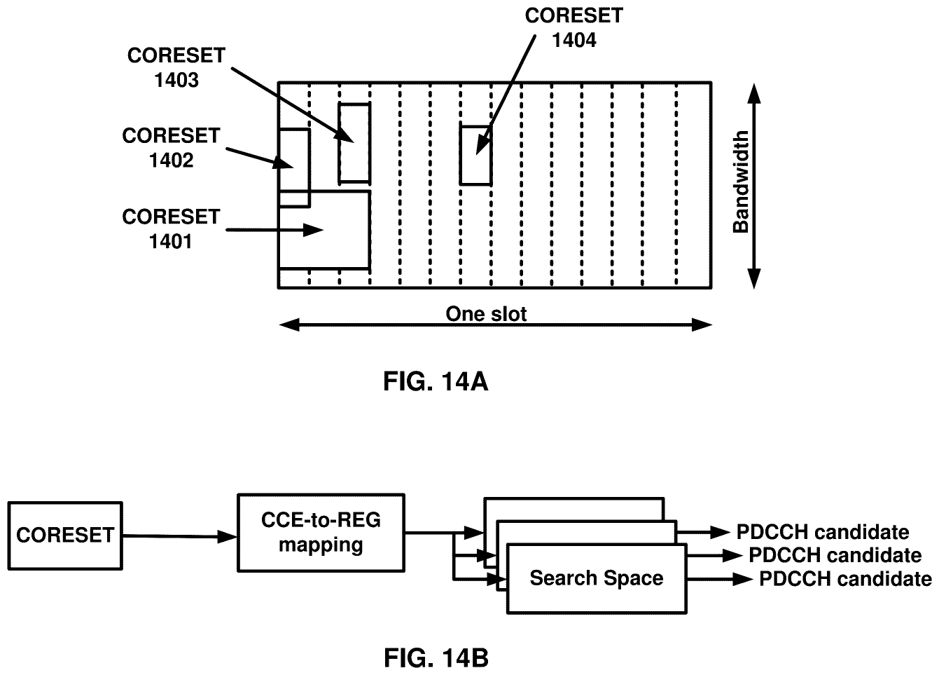

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

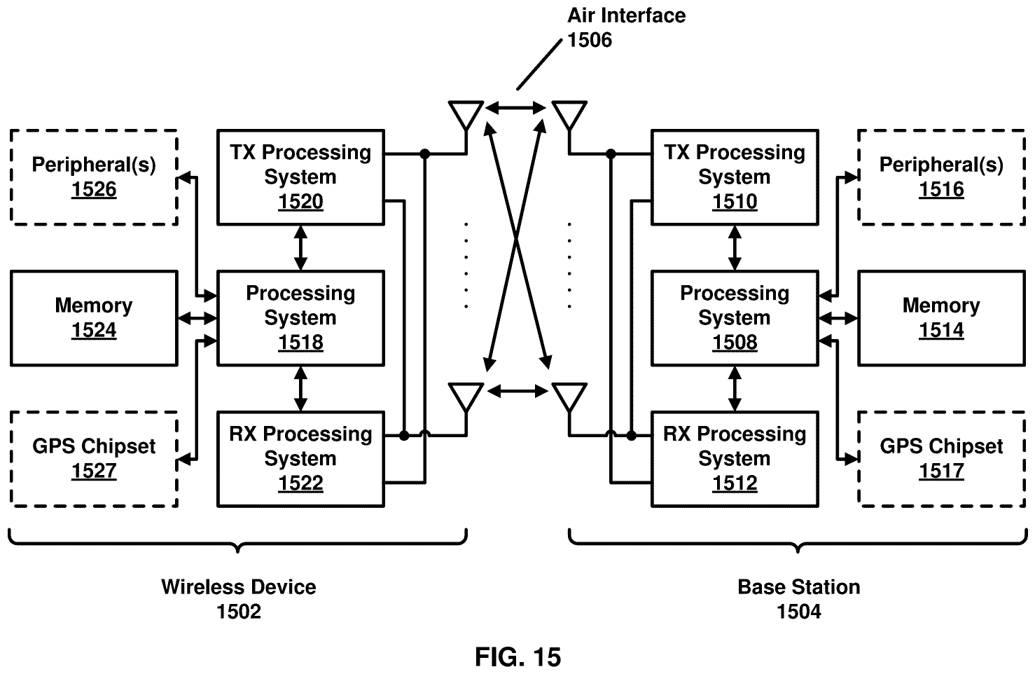

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

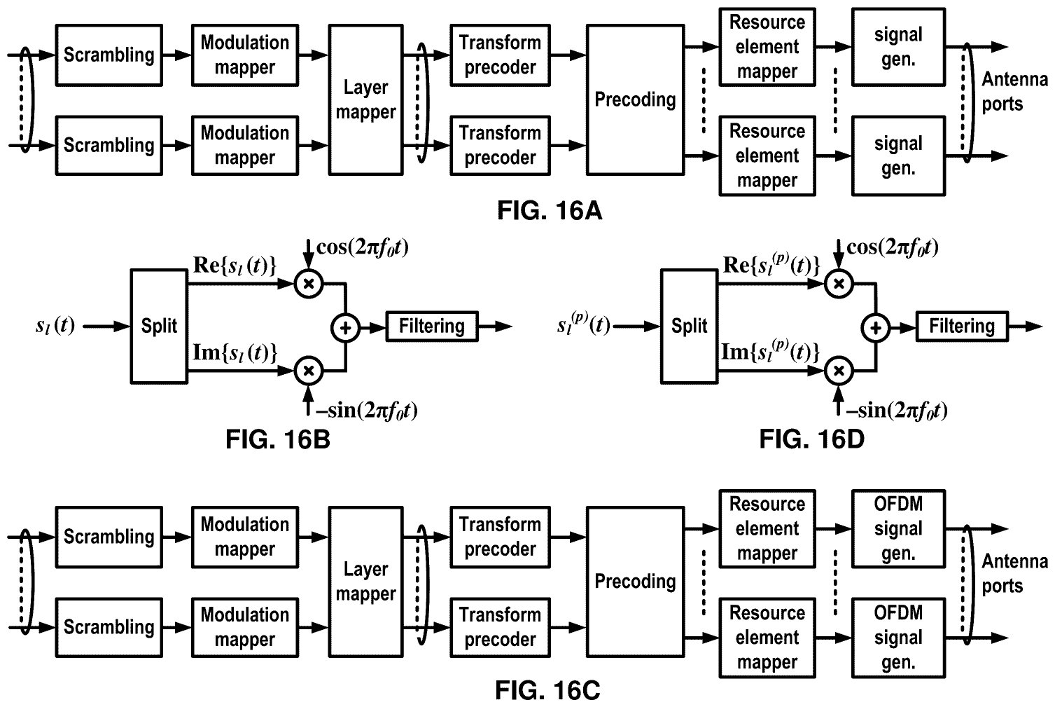

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, an CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual-connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

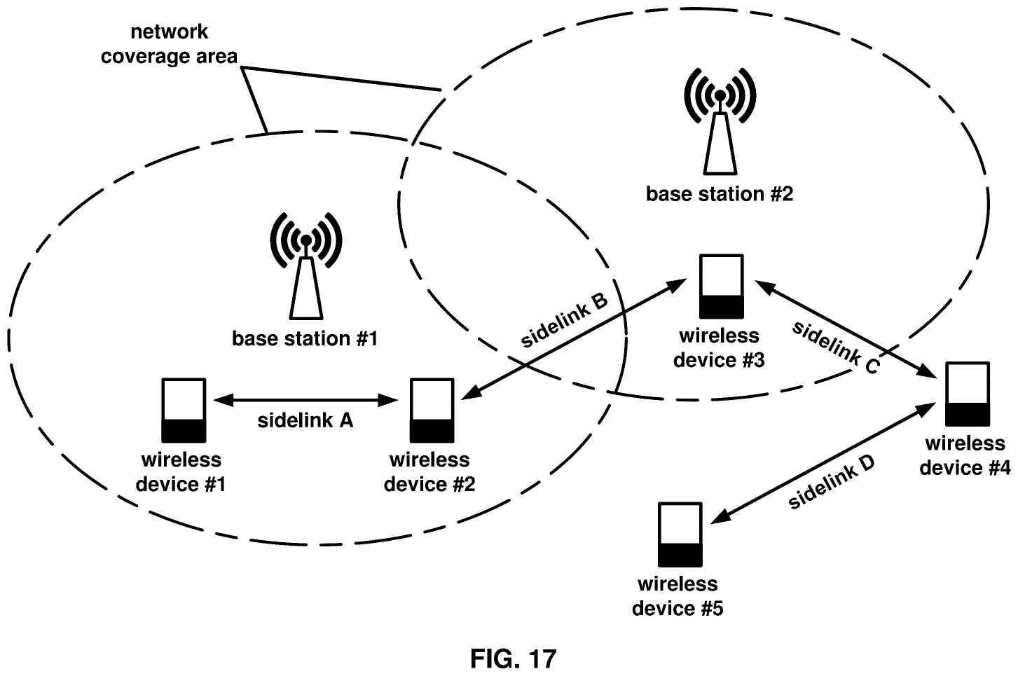

FIG. 17 illustrates examples of device-to-device (D2D) communication, in which there is a direct communication between wireless devices. In an example, D2D communication may be performed via a sidelink (SL). The wireless devices may exchange sidelink communications via a sidelink interface (e.g., a PC5 interface). Sidelink differs from uplink (in which a wireless device communicates to a base station) and downlink (in which a base station communicates to a wireless device). A wireless device and a base station may exchange uplink and/or downlink communications via a user plane interface (e.g., a Uu interface).

As shown in the FIG. 17, wireless device #1 and wireless device #2 may be in a coverage area of base station #1. For example, both wireless device #1 and wireless device #2 may communicate with the base station #1 via a Uu interface. Wireless device #3 may be in a coverage area of base station #2. Base station #1 and base station #2 may share a network and may jointly provide a network coverage area. Wireless device #4 and wireless device #5 may be outside of the network coverage area.

In-coverage D2D communication may be performed when two wireless devices share a network coverage area. Wireless device #1 and wireless device #2 are both in the coverage area of base station #1. Accordingly, they may perform an in-coverage intra-cell D2D communication, labeled as sidelink A. Wireless device #2 and wireless device #3 are in the coverage areas of different base stations, but share the same network coverage area. Accordingly, they may perform an in-coverage inter-cell D2D communication, labeled as sidelink B. Partial-coverage D2D communications may be performed when one wireless device is within the network coverage area and the other wireless device is outside the network coverage area. Wireless device #3 and wireless device #4 may perform a partial-coverage D2D communication, labeled as sidelink C. Out-of-coverage D2D communications may be performed when both wireless devices are outside of the network coverage area. Wireless device #4 and wireless device #5 may perform an out-of-coverage D2D communication, labeled as sidelink D.

Sidelink communications may be configured using physical channels, for example, a physical sidelink broadcast channel (PSBCH), a physical sidelink feedback channel (PSFCH), a physical sidelink discovery channel (PSDCH), a physical sidelink control channel (PSCCH), and/or a physical sidelink shared channel (PSSCH). PSBCH may be used by a first wireless device to send broadcast information to a second wireless device. PSBCH may be similar in some respects to PBCH. The broadcast information may comprise, for example, a slot format indication, resource pool information, a sidelink system frame number, or any other suitable broadcast information. PSFCH may be used by a first wireless device to send feedback information to a second wireless device. The feedback information may comprise, for example, HARQ feedback information. PSDCH may be used by a first wireless device to send discovery information to a second wireless device. The discovery information may be used by a wireless device to signal its presence and/or the availability of services to other wireless devices in the area. PSCCH may be used by a first wireless device to send sidelink control information (SCI) to a second wireless device. PSCCH may be similar in some respects to PDCCH and/or PUCCH. The control information may comprise, for example, time/frequency resource allocation information (RB size, a number of retransmissions, etc.), demodulation related information (DMRS, MCS, RV, etc.), identifying information for a transmitting wireless device and/or a receiving wireless device, a process identifier (HARQ, etc.), or any other suitable control information. The PSCCH may be used to allocate, prioritize, and/or reserve sidelink resources for sidelink transmissions. PSSCH may be used by a first wireless device to send and/or relay data and/or network information to a second wireless device. PSSCH may be similar in some respects to PDSCH and/or PUSCH. Each of the sidelink channels may be associated with one or more demodulation reference signals. Sidelink operations may utilize sidelink synchronization signals to establish a timing of sidelink operations. Wireless devices configured for sidelink operations may send sidelink synchronization signals, for example, with the PSBCH. The sidelink synchronization signals may include primary sidelink synchronization signals (PSSS) and secondary sidelink synchronization signals (SSSS).

Sidelink resources may be configured to a wireless device in any suitable manner. A wireless device may be pre-configured for sidelink, for example, pre-configured with sidelink resource information. Additionally or alternatively, a network may broadcast system information relating to a resource pool for sidelink. Additionally or alternatively, a network may configure a particular wireless device with a dedicated sidelink configuration. The configuration may identify sidelink resources to be used for sidelink operation (e.g., configure a sidelink band combination).

The wireless device may operate in different modes, for example, an assisted mode (which may be referred to as mode 1) or an autonomous mode (which may be referred to as mode 2). Mode selection may be based on a coverage status of the wireless device, a radio resource control status of the wireless device, information and/or instructions from the network, and/or any other suitable factors. For example, if the wireless device is idle or inactive, or if the wireless device is outside of network coverage, the wireless device may select to operate in autonomous mode. For example, if the wireless device is in a connected mode (e.g., connected to a base station), the wireless device may select to operate (or be instructed by the base station to operate) in assisted mode. For example, the network (e.g., a base station) may instruct a connected wireless device to operate in a particular mode.

In an assisted mode, the wireless device may request scheduling from the network. For example, the wireless device may send a scheduling request to the network and the network may allocate sidelink resources to the wireless device. Assisted mode may be referred to as network-assisted mode, gNB-assisted mode, or base station-assisted mode. In an autonomous mode, the wireless device may select sidelink resources based on measurements within one or more resource pools (for example, pre-configure or network-assigned resource pools), sidelink resource selections made by other wireless devices, and/or sidelink resource usage of other wireless devices.

To select sidelink resources, a wireless device may observe a sensing window and a selection window. During the sensing window, the wireless device may observe SCI transmitted by other wireless devices using the sidelink resource pool. The SCIs may identify resources that may be used and/or reserved for sidelink transmissions. Based on the resources identified in the SCIs, the wireless device may select resources within the selection window (for example, resource that are different from the resources identified in the SCIs). The wireless device may transmit using the selected sidelink resources.

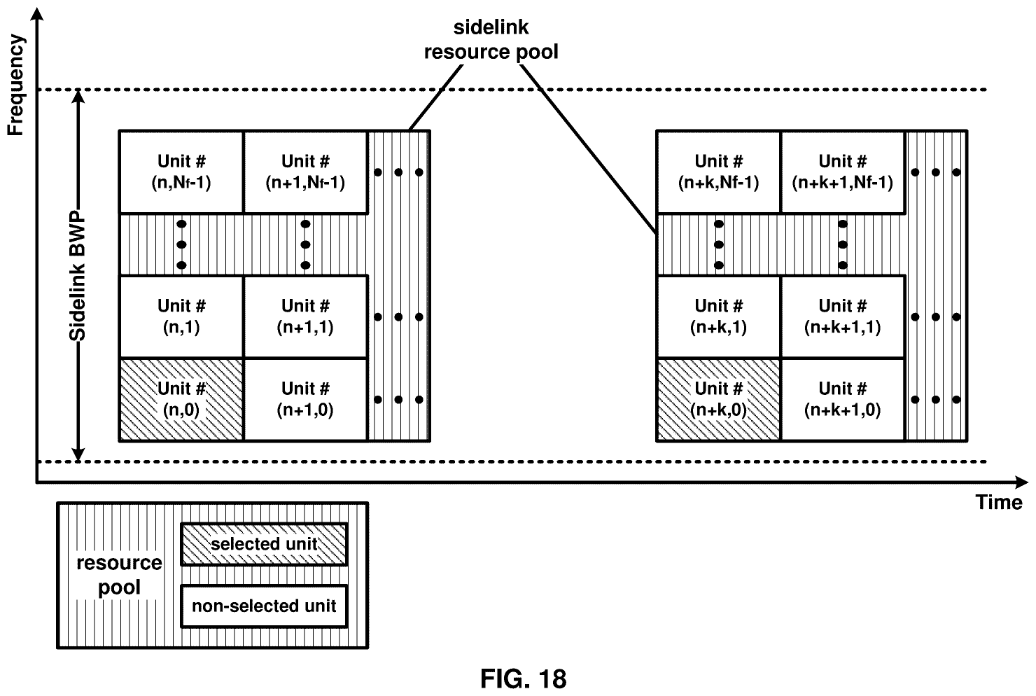

FIG. 18 illustrates an example of a resource pool for sidelink operations. A wireless device may operate using one or more sidelink cells. A sidelink cell may include one or more resource pools. Each resource pool may be configured to operate in accordance with a particular mode (for example, assisted or autonomous). The resource pool may be divided into resource units. In the frequency domain, each resource unit may comprise, for example, one or more resource blocks which may be referred to as a sub-channel. In the time domain, each resource unit may comprise, for example, one or more slots, one or more subframes, and/or one or more OFDM symbols. The resource pool may be continuous or non-continuous in the frequency domain and/or the time domain (for example, comprising contiguous resource units or non-contiguous resource units). The resource pool may be divided into repeating resource pool portions. The resource pool may be shared among one or more wireless devices. Each wireless device may attempt to transmit using different resource units, for example, to avoid collisions.

Sidelink resource pools may be arranged in any suitable manner. In the figure, the example resource pool is non-contiguous in the time domain and confined to a single sidelink BWP. In the example resource pool, frequency resources are divided into a Nf resource units per unit of time, numbered from zero to Nf−1. The example resource pool may comprise a plurality of portions (non-contiguous in this example) that repeat every k units of time. In the figure, time resources are numbered as n, n+1 . . . n+k, n+k+1 . . . , etc.

A wireless device may select for transmission one or more resource units from the resource pool. In the example resource pool, the wireless device selects resource unit (n,0) for sidelink transmission. The wireless device may further select periodic resource units in later portions of the resource pool, for example, resource unit (n+k,0), resource unit (n+2k,0), resource unit (n+3k,0), etc. The selection may be based on, for example, a determination that a transmission using resource unit (n,0) will not (or is not likely) to collide with a sidelink transmission of a wireless device that shares the sidelink resource pool. The determination may be based on, for example, behavior of other wireless devices that share the resource pool. For example, if no sidelink transmissions are detected in resource unit (n−k,0), then the wireless device may select resource unit (n,0), resource (n+k,0), etc. For example, if a sidelink transmission from another wireless device is detected in resource unit (n−k, 1), then the wireless device may avoid selection of resource unit (n, 1), resource (n+k, 1), etc.

Different sidelink physical channels may use different resource pools. For example, PSCCH may use a first resource pool and PSSCH may use a second resource pool. Different resource priorities may be associated with different resource pools. For example, data associated with a first QoS, service, priority, and/or other characteristic may use a first resource pool and data associated with a second QoS, service, priority, and/or other characteristic may use a second resource pool. For example, a network (e.g., a base station) may configure a priority level for each resource pool, a service to be supported for each resource pool, etc. For example, a network (e.g., a base station) may configure a first resource pool for use by unicast UEs, a second resource pool for use by groupcast UEs, etc. For example, a network (e.g., a base station) may configure a first resource pool for transmission of sidelink data, a second resource pool for transmission of discovery messages, etc.

In an example of vehicle-to-everything (V2X) communications via a Uu interface and/or a PC5 interface, the V2X communications may be vehicle-to-vehicle (V2V) communications. A wireless device in the V2V communications may be a vehicle. In an example, the V2X communications may be vehicle-to-pedestrian (V2P) communications. A wireless device in the V2P communications may be a pedestrian equipped with a mobile phone/handset. In an example, the V2X communications may be vehicle-to-infrastructure (V2I) communications. The infrastructure in the V2I communications may be a base station/access point/node/road side unit. A wireless device in the V2X communications may be a transmitting wireless device performing one or more sidelink transmissions to a receiving wireless device. The wireless device in the V2X communications may be a receiving wireless device receiving one or more sidelink transmissions from a transmitting wireless device.

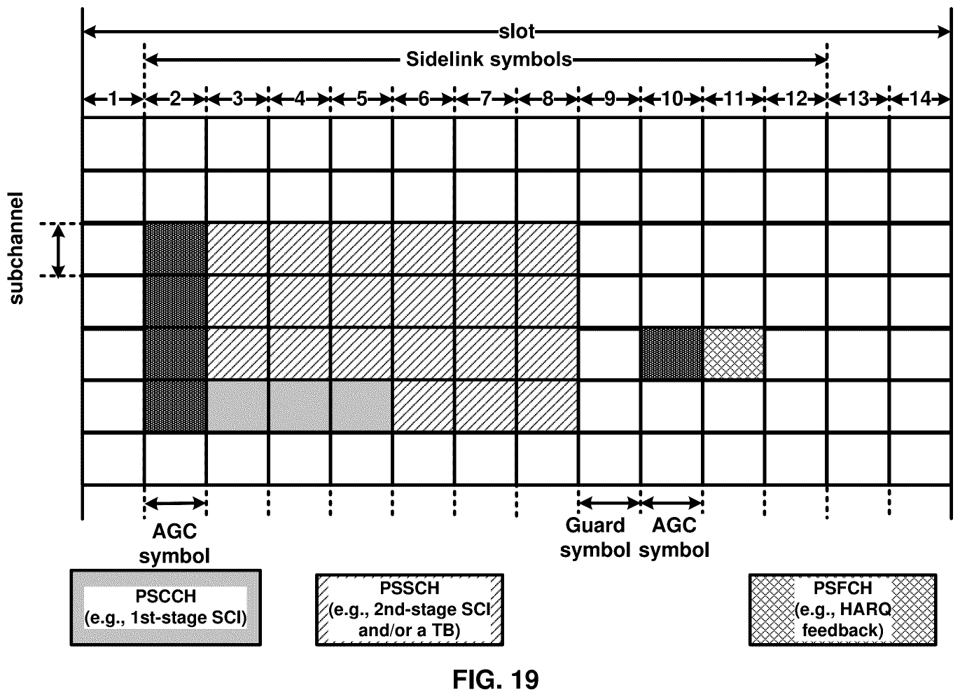

FIG. 19 illustrates an example of sidelink symbols in a slot. In an example, a sidelink transmission may be transmitted in a slot in the time domain. In an example, a wireless device may have data to transmit via sidelink. The wireless device may segment the data into one or more transport blocks (TBs). The one or more TBs may comprise different pieces of the data. A TB of the one or more TBs may be a data packet of the data. The wireless device may transmit a TB of the one or more TBs (e.g., a data packet) via one or more sidelink transmissions (e.g., via PSCCH/PSSCH in one or more slots). In an example, a sidelink transmission (e.g., in a slot) may comprise SCI. The sidelink transmission may further comprise a TB. The SCI may comprise a 1^{st}-stage SCI and a 2^{nd}-stage SCI. A PSCCH of the sidelink transmission may comprise the 1^{st}-stage SCI for scheduling a PSSCH (e.g., the TB). The PSSCH of the sidelink transmission may comprise the 2^{nd}-stage SCI. The PSSCH of the sidelink transmission may further comprise the TB. In an example, sidelink symbols in a slot may or may not start from the first symbol of the slot. The sidelink symbols in the slot may or may not end at the last symbol of the slot. In an example of FIG. 19, sidelink symbols in a slot start from the second symbol of the slot. In an example of FIG. 19, the sidelink symbols in the slot end at the twelfth symbol of the slot. A first sidelink transmission may comprise a first automatic gain control (AGC) symbol (e.g., the second symbol in the slot), a PSCCH (e.g., in the third, fourth and the fifth symbols in a sub-channel in the slot), a PSSCH (e.g., from the third symbol to the eighth symbol in the slot), and/or a first guard symbol (e.g., the ninth symbol in the slot). A second sidelink transmission may comprise a second AGC symbol (e.g., the tenth symbol in the slot), a PSFCH (e.g., the eleventh symbol in the slot), and/or a second guard symbol for the second sidelink transmission (e.g., the twelfth symbol in the slot). In an example, one or more HARQ feedbacks (e.g., positive acknowledgement or ACK and/or negative acknowledgement or NACK) may be transmitted via the PSFCH. In an example, the PSCCH, the PSSCH, and the PSFCH may have different number of sub-channels (e.g., a different number of frequency resources) in the frequency domain.

The 1^{st}-stage SCI may be a SCI format 1-A. The SCI format 1-A may comprise a plurality of fields used for scheduling of the first TB on the PSSCH and the 2^{nd}-stage SCI on the PSSCH. The following information may be transmitted by means of the SCI format 1-A.
A priority of the sidelink transmission. For example, the priority may be a physical layer (e.g., layer 1) priority of the sidelink transmission. For example, the priority may be determined based on logical channel priorities of the sidelink transmission;
Frequency resource assignment of the PSSCH;
Time resource assignment of the PSSCH;
Resource reservation period/interval for a second TB;
Demodulation reference signal (DMRS) pattern;
A format of the 2^{nd}-stage SCI;
Beta_offset indicator,
Number of DMRS port;
Modulation and coding scheme of the PSSCH;
Additional MCS table indicator,
PSFCH overhead indication;
Reserved bits.

The 2^{nd}-stage SCI may be a SCI format 2-A. The SCI format 2-A may be used for the decoding of the PSSCH, with HARQ operation when HARQ-ACK information includes ACK or NACK, or when there is no feedback of HARQ-ACK information. The SCI format 2-A may comprise a plurality of fields indicating the following information.
HARQ process number,
New data indicator,
Redundancy version;
Source ID of a transmitter (e.g., a transmitting wireless device) of the sidelink transmission;
Destination ID of a receiver (e.g., a receiving wireless device) of the sidelink transmission;
HARQ feedback enabled/disabled indicator,
Cast type indicator indicating that the sidelink transmission is a broadcast, a groupcast and/or a unicast;
CSI request.

The 2^{nd}-stage SCI may be a SCI format 2-B. The SCI format 2-B may be used for the decoding of the PSSCH, with HARQ operation when HARQ-ACK information includes only NACK, or when there is no feedback of HARQ-ACK information. The SCI format 2-B may comprise a plurality of fields indicating the following information.
HARQ process number,
New data indicator,
Redundancy version;
Source ID of a transmitter (e.g., a transmitting wireless device) of the sidelink transmission;
Destination ID of a receiver (e.g., a receiving wireless device) of the sidelink transmission;
HARQ feedback enabled/disabled indicator,
Zone ID indicating a zone in which a transmitter (e.g., a transmitting wireless device) of the sidelink transmission is geographic located;
Communication range requirement indicating a communication range of the sidelink transmission.

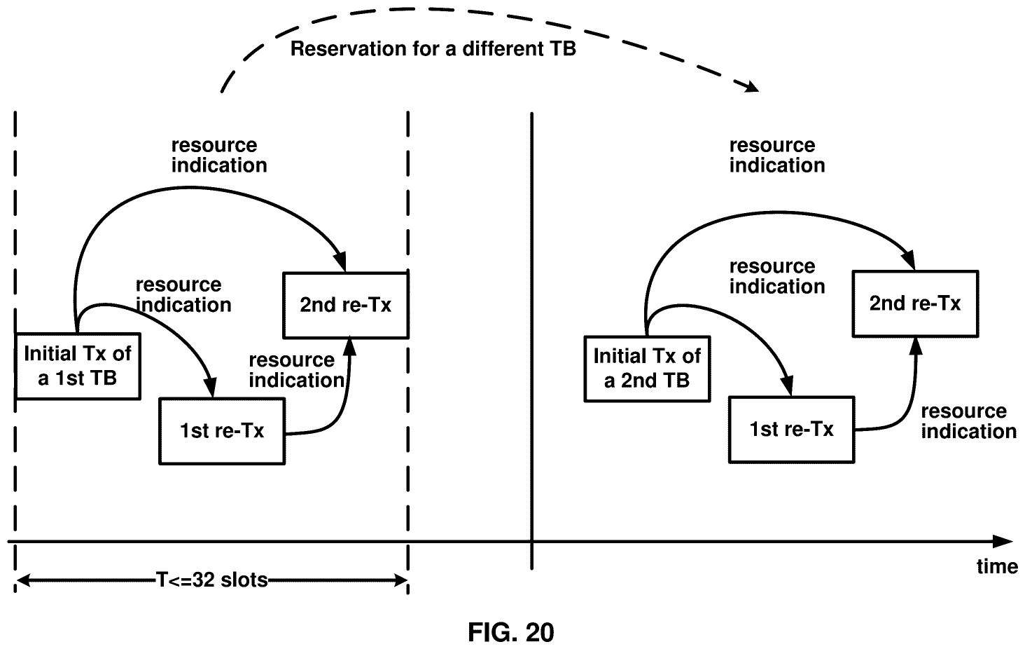

FIG. 20 illustrates an example of resource indication for a first TB (e.g, a first data packet) and resource reservation for a second TB (e.g., a second data packet). SCI of an initial transmission (e.g., a first transmission) and/or retransmission of the first TB may comprise one or more first parameters (e.g., Frequency resource assignment and Time resource assignment) indicating one or more first time and frequency (T/F) resources for transmission and/or retransmission of the first TB. The SCI may further comprise one or more second parameters (e.g., Resource reservation period) indicating a reservation period/interval of one or more second T/F resources for initial transmission and/or retransmission of the second TB.

In an example, in response to triggering a resource selection procedure, a wireless device may select one or more first T/F resources for initial transmission and/or retransmission of a first TB. As shown in FIG. 20, the wireless device may select three resources for transmitting the first TB. The wireless device may transmit an initial transmission (initial Tx of a first TB in FIG. 20) of the first TB via a first resource of the three resources. The wireless device may transmit a first retransmission (1^{st} re-Tx in FIG. 20) of the first TB via a second resource of the three resources. The wireless device may transmit a second retransmission (2^{nd} re-Tx in FIG. 20) of the first TB via a third resource of the three resources. A time duration between a starting time of the initial transmission of the first TB and the second retransmission of the first TB may be smaller than or equal to 32 sidelink slots (e.g., T≤32 slots in FIG. 20). A first SCI may associate with the initial transmission of the first TB. The first SCI may indicate a first T/F resource indication for the initial transmission of the first TB, the first retransmission of the first TB and the second retransmission of the first TB. The first SCI may further indicate a reservation period/interval of resource reservation for a second TB. A second SCI may associate with the first retransmission of the first TB. The second SCI may indicate a second T/F resource indication for the first retransmission of the first TB and the second retransmission of the first TB. The second SCI may further indicate the reservation period/interval of resource reservation for the second TB. A third SCI may associate with the second retransmission of the first TB. The third SCI may indicate a third T/F resource indication for the second retransmission of the first TB. The third SCI may further indicate the reservation period/interval of resource reservation for the second TB.

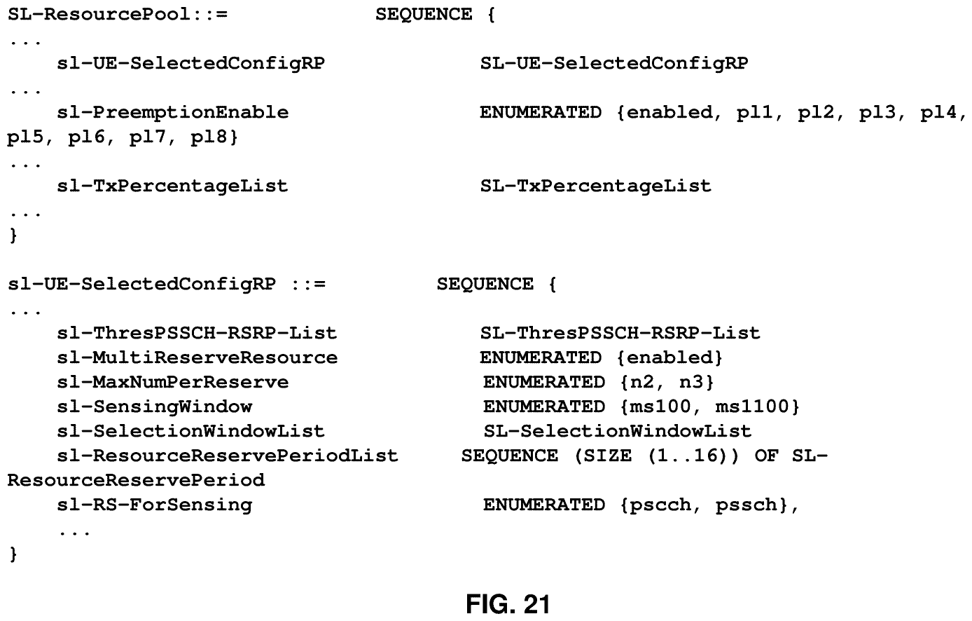

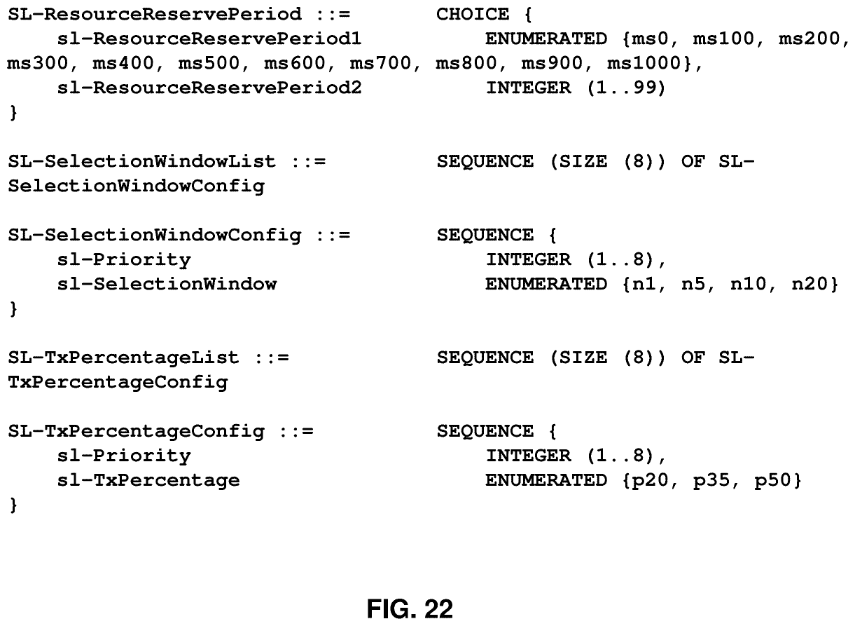

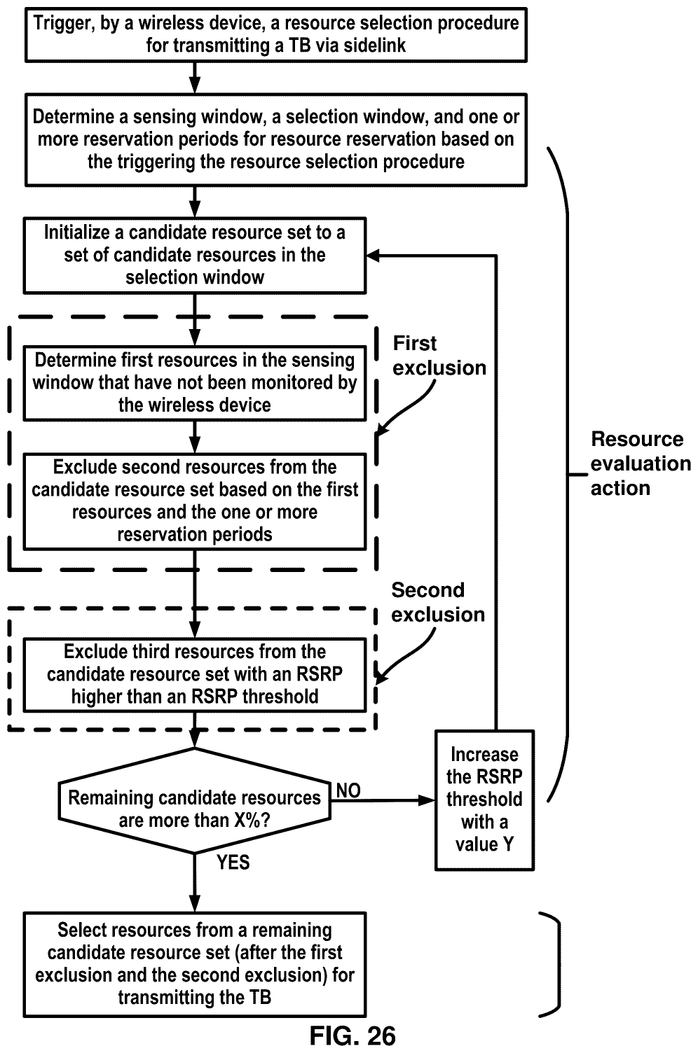

FIG. 21 and FIG. 22 illustrate examples of configuration information for sidelink communication. In an example, a base station may transmit one or more radio resource control (RRC) messages to a wireless device for delivering the configuration information for the sidelink communication. The configuration information may comprise a field of sl-UE-SelectedConfigRP. A parameter sl-ThresPSSCH-RSRP-List in the field may indicate a list of 64 thresholds. In an example, a wireless device may receive first sidelink control information (SCI) indicating a first priority. The wireless device may have second SCI to be transmitted. The second SCI may indicate a second priority. The wireless device may select a threshold from the list based on the first priority in the first SCI and the second priority in the second SCI. Referring to second exclusion in FIG. 26, the wireless device may exclude resources from candidate resource set based on the threshold. A parameter sl-MaxNumPerReserve in the field may indicate a maximum number of reserved PSCCH/PSSCH resources indicated in an SCI. A parameter sl-MultiReserveResource in the field may indicate if it is allowed to reserve a sidelink resource for an initial transmission of a TB by an SCI associated with a different TB, based on sensing and resource selection procedure. A parameter sl-ResourceReservePeriodList may indicate a set of possible resource reservation periods/intervals (e.g., SL-ResourceReservedPeriod) allowed in a resource pool. Up to 16 values may be configured per resource pool. A parameter sl-RS-ForSensing may indicate whether DMRS of PSCCH or PSSCH is used for layer 1 (e.g., physical layer) RSRP measurement in sensing operation. A parameter sl-SensingWindow may indicate a start of a sensing window. A parameter sl-SelectionWindowList may indicate an end of a selection window in resource selection procedure for a TB with respect to priority indicated in SCI. Value n1 may correspond to 1*2μ, value n5 corresponds to 5*2μ, and so on, where p=0,1,2,3 for subcarrier spacing (SCS) of 15, 30, 60, and 120 kHz respectively. A parameter SL-SelectionWindowConfig may indicate a mapping between a sidelink priority (e.g., sl-Priority) and the end of the selection window (e.g., sl-SelectionWindow).

The configuration information may comprise a parameter sl-PreemptionEnable indicating whether sidelink pre-emption is disabled or enabled in a resource pool. For example, a priority level p_preemption may be configured if the sidelink pre-emption is enabled. For example, if the sidelink pre-emption is enabled but the p_preemption is not configured, the sidelink pre-emption may be applicable to all priority levels.

The configuration information may comprise a parameter sl-TxPercentageList indicating a portion of candidate single-slot PSSCH resources over total resources. For example, value p20 may correspond to 20%, and so on. A parameter SL-TxPercentageConfig may indicate a mapping between a sidelink priority (e.g., sl-Priority) and the portion of candidate single-slot PSSCH resources over total resources (e.g., sl-TxPercentage).

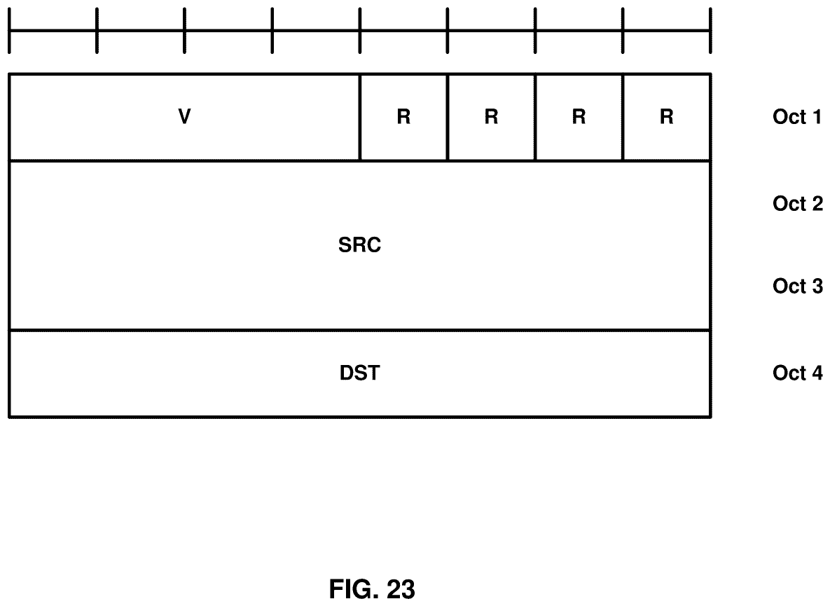

FIG. 23 illustrates an example format of a MAC subheader for sidelink shared channel (SL-SCH). The MAC subheader for SL-SCH may comprise seven header fields V/R/R/R/R/SCR/DST. The MAC subheader is octet aligned. For example, the V field may be a MAC protocol date units (PDU) format version number field indicating which version of the SL-SCH subheader is used. For example, the SRC field may carry 16 bits of a Source Layer-2 identifier (ID) field set to a first identifier provided by upper layers. For example, the DST field may carry 8 bits of the Destination Layer-2 ID set to a second identifier provided by upper layers. In an example, if the V field is set to “1”, the second identifier may be a unicast identifier. In an example, if the V field is set to “2”, the second identifier may be a groupcast identifier. In an example, if the V field is set to “3”, the second identifier may be a broadcast identifier. For example, the R field may indicate reserved bit.

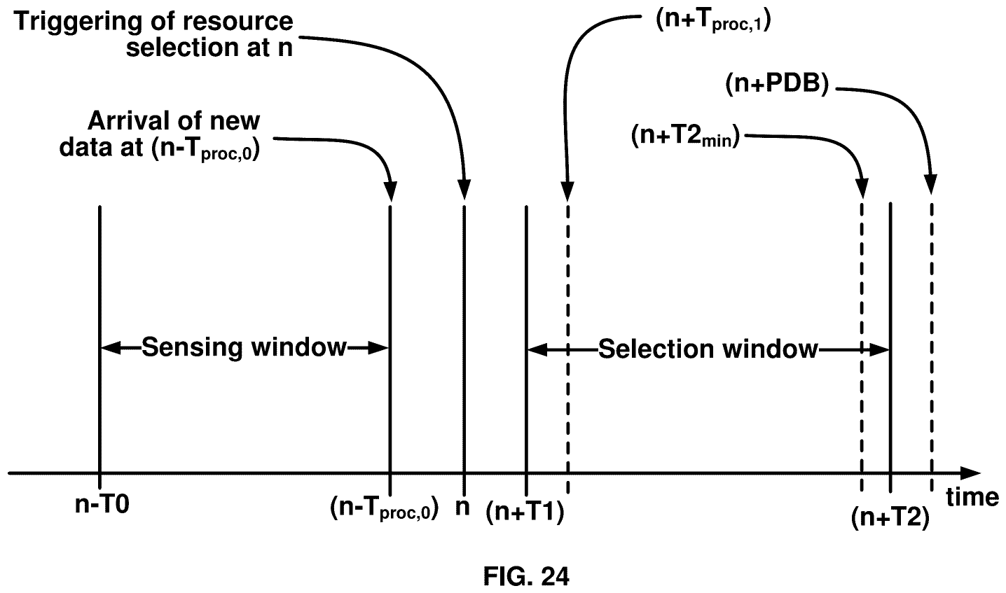

FIG. 24 illustrates an example time of a resource selection procedure. A wireless device may perform the resource selection procedure to select resources for one or more sidelink transmissions. As shown in FIG. 24, a sensing window of the resource selection procedure may start at time (n−T0) (e.g., parameter sl-SensingWindow). The sensing window may end at time (n−T_{proc,0}). New data of the one or more sidelink transmissions may arrive at the wireless device at time (n−T_{proc,0}). The time period T_{proc,0} may be a processing delay of the wireless device to determine to trigger the resource selection procedure. The wireless device may determine to trigger the resource selection procedure at time n to select the resources for the new data arrived at time (n−T_{proc,0}). The wireless device may complete the resource selection procedure at time (n+T1). The wireless device may determine the parameter T1 based on a capability of the wireless device. The capability of the wireless device may be a processing delay of a processor of the wireless device. A selection window of the resource selection procedure may start at time (n+T1). The selection window may end at time (n+T2) indicating the ending of the selection window. The wireless device may determine the parameter T2 based on a parameter T2min (e.g., sl-SelectionWindow). In an example, the wireless device may determine the parameter T2 subject to T2min≤T2≤PDB, where the PDB (packet delay budget) may be the maximum allowable delay (e.g., a delay budget) for successfully transmitting the new data via the one or more sidelink transmissions. The wireless device may determine the parameter T′2 min to a corresponding value for a priority of the one or more sidelink transmissions (e.g., based on a parameter SL-SelectionWindowConfig indicating a mapping between a sidelink priority sl-Priority and the end of the selection window sl-Selection Window). In an example, the wireless device may set the parameter T2=PDB if the parameter T2min>PDB.

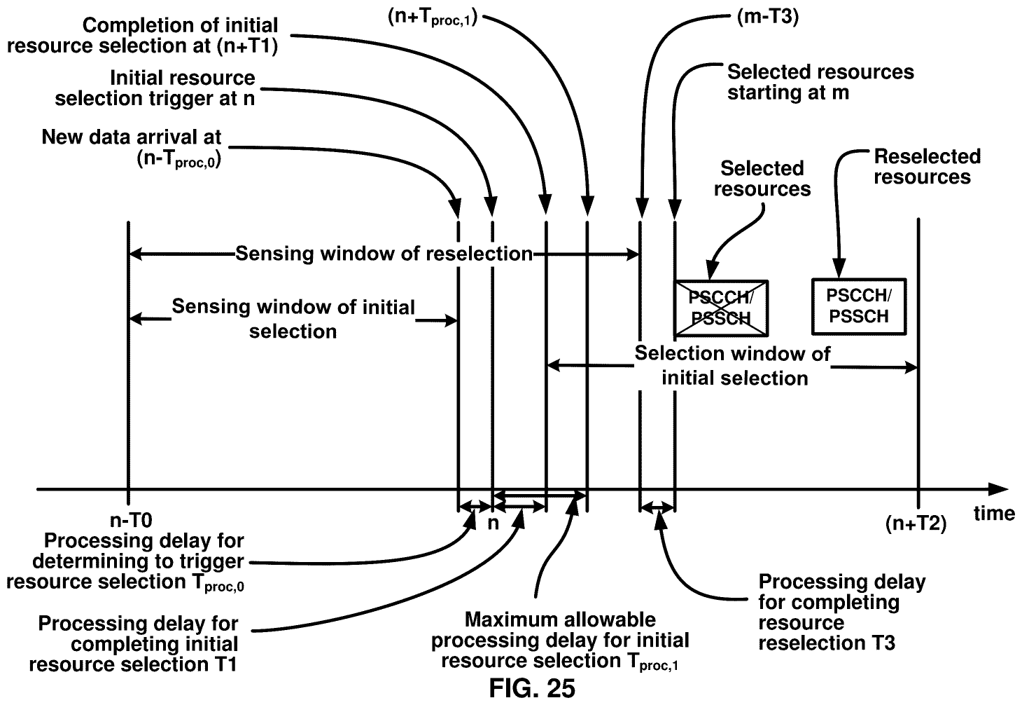

FIG. 25 illustrates an example timing of a resource selection procedure. A wireless device may perform the resource selection procedure for selecting resources for one or more sidelink transmissions. Referring to FIG. 24, a sensing window of initial selection may start at time (n−T0). The sensing window of initial selection may end at time (n−T_{proc,0}). New data of the one or more sidelink transmissions may arrive at the wireless device at the time (n−T_{proc,0}). The time period T_{proc,0} may be a processing delay for the wireless device to determine to trigger the initial selection of the resources. The wireless device may determine to trigger the initial selection at time n for selecting the resources for the new data arrived at the time (n−T_{proc,0}). The wireless device may complete the resource selection procedure at time (n+T1). The time (n+T_{proc,1}) may be the maximum allowable processing latency for completing the resource selection procedure being triggered at the time n, where 0<T1≤T_{proc,1}. A selection window of initial selection may start at time (n+T1). The selection window of initial selection may end at time (n+T2). The parameter T2 may be configured, preconfigured, or determined at the wireless device.

The wireless device may determine first resources (e.g., selected resources in FIG. 25) for the one or more sidelink transmissions based on the completion of the resource selection procedure at the time (n+T1). The wireless device may select the first resources from candidate resources in the selection window of initial selection based on measurements in the sensing window for initial selection. The wireless device may determine a resource collision between the first resources and other resources reserved by another wireless device. The wireless device may determine to drop the first resources for avoiding interference. The wireless device may trigger a resource reselection procedure (e.g., a second resource selection procedure) at time (m−T3) and/or before time (m−T3). The time period T3 may be a processing delay for the wireless device to complete the resource reselection procedure (e.g., a second resource selection procedure). The wireless device may determine second resources (e.g., reselected resource in FIG. 25) via the resource reselection procedure (e.g., a second resource selection procedure). The start time of the first resources may be time m (e.g., the first resources may be in slot m).

In an example, at least one of time parameters TO, T_{proc,0}, T_{proc,1}, T2, and PDB may be configured by a base station to the wireless device. In an example, the at least one of the time parameters T0, T_{proc,0}, T_{proc,1}, T2, and PDB may be preconfigured to the wireless device. The at least one of the time parameters TO, T_{proc,0}, T_{proc,1}, T2, and PDB may be stored in a memory of the wireless device. In an example, the memory may be a Subscriber Identity Module (SIM) card. In an example of FIG. 24 and FIG. 25, the time n, m, T0, T1, T_{proc,0}, T_{proc,1}, T2, T2min, T3, and PDB may be in terms of slots and/or slot index.

FIG. 26 illustrates an example flowchart of a resource selection procedure by a wireless device for transmitting a TB (e.g., a data packet) via sidelink.

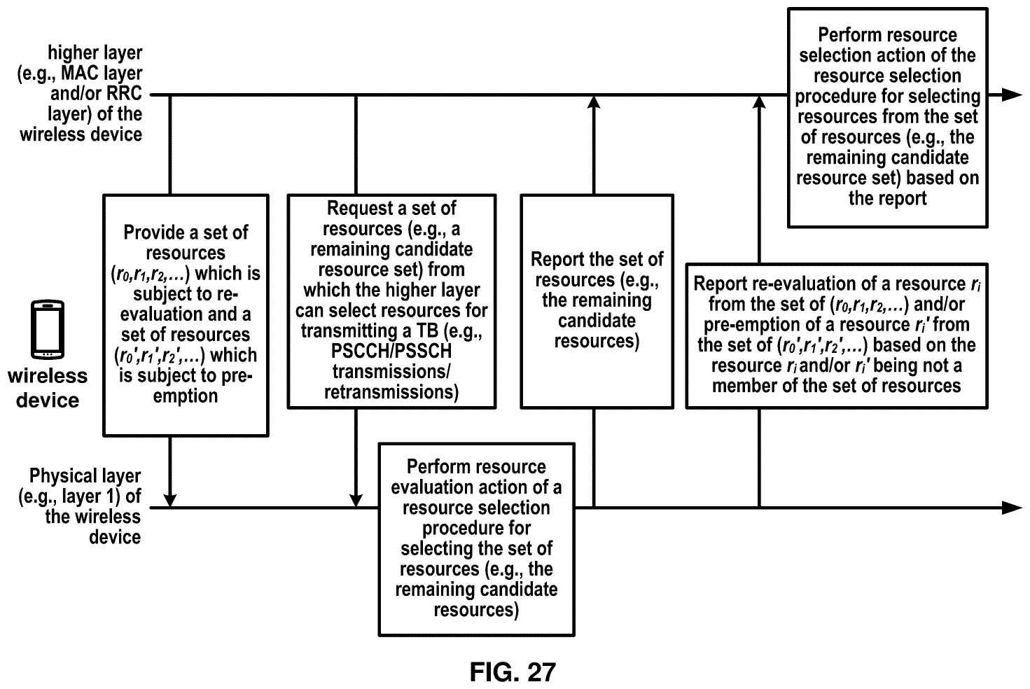

FIG. 27 illustrates an example diagram of the resource selection procedure among layers of the wireless device.

Referring to FIG. 26 and FIG. 27, the wireless device may transmit one or more sidelink transmissions (e.g., a first transmission of the TB and one or more retransmissions of the TB) for the transmitting of the TB. Referring to FIG. 19, a sidelink transmission of the one or more sidelink transmission may comprise a PSCCH. The sidelink transmission may comprise a PSSCH. The sidelink transmission may comprise a PSFCH. The wireless device may trigger the resource selection procedure for the transmitting of the TB. The resource selection procedure may comprise two actions. The first action of the two actions may be a resource evaluation action. Physical layer (e.g., layer 1) of the wireless device may perform the first action. The physical layer may determine a subset of resources based on the first action and report the subset of resources to higher layer (e.g., RRC layer and/or MAC layer) of the wireless device. The second action of the two actions may be a resource selection action. The higher layer (e.g., RRC layer and/or MAC layer) of the wireless device may perform the second action based on the reported the subset of resources from the physical layer.

In an example, higher layer (e.g., RRC layer and/or MAC layer) of a wireless device may trigger a resource selection procedure for requesting the wireless device to determine a subset of resources. The higher layer may select resources from the subset of resources for PSSCH and/or PSCCH transmission. To trigger the resource selection procedure, e.g., in slot n, the higher layer may provide the following parameters for the PSSCH and/or PSCCH transmission:
a resource pool, from which the wireless device may determine the subset of resources;
layer 1 priority, prio_{TX} (e.g., sl-Priority referring to FIG. 21 and FIG. 22), of the PSSCH/PSCCH transmission;
remaining packet delay budget (PDB) of the PSSCH and/or PSCCH transmission;
a number of sub-channels, L_{subCH}, for the PSSCH and/or PSCCH transmission in a slot;
a resource reservation period/interval, P_{rsvp_TX}, in units of millisecond (ms).

In an example, if the higher layer requests the wireless device to determine a subset of resources from which the higher layer will select the resources for the PSSCH and/or PSCCH transmission for re-evaluation and/or pre-emption, the higher layer may provide a set of resources (r₀, r₁, r₂, . . . ) which may be subject to the re-evaluation and a set of resources (r₀′, r₁′, r₂′, . . . ) which may be subject to the pre-emption.

In an example, a base station (e.g., network) may transmit a message comprising one or more parameters to the wireless device for performing the resource selection procedure. The message may be an RRC/SIB message, a MAC CE, and/or a DCI. In an example, a second wireless device may transmit a message comprising one or more parameters to the wireless device for performing the resource selection procedure. The message may be an RRC message, a MAC CE, and/or a SCI. The one or more parameters may indicate following information.
sl-Selection WindowList (e.g., sl-SelectionWindow referring to FIG. 21 and FIG. 22): an internal parameter T2min (e.g., T2min referring to FIG. 24) may be set to a corresponding value from the parameter sl-SelectionWindowList for a given value of prio_{TX} (e.g., based on SL-SelectionWindowConfig referring to FIG. 21 and FIG. 22).
sl-ThresPSSCH-RSRP-List (e.g., sl-ThresPSSCH-RSRP-List referring to FIG. 21 and FIG. 22): a parameter may indicate an RSRP threshold for each combination (pᵢ, pⱼ), where pᵢ is a value of a priority field in a received SCI format 1-A and pⱼ is a priority of a sidelink transmission (e.g., the PSSCH/PSCCH transmission) of the wireless device; In an example of the resource selection procedure, an invocation of pⱼ may be pⱼ=prio_{TX}.
sl-RS-ForSensing (e.g., sl-RS-ForSensing referring to FIG. 21 and FIG. 22): a parameter may indicate whether DMRS of a PSCCH or a PSSCH is used, by the wireless device, for layer 1 (e.g., physical layer) RSRP measurement in sensing operation.
sl-ResourceReservePeriodList (e.g., sl-ResourceReservePeriodList referring to FIG. 21 and FIG. 22)
sl-SensingWindow (e.g., sl-Sensing Window referring to FIG. 21 and FIG. 22): an internal parameter T₀ may be defined as a number of slots corresponding to t0_SensingWindow ms.
sl-TxPercentageList (e.g., based on SL-TxPercentageConfig referring to FIG. 21 and FIG. 22): an internal parameter X (e.g., sl-TxPercentage referring to FIG. 21 and FIG. 22) for a given prio_{TX} (e.g., sl-Priority referring to FIG. 21 and FIG. 22) may be defined as si-xPercentage (prio_{TX}) converted from percentage to ratio.
sl-PreemptionEnable (e.g., p_preemption referring to FIG. 21 and FIG. 22): an internal parameter prioₚᵣₑ may be set to a higher layer provided parameter sl-PreemptionEnable.

The resource reservation period/interval, P_{rsvp_TX}, if provided, may be converted from units of ms to units of logical slots, resulting in P_{rsvp_TX}.

Notation: (t₀^{SL} t₁^{SL}, t₂^{SL}, . . . ) may denote a set of slots of a sidelink resource pool.

In the resource evaluation action (e.g., the first action in FIG. 26), the wireless device may determine a sensing window (e.g., the sensing window shown in FIG. 24 and FIG. 25 based on sl-SensingWindow) based on the triggering the resource selection procedure. The wireless device may determine a selection window (e.g., the selection window shown in FIG. 24 and FIG. 25 based on sl-Selection WindowList) based on the triggering the resource selection procedure. The wireless device may determine one or more reservation periods/intervals (e.g., parameter sl-ResourceReservePeriodList) for resource reservation. In an example, a candidate single-slot resource for transmission R_{x,y} may be defined as a set of L_{subCH} contiguous sub-channels with sub-channel x+j in slot t_{y}^{SL} where j=0, . . . , L_{subCH}−1. The wireless device may assume that a set of L_{subCH} contiguous sub-channels in the resource pool within a time interval [n+T₁, n+T₂] correspond to one candidate single-slot resource (e.g., referring to FIG. 24 and FIG. 25). A total number of candidate single-slot resources may be denoted by Mₜₒₜₐₗ. In an example, referring to FIG. 24 and FIG. 25, the sensing window may be defined by a number of slots in a time duration of [n−T₀, n−T_{proc,0}). The wireless device may monitor a first subset of the slots, of a sidelink resource pool, within the sensing window. The wireless device may not monitor a second subset of the slots than the first subset of the slots due to half duplex. The wireless device may perform the following actions based on PSCCH decoded and RSRP measured in the first subset of the slots. In an example, an internal parameter Th(pᵢ, pⱼ) may be set to the corresponding value of RSRP threshold indicated by the i-th field in sl-ThresPSSCH-RSRP-List, where i=pᵢ+(pⱼ−1)*8.

Referring to FIG. 26 and FIG. 27, in the resource evaluation action (e.g., the first action in FIG. 26), the wireless device may initialize a candidate resource set (e.g., a set S_{A}) to be a set of candidate resources. In an example, the candidate resource set may be the union of candidate resources within the selection window. In an example, a candidate resource may be a candidate single-subframe resource. In an example, a candidate resource may be a candidate single-slot resource. In an example, the set S_{A} may be initialized to a set of all candidate single-slot resources.

Referring to FIG. 26 and FIG. 27, in the resource evaluation action (e.g., the first action in FIG. 26), the wireless device may perform a first exclusion for excluding second resources from the candidate resource set based on first resources and one or more reservation periods/intervals. In an example, the wireless device may not monitor the first resources within a sensing window. In an example, the one or more reservation periods/intervals may be configured/associated with a resource pool of the second resources. In an example, the wireless device may determine the second resources within a selection window which might be reserved by a transmission transmitted via the first resources based on the one or more reservation periods/intervals. In an example, the wireless device may exclude a candidate single-slot resource R_{x,y} from the set S_{A} based on following conditions:
the wireless device has not monitored slot tₘ^{SL} in the sensing window.
for any periodicity value allowed by the parameter sl-ResourceReservePeriodList and a hypothetical SCI format 1-A received in the slot tₘ^{SL} with “Resource reservation period” field set to that periodicity value and indicating all sub-channels of the resource pool in this slot, condition c of a second exclusion would be met.

Referring to FIG. 26 and FIG. 27, in the resource evaluation action (e.g., the first action in FIG. 26), the wireless device may perform a second exclusion for excluding third resources from the candidate resource set. In an example, a SCI may indicate a resource reservation of the third resources. The SCI may further indicate a priority value (e.g., indicated by a higher layer parameter sl-Priority). The wireless device may exclude the third resources from the candidate resource set based on a reference signal received power (RSRP) of the third resources being higher than an RSRP threshold (e.g., indicated by a higher layer parameter sl-ThresPSSCH-RSRP-List). The RSRP threshold may be related to the priority value based on a mapping list of RSRP thresholds to priority values configured and/or pre-configured to the wireless device. In an example, a base station may transmit a message to the wireless device for configuring the mapping list. The message may be a radio resource control (RRC) message. In an example, the mapping list may be pre-configured to the wireless device. A memory of the wireless device may store the mapping list. In an example, a priority indicated by the priority value may be a layer 1 priority (e.g., physical layer priority). In an example, a bigger priority value may indicate a higher priority of a sidelink transmission. A smaller priority value may indicate a lower priority of the sidelink transmission. In another example, a bigger priority value may indicate a lower priority of a sidelink transmission. A smaller priority value may indicate a higher priority of the sidelink transmission. In an example, the wireless device may exclude a candidate single-slot resource R_{x,y} from the set S_{A} based on following conditions:
a) the wireless device receives an SCI format 1-A in slot tₘ^{SL}, and “Resource reservation period” field, if present, and “Priority” field in the received SCI format 1-A indicate the values P_{rsvp_RX} and prio_{RX};
b) the RSRP measurement performed, for the received SCI format 1-A, is higher than Th(prio_{RX}, prio_{TX});
c) the SCI format received in slot tₘ^{SL} or the same SCI format which, if and only if the “Resource reservation period” field is present in the received SCI format 1-A, is assumed to be received in slot(s) t_{m+q×P′}_{_{rsvp_RX}} determines the set of resource blocks and slots which overlaps with R_{x,y+j×P′}_{_{rsvp_TX}} for q=1, 2, . . . , Q and j=0, 1, . . . , Cᵣₑₛₑₗ−1. Here, P_{rsvp_RX}′ is P_{rsvp_RX} converted to units of logical slots,

$$Q = ⌈ \frac{{T}_{scal}}{{P}_{rsvp \_ RX}} ⌉$$

if P_{rsvp_RX}<T_{scal} and n′−m≤P_{rsvp_RX}′, where t_{n′}^{SL}=n if slot n belongs to the set (t₀^{SL}, t₁^{SL}, . . . , t_{T}_{ₘₐₓ}^{SL}), otherwise slot t_{n′}^{SL} is the first slot after slot n belonging to the set (t₀^{SL}, t₁^{SL}, . . . t_{T}_{ₘₐₓ}^{SL}); otherwise Q=1. T_{scal} is set to selection window size T2 converted to units of ms.

Referring to FIG. 26 and FIG. 27, in the resource evaluation action (e.g., the first action in FIG. 26), the wireless device may determine whether remaining candidate resources in the candidate resource set are sufficient for selecting resources for the one or more sidelink transmissions of the TB based on a condition, after performing the first exclusion and the second exclusion. In an example, the condition may be the total amount of the remaining candidate resources in the candidate resource set being more than X percent (e.g., indicated by a higher layer parameter sl-TxPercentageList) of the candidate resources in the candidate resource set before performing the first exclusion and the second exclusion. If the condition is not met, the wireless device may increase the RSRP threshold used to exclude the third resources with a value Y and iteratively re-perform the initialization, first exclusion, and second exclusion until the condition being met. In an example, if the number of remaining candidate single-slot resources in the set S_{A} is smaller than X·Mₜₒₜₐₗ, then Th(pᵢ, pⱼ) may be increased by 3 dB and the procedure continues with re-performing of the initialization, first exclusion, and second exclusion until the condition being met. In an example, the wireless device may report the set S_{A} (e.g., the remaining candidate resources of the candidate resource set) to the higher layer of the wireless device. In an example, the wireless device may report the set S_{A} (e.g., the remaining candidate resources of the candidate resource set when the condition is met) to the higher layer of the wireless device, based on that the number of remaining candidate single-slot resources in the set S_{A} being greater than or equal to X·Mₜₒₜₐₗ.

Referring to FIG. 26 and FIG. 27, in the resource selection action (e.g., the second action in FIG. 26), the wireless device (e.g., the higher layer of the wireless device) may select fourth resources from the remaining candidate resources of the candidate resource set (e.g., the set S_{A} reported by the physical layer) for the one or more sidelink transmissions of the TB. In an example, the wireless device may randomly select the fourth resources from the remaining candidate resources of the candidate resource set.

Referring to FIG. 26 and FIG. 27, in an example, if a resource r; from the set (r₀, r₁, r₂, . . . ) is not a member of S_{A} (e.g., the remaining candidate resources of the candidate resource set when the condition is met), the wireless device may report re-evaluation of the resource rᵢ to the higher layers.

Referring to FIG. 26 and FIG. 27, in an example, if a resource rᵢ′ from the set (r₀′, r₁′, r₂′, . . . ) meets the conditions below, then the wireless device may report pre-emption of the resource r′ to the higher layers.
rᵢ′ is not a member of S_{A}, and
rᵢ′ meets the conditions for the second exclusion, with Th(prio_{RX}, prio_{TX}) set to a final threshold for reaching X·Mₜₒₜₐₗ, and
the associated priority prio_{RX}, satisfies one of the following conditions:
   sl-PreemptionEnable is provided and is equal to ‘enabled’ and prio_{TX}>prio_{RX}
   sl-PreemptionEnable is provided and is not equal to ‘enabled’, and prio_{RX}<prioₚᵣₑ and prio_{TX}>prio_{RX}

In an example, if the resource rᵢ is indicated for re-evaluation by the wireless device (e.g., the physical layer of the wireless device), the higher layer of the wireless device may remove the resource ra from the set (r₀, r₁, r₂, . . . ). In an example, if the resource rᵢ′ is indicated for pre-emption by the wireless device (e.g., the physical layer of the wireless device), the higher layer of the wireless device may remove the resource rᵢ′ from the set (r₀′, r₁′, r₂′, . . . ). The higher layer of the wireless device may randomly select new time and frequency resources from the remaining candidate resources of the candidate resource set (e.g., the set S_{A} reported by the physical layer) for the removed resources rᵢ and/or rᵢ′. The higher layer of the wireless device may replace the removed resources rᵢ and/or rᵢ′ by the new time and frequency resources. For example, the wireless device may remove the resources rᵢ and/or rᵢ′ from the set (r₀, r₁, r₂, . . . ) and/or the set (r₀′, r₁′, r₂′, . . . ) and add the new time and frequency resources to the set (r₀, r₁, r₂, . . . ) and/or the set (r₀′, r₁′, r₂′, . . . ) based on the removing of the resources rᵢ and/or rᵢ′.

Sidelink pre-emption may happen between a first wireless device and a second wireless device. The first wireless device may select first resources for a first sidelink transmission. The first sidelink transmission may have a first priority. The second wireless device may select second resources for a second sidelink transmission. The second sidelink transmission may have a second priority. The first resources may partially and/or fully overlap with the second resources. The first wireless device may determine a resource collision between the first resources and the second resources based on that the first resources and the second resources being partially and/or fully overlapped. The resource collision may imply fully and/or partially overlapping between the first resources and the second resources in time, frequency, code, power, and/or spatial domain. Referring to an example of FIG. 18, the first resources may comprise one or more first sidelink resource units in a sidelink resource pool. The second resources may comprise one or more second sidelink resource units in the sidelink resource pool. A partial resource collision between the first resources and the second resources may indicate that the at least one sidelink resource unit of the one or more first sidelink resource units belongs to the one or more second sidelink resource units. A full resource collision between the first resources and the second resources may indicate that the one or more first sidelink resource units may be the same as or a subset of the one or more second sidelink resource units. In an example, a bigger priority value may indicate a lower priority of a sidelink transmission. A smaller priority value may indicate a higher priority of the sidelink transmission. In an example, the first wireless device may determine the sidelink pre-emption based on the resource collision and the second priority being higher than the first priority. That is, the first wireless device may determine the sidelink pre-emption based on the resource collision and a value of the second priority being smaller than a value of the first priority. In another example, the first wireless device may determine the sidelink pre-emption based on the resource collision, the value of the second priority being smaller than a priority threshold, and the value of the second priority being smaller than the value of the first priority.

Referring to FIG. 25, a first wireless device may trigger a first resource selection procedure for selecting first resources (e.g., selected resources after resource selection with collision in FIG. 25) for a first sidelink transmission. A second wireless device may transmit an SCI indicating resource reservation of the first resource for a second sidelink transmission. The first wireless device may determine a resource collision on the first resources between the first sidelink transmission and the second sidelink transmission. The first wireless device may trigger a resource re-evaluation (e.g., a resource evaluation action of a second resource selection procedure) at and/or before time (m−T3) based on the resource collision. The first wireless device may trigger a resource reselection (e.g., a resource selection action of the second resource selection procedure) for selecting second resources (e.g., reselected resources after resource reselection in FIG. 25) based on the resource re-evaluation. The start time of the second resources may be time m.

A UE may receive one or more messages (e.g., RRC messages and/or SIB messages) comprising configuration parameters of a sidelink BWP. The configuration parameters may comprise a first parameter (e.g., sl-StartSymbol) indicating a sidelink starting symbol. The first parameter may indicate a starting symbol (e.g., symbol #0, symbol #1, symbol #2, symbol #3, symbol #4, symbol #5, symbol #6, symbol #7, etc.) used for sidelink in a slot. For example, the slot may not comprise a SL-SSB (S-SSB). In an example, the UE may be (pre-) configured with one or more values of the sidelink starting symbol per sidelink BWP. The configuration parameters may comprise a second parameter (e.g., sl-LengthSymbols) indicating number of symbols (e.g., 7 symbols, 8 symbols, 9 symbols, 10 symbols, 11 symbols, 12 symbols, 13 symbols, 14 symbols, etc.) used sidelink in a slot. For example, the slot may not comprise a SL-SSB (S-SSB). In an example, the UE may be (pre-) configured with one or more values of the sidelink number of symbols (symbol length) per sidelink BWP.

The configuration parameters of the sidelink BWP may indicate one or more sidelink (communication) resource pools of the sidelink BWP (e.g., via SL-BWP-PoolConfig and/or SL-BWP-PoolConfigCommon). A resource pool may be a sidelink receiving resource pool (e.g., indicated by sl-RxPool) on the configured sidelink BWP. For example, the receiving resource pool may be used for PSFCH transmission/reception, if configured. A resource pool may be a sidelink transmission resource pool (e.g., indicated by sl-TxPool, and/or sl-ResourcePool) on the configured sidelink BWP. For example, the transmission resource pool may comprise resources by which the UE is allowed to transmit NR sidelink communication (e.g., in exceptional conditions and/or based on network scheduling) on the configured BWP. For example, the transmission resource pool may be used for PSFCH transmission/reception, if configured.

Configuration parameters of a resource pool may indicate a size of a sub-channel of the resource pool (e.g., via sl-SubchannelSize) in unit of PRB. For example, the sub-channel size may indicate a minimum granularity in frequency domain for sensing and/or for PSSCH resource selection. Configuration parameters of a resource pool may indicate a lowest/starting RB index of a sub-channel with a lowest index in the resource pool with respect to lowest RB index RB index of the sidelink BWP (e.g., via sl-StartRB-Subchannel). Configuration parameters of a resource pool may indicate a number of sub-channels in the corresponding resource pool (e.g., via sl-NumSubchannel). For example, the sub-channels and/or the resource pool may consist of contiguous PRBs.

Configuration parameters of a resource pool may indicate configuration of one or more sidelink channels on/in the resource pool. For example, the configuration parameters may indicate that the resource pool is configured with PSSCH and/or PSCCH and/or PSFCH.

Configuration parameters of PSCCH may indicate a time resource for a PSCCH transmission in a slot. Configuration parameters of PSCCH (e.g., SL-PSCCH-Config) may indicate a number of symbols of PSCCH (e.g., 2 or 3) in the resource pool (e.g., via sl-TimeResourcePSCCH). Configuration parameters of PSCCH (e.g., SL-PSCCH-Config) may indicate a frequency resource for a PSCCH transmission in a corresponding resource pool (e.g., via sl-FreqResourcePSCCH). For example, the configuration parameters may indicate a number of PRBs for PSCCH in a resource pool, which may not be greater than a number of PRBs of a sub-channel of the resource pool (sub-channel size).

Configuration parameters of PSSCH may indicate one or more DMRS time domain patterns (e.g., PSSCH DMRS symbols in a slot) for the PSSCH that may be used in the resource pool.

A resource pool may or may not be configured with PSFCH. Configuration parameters of PSFCH may indicate a period for the PSFCH in unit/number of slots within the resource pool (e.g., via sl-PSFCH-Period). For example, a value 0 of the period may indicate that no resource for PSFCH is configured in the resource pool and/or HARQ feedback for (all) transmissions in the resource pool is disabled. For example, the period may be 1 slot or 2 slots or 4 slots, etc. Configuration parameters of PSFCH may indicate a set of PRBs that are (actually) used for PSFCH transmission and reception (e.g., via sl-PSFCH-RB-Set). For example, a bitmap may indicate the set of PRBs, wherein a leftmost bit of the bitmap may refer to a lowest RB index in the resource pool, and so on. Configuration parameters of PSFCH may indicate a minimum time gap between PSFCH and the associated PSSCH in unit of slots (e.g., via sl-MinTimeGapPSFCH). Configuration parameters of PSFCH may indicate a number of PSFCH resources available for multiplexing HARQ-ACK information in a PSFCH transmission (e.g., via sl-PSFCH-CandidateResourceType).

A UE may be configured by higher layers (e.g., by RRC configuration parameters) with one or more sidelink resource pools. A sidelink resource pool may be for transmission of PSSCH and/or for reception of PSSCH. A sidelink resource pool may be associated with sidelink resource allocation mode 1 and/or sidelink resource allocation mode 2. In the frequency domain, a sidelink resource pool consists of one or more (e.g., sl-NumSubchannel) contiguous sub-channels. A sub-channel consists of one or more (e.g., sl-SubchannelSize) contiguous PRBs. For example, higher layer parameters (e.g., RRC configuration parameters) may indicate a number of sub-channels in a sidelink resource pool (e.g., sl-Num Subchannel) and/or a number of PRBs per sub-channel (e.g., sl-SubchannelSize).

A set of slots that may belong to a sidelink resource pool. The set of slots may be denoted by (t₀^{SL}, t₁^{SL}, . . . , t_{T}_{ₘₐₓ}₋₁^{SL}) where 0≤tᵢ^{SL}<10240×2^{μ}, 0<i<Tₘₐₓ. The slot index may be relative to slot #0 of the radio frame corresponding to SFN 0 of the serving cell or DFN 0. The set includes all the slots except N_{S_SSB} slots in which S-SS/PSBCH block (S-SSB) is configured. The set includes all the slots except N_{nonSL} slots in each of which at least one of Y-th, (Y+1)-th, . . . , (Y+X−1)-th OFDM symbols are not semi-statically configured as UL as per the higher layer parameter (e.g., tdd-UL-DL-ConfigurationCommon-r16 of the serving cell if provided and/or sl-TDD-Configuration-r16 if provided and/or sl-TDD-Config-r16 of the received PSBCH if provided). For example, a higher layer (e.g., MAC or RRC) parameter may indicate a value of Y as the sidelink starting symbol of a slot (e.g., sl-StartSymbol). For example, a higher layer (e.g., MAC or RRC) parameter may indicate a value of X as the number of sidelink symbols in a slot (e.g., si-LengthSymbols). The set includes all the slots except one or more reserved slots. The slots in the set may be arranged in increasing order of slot index. The UE may determine the set of slot assigned to a sidelink resource pool based on a bitmap (b₀, b₁, . . . , b_{L}_{_{bitmap}}₋₁ associated with the resource pool where L_{bitmap} the length of the bitmap is configured by higher layers. A slot tₖ^{SL} (0≤k<10240×2^{μ}−N_{S}_{_{SSB}}−N_{nonSL}−N_{reserved}) may belong to the set of slots if bₖ′=1 where k′=k mod L_{bitmap}. The slots in the set are re-indexed such that the subscripts i of the remaining slots t′ᵢ^{SL} are successive {0, 1, . . . , T′ₘₐₓ−1} where T′ₘₐₓ is the number of the slots remaining in the set.

The UE may determine the set of resource blocks assigned to a sidelink resource pool, wherein the resource pool consists of N_{PRB} PRBs. The sub-channel m for m=0,1, . . . , numSubchannel−1 consists of a set of n_{subCHsize} contiguous resource blocks with the physical resource block number n_{PRB}=n_{subCHRBstart}+m′n_{subCHsize}+j for j=0,1, . . . , n_{subCHsize}−1, where n_{subCHRBstart} and n_{subCHsize} are given by higher layer parameters sl-StartRB-Subchannel and sl-SubchannelSize, respectively. A UE may not be expected to use the last N_{PRB} mod n_{subCHsize} PRBs in the resource pool.

A UE may be provided/configured with a number of symbols in a resource pool for PSCCH (e.g., by sl-TimeResourcePSCCH). The PSCCH symbols may start from a second symbol that is available for sidelink transmissions in a slot. The UE may be provided/configured with a number of PRBs in the resource pool for PSCCH (e.g., by sl-FreqResourcePSCCH). The PSCCH PRBs may start from the lowest PRB of the lowest sub-channel of the associated PSSCH, e.g., for a PSCCH transmission with a SCI format 1-A. In an example, PSCCH resource/symbols may be configured in every slot of the resource pool. In an example, PSCCH resource/symbols may be configured in a subset of slot of the resource pool (e.g., based on a period comprising two or more slots).

In an example, each PSSCH transmission is associated with an PSCCH transmission. The PSCCH transmission may carry the 1^{st} stage of the SCI associated with the PSSCH transmission. The 2^{nd} stage of the associated SCI may be carried within the resource of the PSSCH. In an example, the UE transmits a first SCI (e.g., 1^{st} stage SCI, SCI format 1-A) on PSCCH according to a PSCCH resource configuration in slot n and PSCCH resource m. For the associated PSSCH transmission in the same slot, the UE may transmit one transport block (TB) with up to two layers (e.g., one layer or two layers). The number of layers (v) may be determined according to the ‘Number of DMRS port’ field in the SCI. The UE may determine the set of consecutive symbols within the slot for transmission of the PSSCH. The UE may determine the set of contiguous resource blocks for transmission of the PSSCH. Transform precoding may not be supported for PSSCH transmission. For example, wideband precoding may be supported for PSSCH transmission.

The UE may set the contents of the second SCI (e.g., 2^{nd} stage SCI, SCI format 2-A). The UE may set values of the SCI fields comprising the ‘HARQ process number’ field, the ‘NDI’ field, the ‘Source ID’ field, the ‘Destination ID’ field, the ‘HARQ feedback enabled/disabled indicator’ field, the ‘Cast type indicator’ field, and/or the ‘CSI request’ field, as indicated by higher (e.g., MAC and/or RRC) layers. The UE may set the contents of the second SCI (e.g., 2^{nd} stage SCI, SCI format 2-B). The UE may set values of the SCI fields comprising the ‘HARQ process number’ field, the ‘NDI’ field, the ‘Source ID’ field, the ‘Destination ID’ field, the ‘HARQ feedback enabled/disabled indicator’ field, the ‘Zone ID’ field, and/or the ‘Communication range requirement’ field, as indicated by higher (e.g., MAC and/or RRC) layers.

In an example, one transmission scheme may be defined for the PSSCH and may be used for all PSSCH transmissions. PSSCH transmission may be performed with up to two antenna ports, e.g., with antenna ports 1000-1001.

In sidelink resource allocation mode 1, for PSSCH and/or PSCCH transmission, dynamic grant, configured grant type 1 and/or configured grant type 2 may be supported. The configured grant Type 2 sidelink transmission is semi-persistently scheduled by a SL grant in a valid activation DCI.

The UE may transmit the PSSCH in the same slot as the associated PSCCH. The (minimum) resource allocation unit in the time domain may be a slot. The UE may transmit the PSSCH in consecutive symbols within the slot. The UE may not transmit PSSCH in symbols which are not configured for sidelink. A symbol may be configured for sidelink, according to higher layer parameters indicating the starting sidelink symbol (e.g., startSLsymbols) and a number of consecutive sidelink symbols (e.g., lengthSLsymbols). For example, startSLsymbols is the symbol index of the first symbol of lengthSLsymbols consecutive symbols configured for sidelink. Within the slot, PSSCH resource allocation may start at symbol startSLsymbols+1 (e.g., second sidelink symbol of the slot). The UE may not transmit PSSCH in symbols which are configured for use by PSFCH, if PSFCH is configured in this slot. The UE may not transmit PSSCH in the last symbol configured for sidelink (e.g., last sidelink symbol of the slot). The UE may not transmit PSSCH in the symbol immediately preceding the symbols which are configured for use by PSFCH, if PSFCH is configured in this slot. FIG. 19 shows an example of sidelink symbols and the PSSCH resource allocation within the slot.

A Sidelink grant may be received dynamically on the PDCCH, and/or configured semi-persistently by RRC, and/or autonomously selected by the MAC entity of the UE. The MAC entity may have a sidelink grant on an active SL BWP to determine a set of PSCCH duration(s) in which transmission of SCI occurs and a set of PSSCH duration(s) in which transmission of SL-SCH associated with the SCI occurs. A sidelink grant addressed to SLCS-RNTI with NDI=1 is considered as a dynamic sidelink grant. The UE may be configured with Sidelink resource allocation mode 1. The UE may for each PDCCH occasion and for each grant received for this PDCCH occasion (e.g., for the SL-RNTI or SLCS-RNTI of the UE), use the sidelink grant to determine PSCCH duration(s) and/or PSSCH duration(s) for initial transmission and/or one or more retransmission of a MAC PDU for a corresponding sidelink process (e.g., associated with a HARQ buffer and/or a HARQ process ID).

The UE may be configured with Sidelink resource allocation mode 2 to transmit using pool(s) of resources in a carrier, based on sensing or random selection. The MAC entity for each Sidelink process may select to create a selected sidelink grant corresponding to transmissions of multiple MAC PDUs, and SL data may be available in a logical channel. The UE may select a resource pool, e.g., based on a parameter enabling/disabling sidelink HARQ feedback. The UE may perform the TX resource (re-) selection check on the selected pool of resources. The UE may select the time and frequency resources for one transmission opportunity from the resources pool and/or from the resources indicated by the physical layer, according to the amount of selected frequency resources and the remaining PDB of SL data available in the logical channel(s) allowed on the carrier. The UE may use the selected resource to select a set of periodic resources spaced by the resource reservation interval for transmissions of PSCCH and PSSCH corresponding to the number of transmission opportunities of MAC PDUs. The UE may consider the first set of transmission opportunities as the initial transmission opportunities and the other set(s) of transmission opportunities as the retransmission opportunities. The UE may consider the sets of initial transmission opportunities and retransmission opportunities as the selected sidelink grant. The UE may consider the set as the selected sidelink grant. The UE may use the selected sidelink grant to determine the set of PSCCH durations and the set of PSSCH durations.

The UE may for each PSSCH duration and/or for each sidelink grant occurring in this PSSCH duration, select a MCS table allowed in the pool of resource which is associated with the sidelink grant. The UE may determine/set the resource reservation interval to a selected value (e.g., 0 or more). In an example, if the configured sidelink grant has been activated and this PSSCH duration corresponds to the first PSSCH transmission opportunity within this period of the configured sidelink grant, the UE may set the HARQ Process ID to the HARQ Process ID associated with this PSSCH duration and, if available, all subsequent PSSCH duration(s) occurring in this period for the configured sidelink grant. The UE may flush the HARQ buffer of Sidelink process associated with the HARQ Process ID. The UE may deliver the sidelink grant, the selected MCS, and the associated HARQ information to the Sidelink HARQ Entity for this PSSCH duration.

The MAC entity may include at most one Sidelink HARQ entity for transmission on SL-SCH, which maintains a number of parallel Sidelink processes. The (maximum) number of transmitting Sidelink processes associated with the Sidelink HARQ Entity may be a value (e.g., 16). A sidelink process may be configured for transmissions of multiple MAC PDUs. For transmissions of multiple MAC PDUs with Sidelink resource allocation mode 2, the (maximum) number of transmitting Sidelink processes associated with the Sidelink HARQ Entity may be a second value (e.g., 4). A delivered sidelink grant and its associated Sidelink transmission information may be associated with a Sidelink process. Each Sidelink process may support one TB.

For each sidelink grant and for the associated Sidelink process, the Sidelink HARQ Entity may obtain the MAC PDU to transmit from the Multiplexing and assembly entity, if any. The UE may determine Sidelink transmission information of the TB for the source and destination pair of the MAC PDU. The UE may set the Source Layer-1 ID to the 8 LSB of the Source Layer-2 ID of the MAC PDU, and set the Destination Layer-1 ID to the 16 LSB of the Destination Layer-2 ID of the MAC PDU. The UE may set the following information of the TB: cast type indicator, HARQ feedback enabler/disabler, priority, NDI, RV. The UE may deliver the MAC PDU, the sidelink grant and the Sidelink transmission information of the TB to the associated Sidelink process. The MAC entity of the UE may instruct the associated Sidelink process to trigger a new transmission or a retransmission.

In sidelink resource allocation mode 1, for sidelink dynamic grant, the PSSCH transmission may be scheduled by a DCI (e.g., DCI format 3_0). In sidelink resource allocation mode 1, for sidelink configured grant type 2, the configured grant may be activated by a DCI (e.g., DCI format 3_0). In sidelink resource allocation mode 1, for sidelink dynamic grant and sidelink configured grant type 2 the “Time gap” field value m of the DCI may provide an index m+1 into a slot offset table (e.g., the table may be configured by higher layer parameter sl-DCI-ToSL-Trans). The table value at index m+1 may be referred to as slot offset K_{SL}. The slot of the first sidelink transmission scheduled by the DCI may be the first SL slot of the corresponding resource pool that starts not earlier than T_{DL}−T_{TA}/2+K_{SL}×Tₛₗₒₜ, where T_{DL} is the starting time of the downlink slot carrying the corresponding DCI, T_{TA} is the timing advance value corresponding to the TAG of the serving cell on which the DCI is received and K_{SL} is the slot offset between the slot of the DCI and the first sidelink transmission scheduled by DCI and Tₛₗₒₜ is the SL slot duration. The “Configuration index” field of the DCI, if provided and not reserved, may indicate the index of the sidelink configured type 2. In sidelink resource allocation mode 1, for sidelink configured grant type 1, the slot of the first sidelink transmissions may follow the higher layer configuration.

The resource allocation unit in the frequency domain may be the sub-channel. The sub-channel assignment for sidelink transmission may be determined using the “Frequency resource assignment” field in the associated SCI. The lowest sub-channel for sidelink transmission may be the sub-channel on which the lowest PRB of the associated PSCCH is transmitted. For example, if a PSSCH scheduled by a PSCCH would overlap with resources containing the PSCCH, the resources corresponding to a union of the PSCCH that scheduled the PSSCH and associated PSCCH DM-RS may not be available for the PSSCH.

The redundancy version for transmitting a TB may be given by the “Redundancy version” field in the 2^{nd} stage SCI (e.g., SCI format 2-A or 2-B). The modulation and coding scheme I_{MCS} may be given by the ‘Modulation and coding scheme’ field in the 1^{st} stage SCI (e.g., SCI format 1-A). The UE may determine the MCS table based on the following: a pre-defined table may be used if no additional MCS table is configured by higher layer parameter sl-MCS-Table; otherwise an MCS table is determined based on the ‘MCS table indicator’ field in the 1^{st} stage SCI (e.g., SCI format 1-A). The UE may use I_{MCS} and the MCS table determined according to the previous step to determine the modulation order (Qₘ) and Target code rate (R) used in the physical sidelink shared channel.

The UE may determine the TB size (TBS) based on the number of RES (N_{RE}) within the slot. The UE may determine the number of REs allocated for PSSCH within a PRB (N_{RE}′) by N_{RE}′=N_{sc}^{RB}(N_{symb}^{sh}−N_{symb}^{PSFCH})−Nₒₕ^{PRB}−N_{RE}^{DMRS}, where N_{sc}^{RB}=12 is the number of subcarriers in a physical resource block; N_{symb}^{sh}=sl-LengthSymbols-2, where sl-LengthSymbols is the number of sidelink symbols within the slot provided by higher layers; N_{symb}^{PSFCH}=3 if ‘PSFCH overhead indication’ field of SCI format 1-A indicates “1”, and N_{symb}^{PSFCH}=0 otherwise, if higher layer parameter sl-PSFCH-Period is 2 or 4. If higher layer parameter sl-PSFCH-Period is 0, N_{symb}^{PSFCH}=0. If higher layer parameter sl-PSFCH-Period is 1, N_{symb}^{PSFCH}=3. Nₒₕ^{PRB} is the overhead given by higher layer parameter sl-X-Overhead. N_{RE}^{DMRS} is given by higher layer parameter sl-PSSCH-DMRS-TimePattern. The UE may determine the total number of REs allocated for PSSCH (N_{RE}) by N_{RE}=N_{RE}′·n_{PRB}−N_{RE}^{SCI,1}−N_{RE}^{SCI,2}, where n_{PRB} is the total number of allocated PRBs for the PSSCH; N_{RE}^{SCI,1} is the total number of RES occupied by the PSCCH and PSCCH DM-RS; N_{RE}^{SCI,2} is the number of coded modulation symbols generated for 2^{nd}-stage SCI transmission (prior to duplication for the 2^{nd} layer, if present). The UE may determine the TBS based on the total number of REs allocated for PSSCH (N_{RE}) and/or the modulation order (Qₘ) and Target code rate (R) used in the physical sidelink shared channel.

For the single codeword q=0 of a PSSCH, the block of bits b^{(q)}(0), . . . , b^{(q)}(M_{bit}^{(q)}−1), where M_{bit}^{(q)}=M_{bit,SCI2}^{(q)}+M_{bit,data}^{(q)} is the number of bits in codeword q transmitted on the physical channel, may be scrambled prior to modulation (e.g., using a scrambling sequence based on a CRC of the PSCCH associated with the PSSCH). For the single codeword q=0, the block of scrambled bits may be modulated, resulting in a block of complex-valued modulation symbols d^{(q)}(0), . . . , d^{(q)} (M_{symb}^{(q)}−1) where M_{symb}^{(q)}=M_{symb,1}^{(q)}+M_{symb,2}^{(q)}. Layer mapping may be done with the number of layers v∈{1,2}, resulting in x(i)=[x⁽⁰⁾(i) . . . x^{(v-1)}(i)]^{T}, i=0,1, . . . , M_{symb}^{layer}−1. The block of vectors [x⁽⁰⁾(i) . . . x^{(v-1)}(i)]^{T} may be pre-coded where the precoding matrix W equals the identity matrix and M_{symb}^{ap}=M_{symb}^{layer}. For each of the antenna ports used for transmission of the PSSCH, the block of complex-valued symbols z^{(p)}(0), . . . , z^{(p)}(M_{symb}^{ap}−1) may be multiplied with the amplitude scaling factor β_{DMRS}^{PSSCH} in order to conform to the transmit power and mapped to resource elements (k′, l)_{p,μ} in the virtual resource blocks assigned for transmission, where k′=0 is the first subcarrier in the lowest-numbered virtual resource block assigned for transmission. The mapping operation may be done in two steps: first, the complex-valued symbols corresponding to the bit for the 2^{nd}-stage SCI in increasing order of first the index k′ over the assigned virtual resource blocks and then the index l, starting from the first PSSCH symbol carrying an associated DM-RS, wherein the corresponding resource elements in the corresponding physical resource blocks are not used for transmission of the associated DM-RS, PT-RS, or PSCCH; secondly, the complex-valued modulation symbols not corresponding to the 2^{nd}-stage SCI shall be in increasing order of first the index k′ over the assigned virtual resource blocks, and then the index l with the starting position, wherein the resource elements are not used for 2^{nd}-stage SCI in the first step; and/or the corresponding resource elements in the corresponding physical resource blocks are not used for transmission of the associated DM-RS, PT-RS, CSI-RS, or PSCCH.

The resource elements used for the PSSCH in the first OFDM symbol in the mapping operation above, including DM-RS, PT-RS, and/or CSI-RS occurring in the first OFDM symbol, may be duplicated in the OFDM symbol immediately preceding the first OFDM symbol in the mapping (e.g., for AGC training purposes). Virtual resource blocks may be mapped to physical resource blocks according to non-interleaved mapping.

For non-interleaved VRB-to-PRB mapping, virtual resource block n is mapped to physical resource block n. For a PSCCH, the block of bits b(0), . . . , b(M_{bit}−1), where M_{bit} is the number of bits transmitted on the physical channel, may be scrambled prior to modulation, resulting in a block of scrambled bits \tilde{b}(0), . . . , \tilde{b}(M_{bit}−1) according to \tilde{b}(i)=(b(i)+c(i)) mod 2. The block of scrambled bits \tilde{b}(0), . . . , \tilde{b}(M_{bit}−1) may be modulated using QPSK, resulting in a block of complex-valued modulation symbols d(0), . . . , d(M_{symb}−1) where M_{symb}=M_{bit}/2. The set of complex-valued modulation symbols d(0), . . . , d(M_{symb}−1) may be multiplied with the amplitude scaling factor β_{DMRS}^{PSCCH} in order to conform to the transmit power and mapped in sequence starting with d(0) to resource elements (k, l)_{p,μ} assigned for transmission, and not used for the demodulation reference signals associated with PSCCH, in increasing order of first the index k over the assigned physical resources, and then the index l on antenna port p (e.g., p=2000).

The resource elements used for the PSCCH in the first OFDM symbol in the mapping operation above, including DM-RS, PT-RS, and/or CSI-RS occurring in the first OFDM symbol, may be duplicated in the immediately preceding OFDM symbol (e.g., for AGC training purposes).

For sidelink resource allocation mode 1, a UE upon detection of a first SCI (e.g., SCI format 1-A) on PSCCH may decode PSSCH according to the detected second SCI (e.g., SCI formats 2-A and/or 2-B), and associated PSSCH resource configuration configured by higher layers. The UE may not be required to decode more than one PSCCH at each PSCCH resource candidate. For sidelink resource allocation mode 2, a UE upon detection of a first SCI (e.g., SCI format 1-A) on PSCCH may decode PSSCH according to the detected second SCI (e.g., SCI formats 2-A and/or 2-B), and associated PSSCH resource configuration configured by higher layers. The UE may not be required to decode more than one PSCCH at each PSCCH resource candidate. A UE may be required to decode neither the corresponding second SCI (e.g., SCI formats 2-A and/or 2-B) nor the PSSCH associated with a first SCI (e.g., SCI format 1-A) if the first SCI indicates an MCS table that the UE does not support.

Throughout this disclosure, a (sub) set of symbols of a slot, associated with a resource pool of a sidelink BWP, that is (pre-) configured for sidelink communication (e.g., transmission and/or reception) may be referred to as ‘sidelink symbols’ of the slot. The sidelink symbols may be contiguous/consecutive symbols of a slot. The sidelink symbols may start from a sidelink starting symbol (e.g., indicated by an RRC parameter), e.g., sidelink starting symbol may be symbol #0 or symbol #1, and so on. The sidelink symbols may comprise one or more symbols of the slot, wherein a parameter (e.g., indicated by RRC) may indicate the number of sidelink symbols of the slot. The sidelink symbols may comprise one or more guard symbols, e.g., to provide a time gap for the UE to switch from a transmission mode to a reception mode. For example, the OFDM symbol immediately following the last symbol used for PSSCH, PSFCH, and/or S-SSB may serve as a guard symbol. As shown in FIG. 19, the sidelink symbols may comprise one or more PSCCH resources/occasions and/or one or more PSCCH resources and/or zero or more PSFCH resources/occasions. The sidelink symbols may comprise one or more AGC symbols.

An AGC symbol may comprise duplication of (content of) the resource elements of the immediately succeeding/following symbol (e.g., a TB and/or SCI may be mapped to the immediately succeeding symbol). In an example, the AGC symbol may be a dummy OFDM symbol. In an example, the AGC symbol may comprise a reference signal. For example, the first OFDM symbol of a PSSCH and its associated PSCCH may be duplicated (e.g., in the AGC symbol that is immediately before the first OFDM symbol of the PSSCH). For example, the first OFDM symbol of a PSFCH may be duplicated (e.g., for AGC training purposes).

In a sidelink slot structure configuration, the first symbol is used for automatic gain control (AGC) and the last symbol is used for a gap. During an AGC symbol, a receiving and/or sensing UE may perform AGC training. For AGC training, a UE detects the energy/power of a signal in the channel during the AGC symbol and applies a hardware gain to maximize the signal amplitude to the dynamic range of the analog to digital convertor (ADC) at the receiver. The receiver may determine a gain for a received signal, and an AGC duration allows time for the receiver to determine the gain and apply the gain (e.g., hardware gain component) such that when the receiver receives the data (e.g., in the next symbol(s), the gain of the amplifier has already been adjusted.

For sidelink communication, the transmitter UE may not map data/control information to the AGC symbol. The AGC symbol may not be used for communication and sending information other than energy. The AGC symbol may be a last symbol prior to an earliest symbol of a transmission, such that a gap between AGC symbol and signal/channel transmission is minimized and an accurate gain is determined for receiving the following signal/channel. For example, the AGC symbol, as shown in FIG. 19, maybe a symbol immediately preceding the first/earliest symbol of a resource used for a transmission via a channel (e.g., PSCCH and/or PSSCH and/or PSFCH transmission).

In an example, the AGC symbol may comprise duplication of resource elements of the next (immediately following) OFDM symbol. In an example, the AGC symbol may comprise any signal, e.g., a per-defined signal/sequence and/or dummy information. The purpose of the AGC symbol is to allow the receiver UE to perform AGC training and adjust the hardware gain for a most efficient reception of the following signal.

Throughout this disclosure, the “AGC symbol” may be referred to as “duplicated symbol” and/or “duplication” and/or “the symbol used for duplication” and/or “the immediately preceding symbol comprising the duplication of a first symbol”.

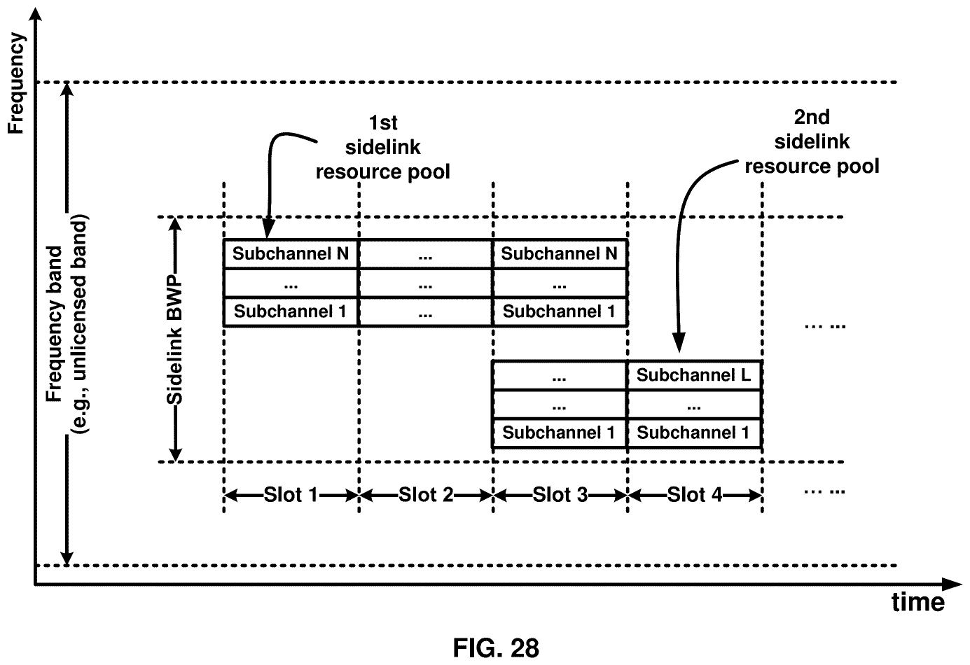

FIG. 28 illustrates an example of the sidelink resource allocation as per an aspect of an embodiment of the present disclosure. The example may be based on a sidelink resource allocation mode 1 and/or sidelink resource allocation mode 2. A transmitting wireless device may select, among a plurality of destinations (e.g., among a plurality of receiving wireless devices), a destination (e.g., a receiving wireless device) for SL transmission. For example, the transmitting wireless device may schedule the SL transmission using a grant received from a base station (e.g., mode 1). For example, the grant from the base station may not be associated with a particular destination (e.g., the first destination and/or the second destination in FIG. 28) of a SL transmission. For example, the grant may not comprise a destination ID (e.g., identifier of a receiving wireless device and/or a group identifier of one or more receiving wireless device) of the SL transmission. The transmitting wireless device may select the destination for the SL transmission, e.g., after or in response to receiving the grant from the base station. The transmitting wireless device may determine active time (e.g., DRX active time) when a SL DRX operation is configured. For example, the active time comprises one or more times (e.g., time duration, time interval, time window and/or the like). For example, the transmitting wireless device may select the first destination to transmit, via and/or using the grant (e.g., and/or a respective SL grant) a respective SCI and/or a transport block. The selecting the first destination may be in response to a time domain resource allocation indicated by the grant (e.g., and/or the respective SL grant) being in the SL DRX active time of the first destination. For example, the transmitting wireless device may not select the second destination to transmit, via and/or using the grant (e.g., and/or a respective SL grant), a respective SCI and/or a transport block, e.g., in response to the time domain resource allocation indicated by the grant (e.g., and/or the respective SL grant) being outside the SL DRX active time of the second destination. For example, the transmitting wireless device may select the second destination to transmit, via and/or using the grant (e.g., and/or a respective SL grant), a respective SCI and/or a transport block. The selecting the second destination may be in response to a time domain resource allocation indicated by the grant (e.g., and/or the respective SL grant) being in the SL DRX active time of the second destination. For example, the transmitting wireless device may not select the first destination to transmit, via and/or using the grant (e.g., and/or a respective SL grant), a respective SCI and/or a transport block, e.g., in response to the time domain resource allocation indicated by the grant (e.g., and/or the respective SL grant) being outside the SL DRX active time of the first destination.

In the example embodiment(s) of the presence disclosure, a grant (e.g., DCI format 3_0) that the transmitting wireless device receives, e.g., via a Uu interface, from a base station may be referred to as an SL grant (e.g., a first-stage SCI and/or a second-stage SCI) that the transmitting wireless device transmits, for SL transmission, to the receiving wireless device. For example, example embodiment(s) of the presence disclosure may refer the grant as the SL grant, e.g., if the transmitting wireless device determines one or more first field values of the SL grant based on one or more second fields of the grant. For example, the one or more first field values indicate at least one of: a value of a priority of the SL transmission, a frequency resource assignment of the SL transmission (e.g., PSSCH), a time resource assignment of the SL transmission (e.g. PSSCH), a resource reservation period, a DMRS pattern of the PSSCH, a second-stage SCI format, a value of a Beta_offset indicator, a value of a number of DMRS port for SL transmission (e.g., PSSCH), a modulation and coding scheme of the SL transmission (e.g., PSSCH), a value of PSFCH overhead indication, a value of HARQ process number for the SL transmission (e.g., an SL TB of PSSCH), a value of new data indicator, a redundancy version of the SL transmission (e.g., an SL TB of PSSCH), a source ID (e.g., Source Layer-1 ID and/or Source Layer-2 ID) of the transmitting wireless device, a destination ID (e.g., Destination Layer-1 ID and/or Destination Layer-2 ID) of the receiving wireless device, a value of HARQ feedback enabled/disabled indicator indicating whether a HARQ feedback of the SL transmission (e.g., an SL TB of PSSCH) is enabled or disabled, a value of a cast type indicator, an indication of a CSI request, and/or a zone identifier. For example, the one or more second values may indicate at least one of: a resource pool index indicating the number of resource pools for transmission configured by the higher layer parameter (e.g., sl-TxPoolScheduling), a time gap, a HARQ process number (e.g., of the SL transmission), a new data indicator indicating whether the SL transmission of the HARQ process number is a new transmission or a retransmission, a lowest index of the subchannel allocation to the initial transmission (e.g., SL transmission), a value of a frequency resource assignment field of SL grant (e.g., SCI format 1-A), a value of a time resource assignment field of SL grant (e.g., SCI format 1-A), a value of a PSFCH-to-HARQ feedback timing indicator indicating a PSFCH resource for a PSFCH transmission with HARQ-ACK information in response to a PSSCH transmission or reception, a value of PUCCH resource indicator indicating a PUCCH resource to transmit HARQ-ACK information to the base station for a PSSCH transmission with HARQ-ACK information in response to a PSSCH transmission, a value of configuration index, a value of a counter sidelink assignment index.

The example of FIG. 28 may be based on sidelink resource allocation mode 2 as per an aspect of an embodiment of the present disclosure. For example, a transmitting wireless device configured (e.g., selecting) the sidelink resource allocation mode 2 may determine an SL grant based on configuration parameters associated with the sidelink resource allocation mode 2. For example, the transmitting wireless device configured (e.g., selecting) the sidelink resource allocation mode 2 may determine the SL grant without receiving a grant from a base station. The transmitting wireless device may select, among a plurality of destinations (e.g., among a plurality of receiving wireless devices), a destination (e.g., a receiving wireless device) for SL transmission. For example, the transmitting wireless device may determine one or more field values of the SL grant. For example, the transmitting wireless device may determine a destination ID (e.g., identifier of a receiving wireless device and/or a group identifier of one or more receiving wireless device) of the SL grant for the SL transmission. A transmitting wireless device may determine active time (e.g., DRX active time) of a particular destination (e.g., a first destination and/or a second destination in FIG. 28), e.g., if the transmitting wireless device transmits configuration parameters of SL DRX operation to the particular destination. For example, the active time comprises one or more times (e.g., time duration, time interval, time window and/or the like). For example, the transmitting wireless device may select the first destination to transmit, via and/or using the SL grant a respective SCI and/or a transport block. The selecting the first destination may be in response to a time domain resource allocation indicated by the SL grant being in the SL DRX active time of the first destination. For example, the transmitting wireless device may not select the second destination to transmit, via and/or using the SL grant, a respective SCI and/or a transport block, e.g., in response to the time domain resource allocation indicated by the SL grant being outside the SL DRX active time of the second destination. For example, the transmitting wireless device may select the second destination to transmit, via and/or using the SL grant, a respective SCI and/or a transport block. The selecting the second destination may be in response to a time domain resource allocation indicated by the SL grant being in the SL DRX active time of the second destination. For example, the transmitting wireless device may not select the first destination to transmit, via and/or using the SL grant, a respective SCI and/or a transport block, e.g., in response to the time domain resource allocation indicated by the SL grant being outside the SL DRX active time of the first destination.

For example, the transmitting wireless device may transmit, to the receiving wireless device and/or via a PSCCH, the first-stage SCI (e.g., the SL grant and/or SCI format 1-A). For example, the first-stage SCI may comprise scheduling information of PSSCH. The PSSCH may comprise the second-stage SCI and/or a sidelink transport block (TB) (e.g., SL-SCH) of the SL transmission. For example, the transmitting wireless device may transmit, to the receiving wireless device and/or via the PSSCH, the second-stage SCI (e.g., the sidelink grant, SCI format 2-A, SCI format 2-B, and/or SCI format 2-C) in which one or more field values are determined based on the grant received from the base station. For example, the transmitting wireless device may transmit, to the receiving wireless device and/or via the PSSCH, the sidelink TB (e.g., SL-SCH) of the SL transmission.

The amount of data traffic carried over cellular networks is expected to increase for many years to come. The number of users/devices is increasing, and each user/device accesses an increasing number and variety of services, e.g., video delivery, large files, images. This requires not only high capacity in the network, but also provisioning of very high data rates to meet customer expectations on interactivity and responsiveness. More spectrum is therefore needed for cellular operators to meet the increasing demand. Considering user expectations of high data rates along with seamless mobility, it is beneficial that more spectrum be made available for deploying macro cells as well as small cells for cellular systems.

Striving to meet the market demands, there has been increasing interest from operators in deploying some complementary access utilizing unlicensed spectrum to meet the traffic growth. This is exemplified by the large number of operator-deployed Wi-Fi networks and the 3GPP standardization of interworking solutions with Wi-Fi, e.g., LTE/WLAN interworking. This interest indicates that unlicensed spectrum, when present, may be an effective complement to licensed spectrum for cellular operators to address the traffic explosion in some scenarios, such as hotspot areas. For example, licensed assisted access (LAA) and/or new radio on unlicensed band(s) (NR-U) may offer an alternative for operators to make use of unlicensed spectrum while managing one radio network, thus offering new possibilities for optimizing the network's efficiency.

Similar to the LAA feature introduced in LTE, the NR-U (e.g., in Rel-16 and Rel-17), the motivation and primary use of unlicensed spectrum is to expand 3GPP technologies into more vertical domains to support wider applications, enabling new services and creating more wireless product types. By not restricting to always rely on operator licensed carriers or dedicated carriers for V2X/D2D or Public Safety, which may not be always available depending on network deployment and availability, if devices are able to communicate directly with each other or sending out messages/signals on a frequency spectrum that is always readily available, this can be used to create exciting new services, applications and even saving lives in disaster areas (e.g. recent devastating flooding events in the US and China).

For example, sidelink in unlicensed spectrum, or a.k.a. SL-U, may be used in following applications and/or services. For example, for applications such as augmented reality (AR)/virtual reality (VR) interactive and gaming services, which often demands very low latency and high data rate communication over sidelink directly between devices. In another example, SL over unlicensed is also ideal for smart home applications, where tens of low-cost devices connecting to a central node like a customer premise equipment (CPE) within a home network to gain access to internet or just directly communicating with each other to share contents such as movies, videos, music, etc. When there are hundreds or thousands of these devices located within a cell area, it is not expected that all of these devices are to be connected to the mobile network and/or need to have the capability of supporting the Uu interface. Therefore, in order to enable these types of applications and expanding the usage of sidelink, the making use of unlicensed bands is the only choice. For wearable devices such as smart watches, bands, etc., it is already common not to have the capability to connect to a mobile network. In this case, unlicensed spectrum and sidelink connection to a smartphone is the only way for gaining access to the Internet. In another example, out of coverage network areas, such as disaster zones, rural sites, mines, deep basements, coast lines, or dangerous areas where unmanned vehicles, robots or UAVs needs to gain access into, unlicensed spectrum and NR sidelink communication is an ideal combination. In another example, IIoT/smart factory application is equally able to take an advantage of sidelink communication utilizing unlicensed spectrum. For traffic offloading from the Uu interface to sidelink in unlicensed band in a factory setting where not all communication data needs to go through a base station. Especially for coordination data messages between factory/warehouse moving equipment such that they don't collide with each other or to perform a synchronized movement between wheels. When the factory/warehouse is operating NR-U, the sidelink operation in the licensed spectrum can be dynamically control by the gNB as well. In another example, even for the cellular V2X (C-V2X) application, the current allocation of ITS spectrum in 5.9 GHz band dedicated for V2X communication only has very limited spectrum bandwidth. In some regions, total of 30 MHz while others have at most 40 MHz of bandwidth is allocated. This allocated bandwidth is to be shared at least between LTE and NR V2X. It is a well-known problem that this limited bandwidth allocation will not be able to support high data rate applications such as extended sensor data sharing and fully autonomous driving. With the local/regional regulators to increase the ITS bandwidth or designating additional spectrum for C-V2X, utilizing unlicensed spectrum is a viable option via SL carrier aggregation, where a vehicle UE transmits its essential/safety message data on the ITS band and the high data rate imaging over the unlicensed spectrum.

Increased sidelink data rate is motivated by applications such as sensor information (video) sharing between vehicles with high degree of driving automation. Commercial use cases could require data rates in excess of what is currently possible. Increased data rate can be achieved with the support of sidelink carrier aggregation and/or sidelink over unlicensed spectrum. Furthermore, by enhancing the FR2 sidelink operation, increased data rate can be more efficiently supported on FR2. While the support of new carrier frequencies and larger bandwidths would also allow to improve its data rate, the main benefit would come from making sidelink more applicable for a wider range of applications. More specifically, with the support of unlicensed spectrum and the enhancement in FR2, sidelink will be in a better position to be implemented in commercial devices since utilization of the ITS band is limited to ITS safety related applications.

Sidelink communication(s), e.g., in FIG. 17, may use radio resource(s) in an unlicensed band. For example, a sidelink BWP may be (pre-) configured in an unlicensed band/carrier. For example, a sidelink resource pool of the sidelink BWP may be (pre-) configured in an unlicensed band. For example, a base station may configure the sidelink BWP and/or the sidelink resource pool of the sidelink BWP in an unlicensed band. A first communication (e.g., UL and/or DL transmission) between a first device (e.g., a base station) and a second device (e.g., a first wireless device) via Uu interface and a second communication (e.g., sidelink transmission) between the second device (e.g., the first wireless device) and a third device (e.g., a second wireless device) via a sidelink may be performed in a same band or in different spectrum bands. For example, a wireless device may receive, from the base station, configuration parameters of communications via Uu interface and configuration parameters of communications via a sidelink. The configuration parameters may indicate that communications via Uu interface and via a sidelink are configured/scheduled in a same unlicensed band. The configuration parameters may indicate that communications via Uu interface and via a sidelink are configured/scheduled in different unlicensed bands. The configuration parameters may indicate that communications via Uu interface are configured/scheduled in a licensed band, while the communications via a sidelink are configured/scheduled in an unlicensed band. The configuration parameters may indicate that communications via Uu interface are configured/scheduled in an unlicensed band, while the communications via a sidelink are configured/scheduled in a licensed band.

In an example embodiment, Listen-before-talk (LBT) may be required for transmission in an unlicensed/shared band. A cell configured in unlicensed/shared cell may be referred to as an unlicensed/shared cell. The unlicensed/shared cell may be referred to as a LAA cell and/or a NR-U cell. The unlicensed/shared cell may be operated as non-standalone with an anchor cell in a licensed band or standalone without an anchor cell in a licensed band. LBT may comprise a clear channel assessment (CCA). For example, a carrier that is configured in the unlicensed/shared cell may be referred to as an unlicensed carrier. The base station may configure a cell on the carrier. For example, the unlicensed/shared cell may be configured on the unlicensed carrier.

For example, in an LBT procedure, equipment may apply a CCA before using the unlicensed/shared cell or channel. The CCA may comprise an energy detection (ED) that determines the presence of other signals on a channel (e.g., channel is occupied) or absence of other signals on a channel (e.g., channel is clear). A regulation of a country may impact the LBT procedure. For example, European and Japanese regulations mandate the usage of LBT in the unlicensed/shared bands, such as the 5 GHz unlicensed/shared band. Apart from regulatory requirements, carrier sensing via LBT may be one way for fairly sharing the unlicensed/shared spectrum among different devices and/or networks attempting to utilize the unlicensed/shared spectrum.

In an example embodiment, discontinuous transmission on an unlicensed/shared band with limited maximum transmission duration may be enabled. Some of these functions may be supported by one or more signals to be transmitted from the beginning of a discontinuous downlink transmission and/or a sidelink transmission in the unlicensed/shared band. Channel reservation may be enabled by the transmission of signals, after or in response to gaining channel access based on a successful LBT operation. Other nodes may receive the signals (e.g., transmitted for the channel reservation) with an energy level above a certain threshold that may sense the channel to be occupied. Functions that may need to be supported by one or more signals for operation in unlicensed/shared band with the discontinuous downlink transmission and/or sidelink transmission may comprise one or more of the following: detection of the downlink transmission and/or sidelink transmission in unlicensed/shared band (comprising cell identification) by wireless devices; time & frequency synchronization of wireless devices.

In an example embodiment, downlink/uplink and/or sidelink transmission and frame structure design for operation in an unlicensed/shared band may employ subframe, slot, mini-slot, and/or symbol boundary alignment according to timing relationships, e.g., across serving cells (e.g., configured on one or more carriers) aggregated by carrier aggregation. This may not imply that base station transmissions start at the subframe, (mini-) slot, and/or symbol boundary. The operation via the unlicensed/shared band may support transmitting PDCCH, PDSCH, PSBCH, PSCCH, PSSCH, and/or PSFCH, for example, when not all OFDM symbols are available for transmission in a slot according to LBT.

An LBT procedure may be employed for fair and friendly coexistence of a 3GPP system (e.g., LTE and/or NR) with other operators and/or radio access technologies (RATs), e.g., WiFi, and/or the like, operating in unlicensed/shared band. For example, a node attempting to transmit on a carrier in unlicensed/shared band may perform a CCA as a part of an LBT procedure to determine if a channel is free (e.g., idle) for use. For example, the channel may be confined within a range of frequency. For example, a regulation of a country may indicate the range of frequency that requires the LBT procedure to use the channel in the unlicensed/shared bands. For example, the channel may be 20 MHz or a multiple of 20 MHz. The channel may be referred to as an LBT band, a subband, and/or the like. The LBT procedure may comprise an ED performed by the node to determine if the channel is being free (e.g., idle) or used (e.g., occupied) for use. The wireless device may perform the ED for the range of frequency comprising the channel. For example, regulatory requirements in some regions, e.g., in Europe, specify an ED threshold such that if a node measures, detects, and/or receives energy greater than the ED threshold, the node determines that the channel is being used/occupied, e.g., by another node(s) (and/or is not free or idle for use/access). While nodes may follow such regulatory requirements, a node may optionally use a lower ED threshold for ED than that specified by regulatory requirements. A radio access technology (e.g., WiFi, LTE and/or NR) may employ a mechanism to adaptively change the ED threshold. For example, NR-U may employ a mechanism to adaptively lower the ED threshold from an upper bound. An adaptation mechanism may not preclude static or semi-static setting of the ED threshold. In an example, Category 4 LBT (CAT4 LBT) mechanism or other type of LBT mechanisms may be implemented.

In an example, if the detected energy during a CCA (e.g., initial CCA) period is lower than an ED threshold, the device may access the channel for a period referred to as Channel Occupancy Time (COT). Otherwise, the device may start an extended CCA period, in which the detected energy is again compared against the ED threshold until channel access is granted. The regulation may specify the CCA slot duration (e.g., 9 us in the 5 GHz band, and 5 us in the 60 GHz band), the initial and extended CCA check times (e.g., a multiple of 5 us for initial CCA and 8+m×5 μs for extended CCA in the 60 GHz band, where m controls the backoff), and the ED threshold (e.g., −72 dBm for a 20 MHz channel bandwidth in the 5 GHz band, and −47 dBm for 40 dBm of radiated power in the 60 GHz band).

In an example, a LBT failure of a LBT procedure on the channel in an unlicensed band may indicate a channel access failure on the channel. For example, a LBT failure of a LBT procedure on the channel may indicate that the channel is not idle or is busy (e.g., occupied by another device(s) during one or more sensing slot durations (e.g., CCA periods) before a transmission via the channel (e.g., or immediately before the transmission via the channel). In an example, a LBT success of a LBT procedure on the channel may indicate a channel access success of the channel. In an example, a LBT success of a LBT procedure on the channel may indicate that the channel is idle during one or more sensing slot durations (e.g., CCA periods) before a transmission via the channels (e.g., or immediately before the transmission via channels).

Various example LBT mechanisms may be implemented. In an example, for some signals, in some implementation scenarios, in some situations, and/or in some frequencies no LBT procedure may be performed by the transmitting entity. An LBT procedure referred in example embodiment(s) may comprise Category 1 LBT, Category 2 LBT, Category 3 LBT, and/or Category 4 LBT. A type of an LBT (e.g., Category 1 LBT, Category 2 LBT, Category 3 LBT, and/or Category 4 LBT) may be indicated

In an example, Category 1 (CAT1 LBT, e.g., no LBT) may be implemented in one or more cases. For example, a channel in unlicensed/shared band may be hold by a first device (e.g., for uplink, downlink, and/or sidelink transmissions). The first device may share the channel with a second device. For example, a second device may take over the channel in unlicensed/shared band for uplink, downlink, and/or sidelink transmissions, e.g., of a control signal (e.g., HARQ feedback of the uplink, downlink, and/or the sidelink transmissions) without performing the CAT1 LBT.

In an example, Category 2 (CAT2 LBT that may be referred to as one-shot LBT and/or a short LBT) may be implemented. The Category 2 may be an LBT without random back-off. The duration of time determining that the channel is idle may be deterministic (e.g., by a regulation). A transmitting device (e.g., a base station in Uu interface, a wireless device in Uu interface, and/or a transmitting device in a sidelink communication) may transmit a grant (e.g., uplink grant and/or a sidelink grant) indicating a type of LBT (e.g., CAT2 LBT) to a receiving device (e.g., a base station in Uu interface, a wireless device in Uu interface, and/or a receiving device in a sidelink communication).

In an example, Category 3 (CAT3, e.g. LBT with random back-off with a contention window of fixed size) may be implemented. The LBT procedure may have the following procedure as one of its components. The transmitting device may draw a random number N within a contention window. The size of the contention window may be specified by the minimum and maximum value of N. The size of the contention window may be fixed. The random number N may be employed in the LBT procedure to determine the duration of time that the channel is sensed to be idle before the transmitting device transmits on the channel.

In an example, Category 4 (CAT4, e.g. LBT with random back-off with a contention window of variable size) may be implemented. The transmitting device may draw a random number N within a contention window. The size of contention window may be specified by the minimum and maximum value of N. The transmitting device may vary the size of the contention window when drawing the random number N. The random number N may be used in the LBT procedure to determine the duration of time that the channel is sensed to be idle before the transmitting device transmits on the channel.

In an example, a transmission burst(s) may comprise a continuous (unicast, multicast, broadcast, and/or combination thereof) transmission on a carrier component (CC). A first transmission burst(s) may be a continuous transmission from a first device (e.g., a base station in Uu interface, a wireless device in Uu interface, and/or a transmitting device in a sidelink communication) to a second device (e.g., a base station in Uu interface, a wireless device in Uu interface, and/or a receiving device in a sidelink communication) on the channel of the CC in an unlicensed/shared band. A second transmission burst(s) may be a continuous transmission from the second device (e.g., a base station in Uu interface, a wireless device in Uu interface, and/or a transmitting device in a sidelink communication) to the first device (e.g., a base station in Uu interface, a wireless device in Uu interface, and/or a receiving device in a sidelink communication) on the channel of the CC in the unlicensed/shared band. In an example, the first transmission burst(s) and the second transmission burst(s) on the channel in the unlicensed/shared band may be scheduled in a TDM manner over the same unlicensed/shared band. Switching between the first transmission burst and the second transmission burst(s) may require an LBT (e.g., CAT1 LBT, CAT2 LBT, CAT3 LBT, and/or CAT4 LBT). For example, an instant in time may be part of the first transmission burst or the second transmission burst.

COT sharing may comprise a mechanism by which one or more devices share a channel, in an unlicensed/shared band, that is sensed as idle by at least one of the one or more devices. For example, one or more first devices may occupy the channel via an LBT (e.g., the channel is sensed as idle based on CAT4 LBT) and one or more second devices may use and/or share, for a transmission of the one or more second devices, the channel using a particular type of an LBT within a maximum COT (MCOT) limit.

In an example, various of LBT types may be employed for Channel occupancy time (COT) sharing. A transmitting device (e.g., a base station in Uu interface, a wireless device in Uu interface, and/or a transmitting device in a sidelink communication) may transmit a grant (e.g., uplink grant and/or a sidelink grant) to a receiving device (e.g., a base station in Uu interface, a wireless device in Uu interface, and/or a receiving device in a sidelink communication). For example, the grant (e.g., uplink grant and/or a sidelink grant) may indicate a trigger of the COT sharing and/or a type of LBT (e.g., CAT1 LBT, CAT2 LBT, CAT2 LBT, and/or CAT2 LBT) to be used for the receiving device during the COT acquired and/or shared by the transmitting device.

In an example, a regulation of certain region(s), e.g., Europe and Japan may prohibit continuous transmission in the unlicensed band and may impose limits on the COT, e.g., the maximum continuous time a device may use the channel. The maximum continuous time in which the device gains an access based on LBT procedure and uses the channel may be referred to as a maximum channel occupancy time (MCOT). The MCOT in the 5 GHZ band may be limited to a certain period, e.g., 2 ms, 4 ms, or 6 ms, depending on the channel access priority class, and it may be increased up to 8-10 ms.

The MCOT in the 60 GHz band may be 9 ms. For example, the regulation (e.g., for the 5 GHZ and 60 GHZ bands) may allow the device (e.g., a wireless device of a Uu interface and/or a transmitting wireless device in a sidelink communication) to share the COT with the associated devices. For example, the associated device may be a wireless device and/or a base station in the Uu interface. For example, the associated device may be a wireless device of the sidelink (e.g., unicast, multicast, and/or broadcast) communication. For example, the device may get an (e.g., initial) access to the channel through the LBT procedure, e.g., for COT (or MCOT). The device may transmit, to the associated device, a control message and/or a control signal indicating sharing the COT (or MCOT) with the associated device and/or remaining time of the COT, and starting/ending times (e.g., in terms of symbol(s), slot(s), SFN(s), and/or a combination thereof) of the COT that the associated device to use/share the channel. The associated device may skip (e.g., may not perform) the CCA check and/or may perform Category 1 LBT procedure on the channel during the shared COT. The associated wireless device may transmit data via the channel during the shared COT based on a particular LBT type. The particular LBT type may comprise Category 1, Category 2, Category 3, and/or Category 4. For example, the MCOT may be defined and/or configured per priority class, logical channel priority, and/or device specific.

In an example, a first device may gain an access through the LBT procedure for a first (e.g., UL, DL, and/or sidelink) transmission in an unlicensed band. If the first device shares, with a second device, the channel, the second device may perform a second (e.g., UL, DL, and/or sidelink) transmission with a dynamic grant and/or a configured grant (e.g., Type 1 and/or Type2) with a particular LBT (e.g., CAT2 LBT) that the second device performs on a channel shared by a first device. The second device may use and/or occupy, e.g., by performing UL, DL, and/or sidelink transmission, the channel during the COT. For example, the first device performing the first transmission based on a configured grant (e.g., Type 1, Type2, autonomous UL) may transmit a control information (e.g., DCI, UCI, SCI, and/or MAC CE) indicating the COT sharing. The COT sharing may comprise switching, within a (M) COT, from the first transmission (e.g., UL, DL, and/or sidelink transmission) of the first device to the second transmission (e.g., UL, DL, and/or sidelink transmission) of the second device. A starting time of the second transmission in the COT sharing, e.g., triggered by the first device, may be indicated in one or more ways. For example, one or more parameters in the control information may indicate the starting time of the COT sharing at which the second device starts to access the channel and/or an ending time of the COT sharing at which the second device terminates/ends to use the channel. For example, resource configuration(s) of configured grant(s) may indicate the starting time and/or the ending time.

In an example, single and/or multiple switching of transmissions within a shared COT may be supported. For example, a switching of transmissions within the shared COT may comprise switching from the first transmission (e.g., UL, DL, and/or sidelink transmission) of the first device to the second transmission (e.g., UL, DL, and/or sidelink transmission) of the second device within the shared COT. A type of LBT required/performed, by the second device, for the second transmission may be different depending on a time gap between the first transmission and the second transmission. The time gap may be referred to as a COT gap. For example, the second wireless device may perform CAT1 LBT (e.g., may not perform or may skip LBT procedure) for the second transmission switched from the first transmission within the shared COT, e.g., if the time gap is less than a first time value, e.g., 16 us. For example, the second wireless device may perform CAT2 LBT for the second transmission switched from the first transmission within the shared COT, e.g., if the time gap is longer than the first time value and does not exceed a second time value, e.g., 25 us. For example, the second wireless device may perform CAT2 LBT for the second transmission switched from the first transmission within the shared COT, e.g., if the time gap exceeds the second time value. For example, the second wireless device may perform CAT4 LBT for the second transmission switched from the first transmission within the shared COT, e.g., if the time gap exceeds the second time value.

A sidelink resource of a sidelink communication may be configured in an unlicensed band. For example, a first wireless device may perform, during a period in one or more symbols, an LBT procedure on a channel comprising a sidelink resource (e.g., comprising PSBCH, PSCCH, PSSCH, and/or PSFCH) via which the first wireless device schedules (or is scheduled) to transmit a data and/or a signal to a second wireless device. For example, the LBT procedure may start during a first symbol that is at least one symbol or a certain period (e.g., in terms of p or ms) before and/or prior to a starting symbol of the sidelink resource (and/or a starting symbol of the transmission of the data and/or the signal). For example, the LBT procedure may end before and/or prior to the starting symbol of the sidelink resource (and/or the starting symbol of the transmission of the data and/or the signal). The wireless device may not transmit, via the sidelink resource (e.g., comprising PSBCH, PSCCH, PSSCH, and/or PSFCH), the data and/or the signal to the second wireless device, e.g., in response to the LBT procedure indicating the channel is busy. The wireless device may transmit, via the sidelink resource (e.g., comprising PSBCH, PSCCH, PSSCH, and/or PSFCH), the data and/or the signal to the second wireless device, e.g., in response to the LBT procedure indicating the channel is idle.

For example, the first wireless device may determine an AGC symbol located before or prior to a starting symbol of the PSBCH, PSCCH, PSSCH, and/or PSFCH via which the first wireless device schedules (or is scheduled) to transmit the data and/or the signal to the second wireless device. For example, the AGC symbol may be located one symbol before the starting symbol of sidelink resource (e.g., PSBCH, PSCCH, PSSCH, and/or PSFCH). Referring to FIG. 19, the AGC symbol is the second symbol in the slot (e.g., one symbol before a starting symbol (e.g., the third symbol in the slot) of a PSCCH (in the third, fourth and the fifth symbols in a subchannel in the slot) and/or a starting symbol (e.g., the third symbol in the slot) of PSSCH (e.g., from the third symbol to the eighth symbol in the slot), and/or a starting symbol (e.g., the tenth symbol in the slot) of a PSFCH (e.g., the eleventh symbol in the slot). For example, the first wireless device may start the LBT procedure at least one symbol or a certain period (e.g., in terms of u or ms) before and/or prior to a starting symbol of the AGC symbol. For example, the first wireless device may end the LBT procedure at least one symbol or a certain period (e.g., in terms of u or ms) before and/or prior to a starting symbol of the AGC symbol. For example, referring to FIG. 19, the first wireless device may start the LBT procedure.

For example, the LBT procedure may start during a first symbol that is at least one symbol or a certain period (e.g., in terms of u or ms) before and/or prior to a starting symbol of the AGC symbol (e.g., located one symbol before the PSCCH, PSSCH, and/or PSFCH in FIG. 19). For example, the LBT procedure may end before and/or prior to the starting symbol. The wireless device may not transmit, via the AGC symbol, an AGC signal (e.g., that is for the second wireless device to determine/adjust/train parameter values of its AGC) to the second wireless device, e.g., in response to the LBT procedure indicating the channel is busy. The wireless device may transmit, via the AGC symbol, the AGC signal to the second wireless device, e.g., in response to the LBT procedure indicating the channel is idle.

A wireless device may receive message(s) comprising configuration parameters of one or more sidelink resource pools configured in an unlicensed spectrum. The wireless device may select and/or determine a sidelink resource pool from the one or more sidelink resource pools for a sidelink transmission and/or a sidelink reception in the unlicensed spectrum. The wireless device may select and/or a sidelink resource from the sidelink resource pool for the sidelink transmission and/or sidelink reception in the unlicensed spectrum.

In an example, a first wireless device may be a transmitting wireless device of one or more sidelink transmissions. A second wireless device may be a receiving wireless device of the one or more sidelink transmissions. For example, the second wireless device may be a desired/intended receiver of the one or more sidelink transmissions. For example, a SCI (e.g., a second-stage SCI) scheduling the one or more sidelink transmissions may comprise/indicate an ID (e.g., destination ID) of the second wireless device indicating that the second wireless device is a desired/intended/destination receiver of the one or more sidelink transmissions. For example, the second wireless device may not be a desired/intended receiver of the one or more sidelink transmissions, e.g., if a SCI (e.g., a second-stage SCI) scheduling the one or more sidelink transmissions may not comprise/indicate an ID (e.g., destination ID) of the second wireless device. For example, the second wireless device that is not a desired/intended receiver of the one or more sidelink transmissions may be a device that monitors and/or receives the SCI (e.g., comprising an ID (e.g., destination ID) of another wireless device) transmitted by the first wireless devices using the one or more sidelink resource pools. In an example, the one or more sidelink transmissions may comprise PSCCH and/or PSSCH transmissions. In an example, the one or more sidelink transmissions may comprise one or more unicast transmissions, one or more groupcast transmissions, and/or one or more broadcast transmissions.

A base station and/or a wireless device may transmit a message to the first wireless device. The message may comprise an RRC message, SIB, a MAC CE, DCI, and/or SCI. The message may comprise a field indicating/configuring one or more sidelink resource pools in a sidelink BWP. The message may further indicate/configure (e.g., frequency location of) the sidelink BWP in a frequency band, e.g., an unlicensed band. In an example, the sidelink BWP may be in an unlicensed/shared spectrum/carrier/band/cell with a plurality of RATs (e.g., wifi, etc.). The one or more sidelink resource pools and/or sidelink BWP may be pre-configured to the first wireless device. A bandwidth of the frequency band may be at least as wide as (e.g., wider than or equal to) a minimum regularized bandwidth in a respective unlicensed band. In an example, the message transmitted by the base station and/or the wireless device may comprise/indicate a threshold indicating a bandwidth (e.g., a minimum bandwidth). The bandwidth indicated by the threshold may be wider than or equal to the minimum regularized bandwidth in the unlicensed spectrum. In an example, the threshold indicating the bandwidth may be pre-configured to the first wireless device. In an example, the frequency band may have a frequency band identifier (ID)/index. Each of the one or more sidelink resource pools (e.g., in the frequency band) may have a sidelink resource pool ID/index. The message, received by the first wireless device and/or the second wireless device from the base station and/or the wireless device, may comprise/indicate/configure the frequency band ID/index and the sidelink resource pool ID/index for the each of the one or more sidelink resource pools in the frequency band. The message may comprise/indicate/configure a mapping (e.g., an association) between the frequency band and the one or more sidelink resource pools in the frequency band. The mapping may indicate that the ID/index of the frequency band is associated with the IDs/Indexes of the one or more sidelink resource pools in the frequency band. In an example, the frequency ID/index, the sidelink resource pool IDs/indexes of the one or more sidelink resource pools in the frequency band, and/or the mapping between the frequency band and the one or more sidelink resource pools in the frequency band may be pre-configured to the first wireless device and/or the second wireless device. The first wireless device may select, from the one or more sidelink resource pools, a sidelink grant comprising one or more resources for the one or more sidelink transmissions. The first wireless device may select the sidelink grant based on a resource selection procedure in the frequency band (e.g., unlicensed band). In an example, the resource selection procedure may comprise at least one of sensing procedures and/or actions described in FIG. 25, FIG. 26, and/or FIG. 27.

A sidelink resource pool may be confined within an unlicensed band. The unlicensed band may comprise a channel having a bandwidth (e.g., a range of frequency) requiring an LBT procedure. For example, a wireless device determine/select the sidelink resource pool and determine/select a sidelink resource among one or more sidelink resources of the sidelink resource pool. The wireless device may perform the LBT on the channel. The bandwidth may comprise one or more subchannel of the sidelink resource. The sidelink BWP comprising the sidelink resource pool may be confined in the unlicensed band. The sidelink BWP comprising the sidelink resource pool may be confined in the unlicensed band.

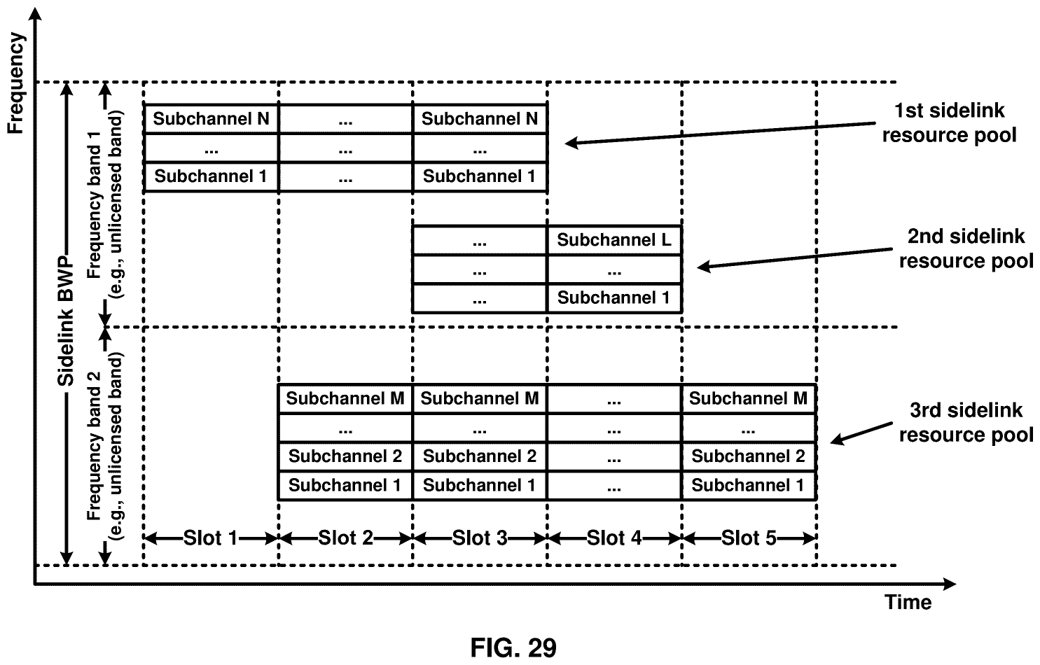

FIG. 29 illustrates an example configuration of a sidelink resource pool in a frequency band as per an aspect of an example embodiment of the present disclosure. In FIG. 29, a sidelink resource pool may refer to the one in FIG. 18. For example, a wireless device may receive a message (e.g., RRC message and/or a SIB) from a base station and/or another wireless device. The message may comprise configuration parameters of sidelink BWP. The configuration parameters may indicate a bandwidth (e.g., and/or frequency size) of the sidelink BWP. The configuration parameters may indicate a first sidelink resource pool is configured in the sidelink BWP. The configuration parameters may indicate that the sidelink BWP is confined and/or configured in a particular frequency band (e.g., unlicensed band). For example, the size of the sidelink BWP may be equal to or smaller than a minimum regularized bandwidth for which the wireless device performs an LBT procedure to gain access on a channel. For example, the size of the sidelink BWP may be smaller than or equal to 20 MHz, e.g., the particular frequency band is an unlicensed band in 5 GHZ, 6 GHZ, and/or FR1 band. For example, the configuration parameters may further indicate a second sidelink resource pool is configured in the sidelink BWP. A first sidelink resource of the first sidelink resource pool may overlap in time with a second sidelink resource of the second sidelink resource pool, e.g., Slot 3 in FIG. 29.

For example, the sidelink BWP may be a wideband sidelink BWP that has a bandwidth larger than a minimum regularized bandwidth for which the wireless device performs an LBT procedure to gain access on a channel. For example, the sidelink BWP may be larger than 20 MHz. The configuration parameters may indicate that one or more sidelink resource pools are configured in the sidelink BWP. The configuration parameters may indicate that each of the one or more sidelink resource pools is confined and/or configured in a respective frequency band (e.g., unlicensed band). In FIG. 29, three sidelink resource pools are in a sidelink BWP. The sidelink BWP may comprise a frequency band 1 (e.g., unlicensed band 1) and a frequency band 2 (e.g., unlicensed band 2). The first sidelink resource pool and the second sidelink resource pool may be confined in the frequency band 1. The third sidelink resource pool may be confined in the frequency band 2. The frequency band 1 (e.g., unlicensed band 1) and the frequency band 2 (e.g., unlicensed band 2) may require different and/or independent LBT procedures. For example, the wireless device may perform a first LBT procedure that may indicate a channel of frequency band 1 being idle in Slot 3. For example, the wireless device may transmit, in response to the channel of frequency band 1 being idle in Slot 3, a sidelink data via a sidelink resource selected from the first sidelink resource pool or the second sidelink resource pool that are configured in the frequency band 1. For example, the wireless device may not transmit, in response to the channel of frequency band 1 being idle in Slot 3, a sidelink data via a sidelink resource selected from the third sidelink resource pool that are configured in the frequency band 2. Transmitting a sidelink data via a sidelink resource selected from the third sidelink resource pool that are configured in the frequency band 2 may require a second LBT procedure.

For operation of sidelink in unlicensed spectrum (SL-U), multi-consecutive slots transmission (MCSt) and/or sidelink burst transmission may be supported. MCSt may be used to reduce the need and/or frequency of UE performing LBT to access the channel once it has acquired a COT, to retain the COT to transmit UE's data as much as possible, and/or to be able to transmit UE's data as soon as possible in the following slot. A MCSt may comprise n consecutive time slots in time domain. The n consecutive time slots may be physical consecutive time slots or logical consecutive time slots in a resource pool. The n consecutive time slots may be within one or more COT duration (e.g., within MCOT). The MCSt may comprise one or more RB sets (e.g., LBT subbands) in frequency domain. For example, a physical slot may be any slot comprising 14 OFDM symbols based on the given numerology (based on the SCS of the SL BWP). For example, a logical slot may be a physical slot that is configured for sidelink operation. For example, some physical slots may not be configured for SL operation and may not be logical slots.

In an example, any two adjacent time slots of the n consecutive time slots for the MCSt may not have a time gap (e.g., guard period) in between. In an example, a time gap between any two adjacent time slots of the n consecutive time slots for the MCSt may not be larger than a threshold (e.g., 16 us or 25 us, etc.). Based on the regulations of unlicensed spectrum, if the time gap between any two transmissions is longer than the threshold, the transmissions are considered as two separate transmissions (e.g., not consecutive/contiguous transmissions and/or not a burst transmission), and the transmitter must perform separate LBT procedures (e.g., separate/independent Type 1 LBT procedures) for each of the transmissions. While, for any two transmissions without a gap between them and/or with a gap shorter than the threshold between them, a single LBT procedure (e.g., Type 1 LBT procedure) may be performed at/for the earliest transmissions and the following consecutive transmissions in the burst may follow with no LBT procedure or short LBT procedure (e.g., Type 2A/2B/2C LBT procedure). Therefore, the transmitter UE may have a higher chance of successfully accessing the channel and transmitting multiple transmissions in a burst and contiguously using consecutive resources without gaps (or gaps shorter than the threshold). MCSt resources or MCSt occasion may be configured and/or used to facilitate such burst transmission using consecutive resources and based on a single LBT procedure (e.g., a single Type 1 LBT procedure, if any).

In unlicensed spectrum operation (e.g., a cell configured with operation in shared spectrum) listen before talk (LBT) is used as a baseline to access the unlicensed spectrum and comply with regulations. The baseline for accessing the channel is Type 1 LBT, which randomizes a counter based on a traffic priority class and a contention window (CW) length. After sensing the medium as free (according to a proper energy detection threshold), e.g., for a period of 16 μs, the device may measure the energy of the channel over the LBT bandwidth (e.g., based on RB-sets of 20 MHZ) and then performs clear channel assessments (CCAs) over 9 us contention slots to reduce the counter. When the countdown is completed/reaches zero, the device, if ready/allowed, may start the transmissions. If not ready/allowed, an additional LBT (e.g., of duration T_{d}+Tₛₗ=25 μs) needs to be cleared before the desired transmission starting point. Otherwise, the channel access would be declared to be failed and the procedure should start over. This additional LBT was introduced due to the synchronous nature of unlicensed/shared spectrum operation as a method to avoid inter-RAT collisions. In some cases, a device from another RAT (e.g., a WiFi node, which can start transmissions asynchronously) could complete its LBT and start transmitting before the node's next transmission starting point. The additional LBT allows the NR-U/SL-U node to detect this case and defer the access. This mechanism, and generally, allowing transmissions at more frequent starting points than full slot boundaries, can also provide a certain degree of intra-RAT collision resolution capability. That is, a device that completes the Type 1 LBT earlier, can start transmitting earlier.

In unlicensed spectrum operation, performing back-to-back transmissions, namely transmission burst, over a channel occupancy time (COT) up to a maximum duration (MCOT) is supported, at the condition that the activity gaps between two consecutive transmissions are no longer than a gap, e.g., 16 μs. Transmission bursts can improve channel access efficiency by reducing the number of channel accesses needed to deliver a file (e.g., if composed by multiple transport blocks). This is beneficial compared to accessing the channel for only delivering small portions of a file, which can also reduce the possibility to lose the medium due to the presence of WiFi. One of the enablers of COT based access is COT sharing, that is, different devices can alternate to use the medium, at the condition of keeping controlled the activity gaps between a transmission and another. Different types of COT sharing may be allowed via different types of LBT. For example, COT sharing with Type 2A, 2B, or 2C LBT, with activity gaps of 25 μs, 16<x<25 μs, and up to 16 μs, respectively. The gap may be controlled (e.g., by the controller or the scheduled, e.g., by the gNB or a COT sharing UE) via the LBT type and CAPC indication (e.g., in DCI/SCI), and the UE that the COT has been shared to may start transmissions with cyclic prefix extension (CPE) to enforce the activity gap of the desired length.

To solve potential collisions between UEs trying to access a channel simultaneously with Type 1 LBT, e.g., for PSSCH/PSSCH transmission and/or for transmitting semi-static transmissions such as CG-PUSCH and/or PSFCH and/or S-SSB, multiple starting points may be configured within 1/2/4 symbols for 15/30/60 KHz sub carrier spacing (SCS), respectively. These points are achieved via CPE of the first symbol of the transmission.

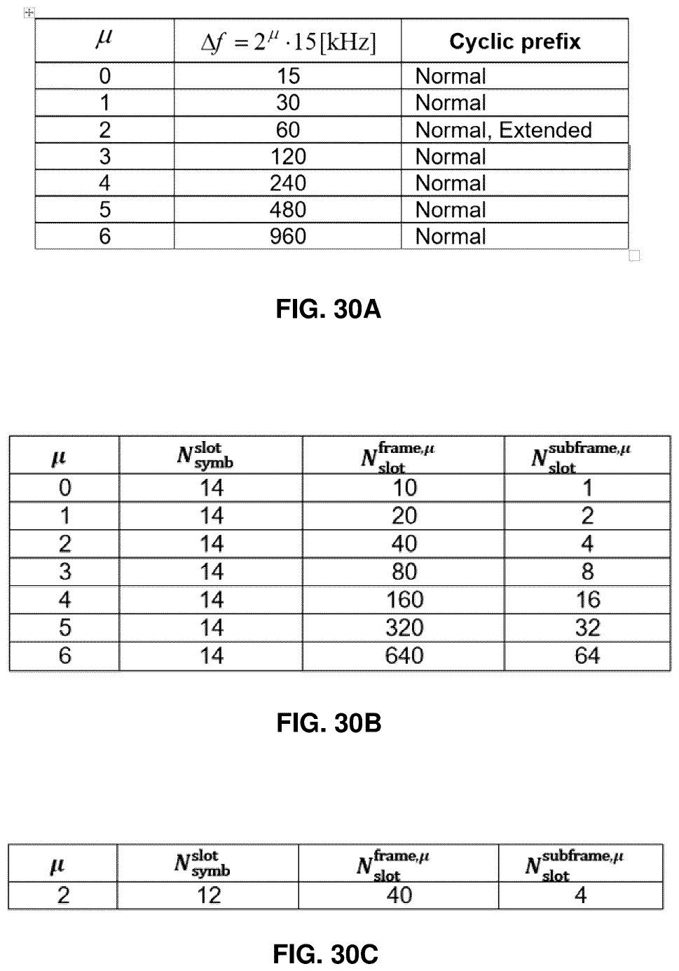

FIG. 30A and FIG. 30B and FIG. 30C show examples of supported transmission numerologies. In a radio technology (e.g., NR/SL), multiple OFDM numerologies (μ) may be supported, e.g., μ=0,1,2, . . . ,6. FIG. 30A shows supported numerologies with their corresponding subcarrier spacing (SCS) and type of cyclic prefix (CP). As shown in FIG. 30A, each numerology may correspond to a subcarrier spacing in the frequency domain (e.g., Δf=2^{μ}·15 [KHz]), a symbol duration in time domain, and a cyclic prefix for the OFDM symbol. For example, numerology u and the cyclic prefix for a downlink or uplink or sidelink bandwidth part may be provided by higher-layer parameters (e.g., subcarrierSpacing and cyclicPrefix).

A numerology may be referred to as subcarrier spacing configuration p. For example, the numerology may correspond to a subcarrier spacing configuration through table of FIG. 30A.

Downlink, uplink, and sidelink transmissions are organized into frames, e.g., with T_{f}=(Δfₘₐₓ/100)·T_{c}=10 ms) duration. Each frame may consist of ten subframes of T_{f}=(Δfₘₐₓ/1000)·T_{c}=1 ms) duration. The number of consecutive OFDM symbols per subframe is N_{symb}^{subframe,μ}=N_{symb}^{slot}Nₛₗₒₜ^{subframe,μ}. For subcarrier spacing configuration corresponding to numerology μ, slots are numbered (e.g., nₛ^{μ}∈{0, . . . , Nₛₗₒₜ^{subframe,μ}−1}) in increasing order within a subframe and (e.g., n_{s,f}^{μ}∈{0, . . . , Nₛₗₒₜ^{frame,μ}−1}) in increasing order within a frame. For each numerology μ, FIG. 30B and FIG. 30C show the number of symbols per slot (N_{symb}^{slot}), the number of slots per frame (Nₛₗₒₜ^{frame,μ}), and the number of slots per subframe (Nₛₗₒₜ^{subframe,μ}). There may be N_{symb}^{slot} consecutive OFDM symbols in a slot, where N_{symb}^{slot} may depend on the cyclic prefix as shown in FIG. 30B and FIG. 30C.

An antenna port may be defined such that the channel over which a symbol on the antenna port is conveyed can be inferred from the channel over which another symbol on the same antenna port is conveyed.

A baseband signal may be a complex-valued Single Carrier Frequency Division Multiple Access (SC-FDMA) or cyclic prefix orthogonal frequency division multiplexing (CP-OFDM) baseband signal for an antenna port.

A time-continuous signal sₗ^{(p,μ)}(t) on antenna port p and subcarrier spacing configuration μ for OFDM symbol l∈{0,1, . . . , Nₛₗₒₜ^{subframe,μ}N_{symb}^{slot}−1} in a subframe for any physical channel or signal may be defined by:

$$\begin{matrix}{s}_{l}^{( p , μ )} ( t ) = \{ \begin{matrix}{\overline{s}}_{l}^{( p , μ )} ( t ) & {t}_{start , l}^{μ} \leq t < {t}_{start , l}^{μ} + {T}_{symb , l}^{μ} \\ 0 & otherwise\end{matrix} \\ {\overline{s}}_{l}^{( p , μ )} ( t ) = {\sum }_{k = 0}^{{N}_{grid , x}^{size , μ} {N}_{sc}^{RB} - 1} {a}_{k , l}^{( p , μ )} {e}^{j 2 π ( k + {k}_{0}^{μ} - {N}_{grid , x}^{size , μ} {N}_{sc}^{RB} / 2 ) Δ f ( t - {N}_{CP , l}^{μ} {T}_{c} - {t}_{start , l}^{μ} )} \\ {k}_{0}^{μ} = ( {N}_{grid , x}^{start , μ} + {N}_{grid , x}^{size , μ} / 2 ) {N}_{sc}^{RB} - ( {N}_{grid , x}^{start , {μ}_{0}} + {N}_{grid , x}^{size , {μ}_{0}} / 2 ) {N}_{sc}^{RB} {2}^{{μ}_{0} - μ} \\ {T}_{symb , l}^{μ} = ( {N}_{u}^{μ} + {N}_{CP , l}^{μ} ) {T}_{c}\end{matrix}$$

where t=0 at the start of the subframe, μ is the subcarrier spacing configuration, μ₀ is the largest μ value among the subcarrier spacing configurations (e.g., by scs-SpecificCarrierList for each of uplink and downlink and by sl-SCS-SpecificCarrierList for sidelink), and

$$\begin{matrix}{N}_{u}^{μ} = 2048 κ \cdot {2}^{- μ} \\ {N}_{CP , l}^{μ} = \{ \begin{matrix}512 κ \cdot {2}^{- μ} & extender cyclic prefix \\ 44 κ \cdot {2}^{- μ} + 16 κ & normal cyclic prefix , l = 0 or l = 7 \cdot {2}^{μ} \\ 144 κ \cdot {2}^{- μ} & normal cyclic prefix , l \neq 0 and l \neq 7 \cdot {2}^{μ}\end{matrix}\end{matrix}$$

As suggested above, T_{symb,l}^{μ} is the duration of the OFDM symbol l (OFDM symbol duration, or simply, symbol duration), including the cyclic prefix (CP), in/with numerology μ. A CP may be part of the OFDM signal transmitted during the OFDM symbol duration. A CP of an OFDM symbol may be normal CP or extended CP. For example, for all OFDM symbols of all slot/subframes/frames of a bandwidth part (e.g., uplink BWP or downlink BWP or sidelink BWP), configuration parameters may indicate whether the CP of an OFDM symbol is normal or extended. The slot duration is 14 symbols with Normal CP and 12 symbols with Extended CP, and scales in time as a function of the used sub-carrier spacing so that there is always an integer number of slots in a subframe. For example, each slot of a BWP configured with normal CP, may comprise 14 OFDM symbols, as shown in FIG. 30B. For example, each slot of a BWP configured with extended CP, may comprise 12 OFDM symbols, as shown in FIG. 30C.

The starting position of OFDM symbol l for subcarrier spacing configuration μ in a subframe is given by:

$${t}_{start , l}^{μ} = \{ \begin{matrix}0 & l = 0 \\ {t}_{start , l - 1}^{μ} + ( {N}_{u}^{μ} + {N}_{CP , l - 1}^{μ} ) \cdot {T}_{c} & otherwise\end{matrix}$$

A symbol with normal CP may comprise a CP extension (CPE). A symbol with extended CP may comprise a CP extension. The CPE may not be within the corresponding symbol duration. For example, the CPE length/duration may be extended to an immediately preceding symbol of the respective symbol. For example, the starting point of the CPE may be located before the start of the corresponding OFDM symbol (t_{start,l}^{μ}).

In an example, in case of cyclic prefix extension of the first OFDM symbol l allocated for a transmission (e.g., PUSCH, SRS, PUCCH, PSSCH/PSCCH, or PSFCH transmission), the time-continuous signal sₑₓₜ^{(p,μ)}(t) for the interval t_{start,l}^{μ}−Tₑₓₜ≤t<t_{start,l}^{μ} preceding the first OFDM symbol for the transmission is given by:

$${s}_{ext}^{( p , μ )} ( t ) = {\overline{s}}_{l}^{( p , μ )} ( t )$$

where t<0 refers to the signal in the previous subframe.

In an example, the CPE length/duration may be given by:

$$\begin{matrix}{T}_{ext} = min ( max ( {T}_{ext}^{′} , 0 ) , {T}_{symb , ( l - 1 ) mod 7 \cdot {2}^{μ}}^{μ} ) , \\ {T}_{ext}^{′} = {\sum }_{k = 1}^{{C}_{i}} {T}_{symb , ( l - k ) mod 7 \cdot {2}^{μ}}^{μ} - {Δ}_{i}\end{matrix}$$

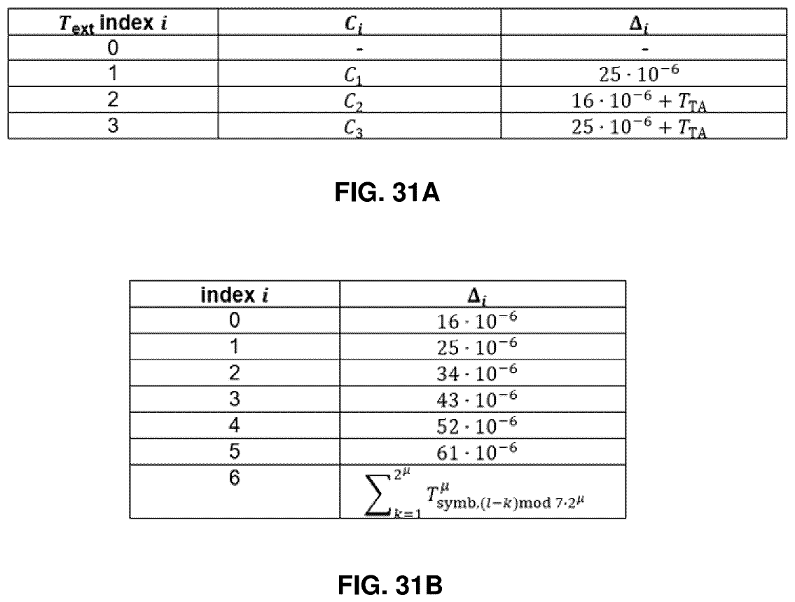

FIG. 31A and FIG. 31B show examples of cyclic prefix extension for transmissions. The index i indicates Δᵢ which is used to determine Tₑₓₜ. In the example of FIG. 31A, C₁=1 for μ∈{0,1}, C₁=2 for μ=2, and C₂ and C₃ are given by the higher-layer parameters (e.g., cp-ExtensionC2 and cp-ExtensionC3, respectively), and T_{TA} is the timing advance value. For example, the UE may receive a RRC message from a base station or from a second UE, comprising the higher layer parameter. In an example, the values of Cᵢ and/or Δᵢ corresponding to each index i may be pre-defined. For some cases (e.g., contention-based random access, and/or in absence of higher-layer configuration of C₂ and C₃), the value of Cᵢ shall be set to the largest integer fulfilling Tₑₓₜ′<T_{symb,(l-1) mod 7·2}_{^{μ}}^{μ} for each of the values of i∈{2,3}. The CPE extension, Tₑₓₜ, may be applied to a first transmission, e.g., a first UL/SL transmission scheduled by a scheduling DCI.

For example, the UE may receive a DCI format (e.g., DCI format 0_1, or DCI format 2_1 or DCI format 2_2) scheduling one or more transmissions (e.g., PUSCH or PSSCH). The DCI format may comprise a field indicating the LBT/channel access parameters for the one or more transmissions. For example, an information field (e.g., ChannelAccess-CPext-CAPC field) in the DCI format may indicate a channel access type (e.g., Type1 Channel Access, or Type2A Channel Access or Type2B Channel Access or Type2C Channel Access) for the one or more transmissions with operation in a cell/carrier with shared spectrum channel access. The information field may further indicate a channel access priority class (CAPC) and/or a CP extension Tₑₓₜ index (e.g., index i). For example, the information field in the DCI format may indicate the index i to be used as an entry to the table in FIG. 31A and/or FIG. 31B.

In an example, the UE may receive an RRC message (e.g., SIB and/or RRCReconfiguration message) comprising configuration parameters for shared spectrum channel access (e.g., ul-AccessConfigListDCI in PUSCH-Config; or sl-AccessConfigListDCI in PSSCH-Config). The configuration parameters may indicate a set of entries of a pre-defined table comprising combinations of cyclic prefix extension (Tₑₓₜ index i), channel access priority class (CAPC), and UL/SL channel access type.

In an example, the CPE length/duration may be given by:

$${T}_{ext} = {\sum }_{k = 1}^{{2}^{μ}} {T}_{symb , ( l - k ) mod 7 \cdot {2}^{μ}}^{μ} - {Δ}_{i}$$

where Δᵢ is given by the table in FIG. 31B.

For example, a UE may perform a transmission (e.g., uplink/sidelink transmission with configured grants) in contiguous OFDM symbols on all resource blocks of an RB set (full bandwidth). For a first such transmission (e.g., the earliest OFDM symbol of the transmission), the UE may determine a duration of a CPE, Text, to be applied for transmission. The UE may determine the index for Δᵢ by choosing, e.g., randomly, from a set of values configured by higher layers (e.g., via RRC signaling). For example, if the first such transmission is within a channel occupancy, COT (e.g., initiated by BS or a second UE), the set of values is determined by a first parameter (e.g., cg-StartingFullBW-InsideCOT). For example, if the first such transmission is not within a channel occupancy (e.g., initiated by BS or a second UE), the set of values is determined by a second parameter (e.g., cg-StartingFullBW-OutsideCOT).

For example, a UE may perform a transmission (e.g., uplink/sidelink transmission with configured grants) in contiguous OFDM symbols on fewer than all resource blocks of an RB set (e.g., partial bandwidth). For a first such transmission the UE determines a duration of a cyclic prefix extension Text to be applied for transmission. For example, if the first such transmission is within a channel occupancy, COT (e.g., initiated by the BS or a second UE), the index for Δᵢ is equal to a first parameter (e.g., cg-StartingPartialBW-InsideCOT). For example, if the first such transmission is not within a channel occupancy, COT (e.g., initiated by the BS or a second UE), the index for Δᵢ is equal to a second parameter (e.g., cg-StartingPartialBW-PutsideCOT).

In an example, an extension of an OFDM symbol may be applied to a first (e.g., earliest) symbol of a transmission/signal. In the radio technology, CP extension (CPE) may be used for one or more purposes including filling the time gaps and/or aligning simultaneous transmissions of multiple UEs.

For example, for a channel occupancy in an unlicensed spectrum operation (e.g., COT in NR-U and/or SL-U), in order to maintain a required time gap between two adjacent transmissions, a CPE may be applied before an actual signal. For example, COT sharing may be aided by utilizing a CPE, where it is used by the transmitter node to avoid the COT from being idle for too long and losing the access to the unlicensed channel to another RAT. For example, in the current SL slot structure, there may be a gap symbol at the end of a slot for Tx/Rx switching (and/or switching to UL transmission with TA when UE is RRC connected to the network). For SCS=15 kHz and 30 kHz which are supported in FR1, the symbol length is greater than 25 μs (e.g., the gap allowed within a COT). For these cases, CPE is very useful in retaining the COT. Otherwise, the COT may be interrupted due to a large gap and channel access may be lost (e.g., Type 1 channel access procedure may be required after the gap).

In another example, CPE may be used to resolve inter-UE blocking. For example, for simultaneous transmission on all resource blocks of an RB set, and to avoid inter-UE collision, each UE may use/select (e.g., randomly) a CPE duration/length and/or a CPE starting point. Thus, the UE with the earliest CPE starting point (e.g., longest CPE duration) will succeed the LBT and access the channel, while the other UE(s) will sense the channel to be busy to the CPE transmission and will determine a failed LBT, thus will not collide with each other. For example, for simultaneous transmission on partial resource blocks of an RB set (FDMed transmissions), and to enable UE multiplexing, all UEs may use/select a same CPE duration/length and/or a same CPE starting point. Thus, all UEs will start the CPE transmission at the same CPE starting point (e.g., for the same CPE duration) and all will succeed the LBT and access the channel, while not blocking each other.

For sidelink operation with shared spectrum channel access (SL-U), CPE may be supported. CPE of a short duration is transmitted to fill-in a transmission gap within a COT such that the node/device is able to apply one of Type 2A/2B/2C short LBT to access the channel within a COT. A starting position or the length of the CPE could be used for deciding which node/device get to access the channel based on some criteria (e.g., priority class) by blocking others before a transmission/slot boundary, e.g., for TDM access between the nodes/devices when the transmission occupies all resource blocks of one RB set.

In SL Mode 2 resource allocation, a sensing and reservation mechanism is employed to avoid Tx collision among UEs in the same resource pool. As such, it is very spectral efficient to allow different UE's transmissions in the same slot in a FDM manner when their transmissions occupy only a portion of the channel/resource pool (partial bandwidth). Therefore, it is desired to allow multiple SL UEs to transmit in the same slot without blocking each other when they do not occupy the entire channel bandwidth/RB set. This can be also very useful for PSFCH transmissions from multiple UEs in the same symbol without blocking.

A SL UE may transmit a CPE, as part of an OFDM symbol of a sidelink transmission in a slot, from a CPE starting position until the start of the AGC symbol of the slot (e.g., next slot). The CPE starting position(s) may be confined within the last symbol of a slot (the GP symbol). For example, a CPE is transmitted from a CPE starting position before SL transmission within a COT. For example, a CPE may be transmitted from a CPE starting position within the symbol just before the next AGC symbol. For example, a CPE may be transmitted from a CPE starting position within at most 1, 2 or 4 symbols just before the next AGC symbol, e.g., for 15, 30 or 60 KHz SCS, respectively.

A CPE can be transmitted from a CPE starting position before a SL transmission. One or more CPE starting positions may be (pre-) configured before a starting symbol of the SL transmission, e.g., in one or more symbols immediately preceding the starting symbol of the SL transmission. For example, the one or more CPE starting positions may be within the symbol before the next AGC symbol (e.g., before the AGC symbol allocated to the sidelink transmission.). For example, the one or more CPE starting positions may be within the symbol just before the next AGC symbol for 15 KHz SCS, and/or within at most 2 symbols just before the next AGC symbol for 30 or 60 KHz SCS. For example, the number and/or location of the one or more CPE starting positions may be based on scenarios/criteria/conditions including, e.g., the channel access type, and/or channel/signal type, and/or inside or outside the COT, and/or full or partial bandwidth and/or reservation, etc.

A CPE starting position may be (pre-) configured for a SL transmission using fewer than all resource blocks of an RB set (e.g., for a SL transmission, PSSCH/PSCCH, PSFCH, S-SSB, inside a COT and/or outside a COT).

One or multiple CPE starting positions may be (pre-) configured in each resource pool for PSSCH/PSCCH. When multiple CPE starting positions are (pre-) configured, the UE may select a default/first CPE starting position (e.g., according to partial/full RB set allocation, resource reservation information, and/or within or outside of a COT, etc.). The UE may select one of the multiple CPE starting positions (e.g., according to priority level (e.g., CAPC or L1), selected randomly by UE from the (pre-) configured set of CPEs, selected by the UE based on channel access result, and/or determined based on indication from the COT initiating UE, etc.).

For example, multiple CPE starting positions within the GP symbol based on transmission priority level (e.g., CAPC) may be configured, e.g., at least for a SL transmission using all resource blocks of one or more RB set(s). For example, a RRC parameter may indicate whether to use a single CPE starting position or multiple CPE starting positions.

A single CPE starting position may be (pre-) configured for PSFCH. For example, the CPR starting position may be (pre-) configured in each RP, pre-defined and/or indicated. At least one CPE starting position may be (pre-) configured for S-SSB.

For single cell operation with two uplink carriers and/or for operation with carrier aggregation, a UE may determine transmission powers for two or more simultaneous UL transmissions, e.g., PUSCH and/or PUCCH and/or PRACH and/or SRS transmissions. The UE may determine a total transmission power, as a sum of transmission powers of all transmissions in each symbol of a transmission occasion. For example, the UE may perform a power control/adjustment mechanism in every symbol, based on the total transmission power in that symbol. For example, a total UE transmit power (e.g., for PUSCH and/or PUCCH and/or PRACH and/or SRS transmissions) on serving cells in a frequency range (e.g., FR1 and/or FR2 and/or FR3) in a respective transmission occasion i may exceed a maximum power threshold (e.g., PCMAX (i), where PCMAX (i) is the linear value of PCMAX (i) in transmission occasion i). In an example, the UE may allocate power to uplink transmissions (e.g., PUSCH/PUCCH/PRACH/SRS transmissions) according to a priority order, so that the total UE transmit power for transmissions on serving cells in the frequency range is smaller than or equal to the maximum power threshold (PCMAX (i)) for that frequency range in every symbol of the transmission occasion i. In an example, a UE may multiplex HARQ-ACK information in a PUSCH. A priority index of the PUSCH may be the larger of (a) the priority index of the PUSCH and (b) the larger priority index of the HARQ-ACK information, e.g., if the UE is configured with a multiplexing enabling RRC parameter (e.g., provided UCI-MuxWithDifferentPriority). When determining a total transmit power for serving cells in a frequency range in a symbol of transmission occasion i, the UE may not include power for transmissions starting after the symbol of transmission occasion i. The total UE transmit power in a symbol of a slot may be defined as the sum of the linear values of UE transmit powers for one or more transmissions (e.g., UL transmissions comprising PUSCH, PUCCH, PRACH, and SRS) in the symbol of the slot.

In an example, a UE may receive RRC message(s) from a BS and/or a second UE, comprising first configuration parameters of an UL carrier and second configuration parameters of a SL carrier. The first configuration parameters may indicate the location and bandwidth of the UL carrier; one or more uplink channels and/or signals for the uplink carrier. The second configuration parameters may indicate the location and bandwidth of the SL carrier; one or more sidelink channels and/or signals of a sidelink resource pool of the sidelink carrier.

For a sidelink transmission/reception, power control is performed once per transmission occasion, e.g., using the AGC symbol. The sidelink power control is based on the assumption that the transmit power is constant/consistent across the symbols of a sidelink transmission, e.g., to avoid transient period issue. For example, total sidelink transmit power may be the same in the symbols used for PSCCH/PSSCH/PSFCH transmissions in a slot/mini-slot/multi-slot. A maximum SL transmit power may be (pre-) configured to the UE.

When an UL transmission/transmission occasion and a SL transmission/transmission occasion overlap in time, the UE still needs to ensure that the SL transmission power is constant/consistent across all symbols of the SL transmission. To avoid the transient period issue that total sidelink transmit power is the same in the symbols used for PSCCH/PSSCH/PSFCH/S-SSB transmissions in a slot, when there is simultaneous transmission of sidelink and uplink in a shared carrier and/or different carriers, the total transmit power of sidelink and uplink may be the same in the symbols used for PSCCH/PSSCH/PSFCH/S-SSB transmissions in a slot. Therefore, the UE may perform power control/adjustment for simultaneous transmission of UL and SL, if possible. In an example, if not possible, e.g., based on the UE simultaneous transmission capability, the UE may drop one of the SL and UL transmissions.

In an example, the UE may transmit an RRC message, e.g., to the base station and/or the second UE, comprising the UE's capability information. The capability information may comprise capability parameters associated with a band combination (e.g., one or more band that may be simultaneously configured (with carriers within those bands) for the UE). A first capability information/parameter may indicate dual connectivity related capabilities that are defined per band combination (e.g., CA-ParametersNRDC). In an example, the first capability information/parameter may comprise one or more parameters indicating whether the UE is capable of supporting power sharing between simultaneous transmissions, e.g., semi-static power sharing and/or dynamic power sharing, e.g., for intra-frequency and/or inter-frequency carriers/bands (intraFR-NR-DC-PwrSharingMode1; intraFR-NR-DC-PwrSharingMode2; intraFR-NR-DC-DynamicPwrSharing). In an example, the simultaneous transmissions may be via two or more carriers on two or more bands of the respective band combination. In an example, the two or more carriers may comprise a UL carrier and a SL carrier. For example, the capability information/parameter may indicate whether the UE is capable of simultaneous transmissions on the UL carrier and the SL carrier based on power sharing. For example, this capability may require the UE to check when and whether the data/signal comes simultaneously from time to time both for simultaneous transmission and/or priority-based dropping.

A UE may perform prioritization between SL transmissions and UL transmissions. The UE may determine priorities of SL transmissions and UL transmissions. For example, the UE may determine a priority (e.g., PHY priority) of a sidelink transmission, e.g., a PSCCH and/or PSSCH transmission. For example, a SL transmission via PSFCH (PSFCH transmissions) in a slot, may have a same priority value as the smallest priority value among PSSCH receptions with corresponding HARQ-ACK information provided by the PSFCH transmissions in the slot, if any, and/or among PSFCH transmissions with conflict information in the slot, if any, where each priority value is equal to the smallest priority value determined by corresponding SCI formats 1-A. For example, a priority of S-SS/PSBCH block transmission or reception may be provided by RRC configuration parameter (e.g., sl-SSB-PriorityNR).

The UE may perform prioritization between SL transmission and UL transmission (e.g., other than a PRACH, and/or a PUSCH scheduled by an UL grant in a RAR and its retransmission, and/or a PUSCH corresponding to Type-2 random access procedure and its retransmission, and/or a PUCCH with sidelink HARQ-ACK information report).

An UL transmission may be of/associated with a priority index. The priority index may be/indicate 1 (e.g., high priority for URLLC traffic). The priority index may be/index 0 (e.g., low priority for non-URLLC traffic). The priority index may indicate the priority of the UL transmission. In an example, the UL transmission may be associated with a priority index 1 (e.g., PHY priority of the PUSCH/PUCCH/PRACH/SRS/UL transmission). For example, the UL transmission may be for a PUSCH and/or PUCCH with priority index 1. In an example, the UL transmission may be associated with a priority index 0 (e.g., PHY priority of the PUSCH/PUCCH/PRACH/SRS/UL transmission). For example, the UL transmission may be for a PUSCH and/or PUCCH with priority index 0.

A PUSCH or a PUCCH transmission (e.g., other than PUCCH transmissions with SL HARQ-ACK reports), including repetitions if any, may be of priority index 0 or of priority index 1. For a configured grant PUSCH transmission, a UE determines a priority index from a RRC configuration parameter (e.g., phy-PriorityIndex), if provided. For a PUCCH transmission with HARQ-ACK information corresponding to a SPS PDSCH reception or a SPS PDSCH release, a UE determines a priority index from a RRC configuration parameter (e.g., harq-CodebookID), if provided. For a PUCCH transmission with SR, a UE may be provided, by a RRC configuration parameter (e.g., phy-PriorityIndex in SchedulingRequestResourceConfig), a priority index 0 or a priority index 1 for the SR. If the UE is not provided a priority index for SR, the priority index is 0. For a PUSCH transmission with semi-persistent CSI report, a UE determines a priority index from a priority indicator field, if provided, in a DCI format that activates the semi-persistent CSI report. If a priority index is not provided to a UE for a PUSCH or a PUCCH transmission (e.g., other than PUCCH transmissions with SL HARQ-ACK reports), the priority index is 0.

If in an active DL BWP a UE monitors PDCCH for detection of DCI format that includes a priority indicator field, a priority index can be provided by the priority indicator field. If a UE indicates a capability to monitor, in an active DL BWP, PDCCH for detection of DCI format that includes a priority indicator field, the DCI format can schedule PUSCH transmissions of any priority, or PDSCH receptions and/or trigger a PUCCH transmission with corresponding HARQ-ACK information of any priority. A DCI (e.g., DCI format 1_1 or DCI format 1_2) may indicate a TCI state update and trigger a PUCCH transmission with corresponding HARQ-ACK information of any priority. A DCI format indicating a SPS PDSCH release, and/or SCell dormancy without scheduling a PDSCH reception, and/or indicating a TCI state update without scheduling PDSCH reception, may be referred to as a DCI format having associated HARQ-ACK information without scheduling a PDSCH reception.

The UL transmission may be/comprise a PUSCH transmission comprising a transport block. In an example, a control signal (e.g., DCI and/or MAC-CE) scheduling and/or activating the PUSCH transmission may comprise a field indicating a priority index of/for the transport block and/or the scheduled UL transmission (e.g., 0 or 1). In an example, an RRC parameter (e.g., a parameter of configured grant configuration) may indicate the priority index of the PUSCH transmission (e.g., 0 or 1). In an example, the priority index of the PUSCH transmission may be pre-defined (e.g., 0 if not indicated by RRC or MAC-CE or DCI).

The UL transmission may be/comprise a PUCCH transmission comprising one or more UCI (e.g., HARQ-ACK and/or CSI report and/or CG-UCI, etc.). In an example, a control signal (e.g., DCI and/or MAC-CE) scheduling and/or activating a PDSCH/PDCCH transmission associated with the PUCCH transmission may comprise a field indicating a priority index of/for the PUCCH transmission (e.g., 0 or 1). For example, a DCI scheduling a PDSCH may comprise: a first field indicating a slot offset for the PUCCH transmission comprising HARQ feedback information of the PDSCH; and a second field indicating a priority index of the PDSCH and the PUCCH. In an example, an RRC parameter (e.g., a parameter of configured grant configuration) may indicate the priority index of the PUCCH transmission (e.g., 0 or 1, e.g., for PUCCH comprising HARQ feedback information of SPS PDSCH). In an example, the priority index of the PUCCH transmission may be pre-defined (e.g., 0 if not indicated by RRC or MAC-CE or DCI). For example, depending on the content of the PUCCH, the priority index may be pre-defined (e.g., 0 or 1 for CSI report, etc.).

The UL transmission may be/comprise a PRACH transmission comprising a preamble. The priority index of the PRACH transmission may be pre-defined and/or configured by RRC signaling, e.g., based on the preamble. For example, the RRC message may indicate a priority index for the preamble. The priority of the PRACH transmission may determined by the priority of the preamble.

The UL transmission may be/comprise an SRS transmission. The priority index of the SRS transmission may be pre-defined and/or configured by RRC signaling.

In an example, multiple UL transmissions (e.g., one or more PUSCH and/or one or more PUCCH transmissions) may overlap/collide in time (e.g., in at least one symbol). The UE may determine/resolve the overlapping of the multiple UL transmissions (e.g., by dropping and/or multiplexing).

In an example, the UE may determine overlapping for PUCCH transmissions with SL HARQ-ACK reports and PUCCH of larger and/or smaller priority index. The UE may resolve the overlapping for PUCCH transmissions with SL HARQ-ACK reports and PUCCH of each priority index before resolving the overlapping for PUCCH transmissions without SL HARQ-ACK or the overlapping for PUCCH transmissions and PUSCH transmissions.

A UE may be provided with configuration of simultaneous PUSCH and PUCCH transmission (e.g., via simultaneous PUCCH-PUSCH) and would transmit a PUCCH with a first priority index and PUSCHs with a second priority index that is different than the first priority index, where the PUCCH and the PUSCHs overlap in time. The UE may be capable to simultaneously transmit the PUCCH and the PUSCHs. The UE may exclude the PUSCHs for resolving the time overlapping between the PUCCH and PUSCHs, where the timeline conditions are not required for the excluded PUSCHs.

A UE may determine overlapping for PUCCH transmissions and/or PUSCH transmissions of different priority indexes (e.g., other than PUCCH transmissions with SL HARQ-ACK reports), including repetitions if any. The UE may be provided with a configuration parameter enabling multiplexing of transmissions with different priorities (e.g., via UCI-MuxWithDifferentPriority). The timeline conditions for multiplexing UCI in a PUCCH and/or a PUSCH may be satisfied (e.g., the processing time requirement). The UE may first resolve overlapping for PUCCH and/or PUSCH transmissions of a same priority index. For example, the UE may multiplex UCI of PUCCH and/or transport block of PUSCH transmissions of a same priority index into one transmission (PUSCH and/or PUCCH transmission) of the PUCCH and/or PUSCH transmissions. The UE may second resolve the overlapping for PUCCH transmissions of different priority indexes. For example, the UE may multiplex (e.g., if enabled by a configuration parameter) the UCI of PUCCH transmissions of different priority indexes into one PUCCH transmission of the PUCCH transmissions, e.g., with a higher priority. In an example, the UE may drop the PUCCH transmission(s) of lower priority (e.g., priority index 0) that overlap with PUCCH transmission(s) of higher priority (e.g., priority index 1). The UE may third resolve the overlapping for PUCCH and PUSCH transmissions of different priority indexes. For example, the UE may drop PUSCH transmission(s) of smaller priority index (e.g., lower priority) that overlap with a PUCCH transmission with positive SR of larger priority index prior to multiplexing UCI in a PUSCH transmission of smaller priority index, if any. For example, the UE may drop PUSCH transmissions of smaller priority index that overlap with a PUCCH transmission with repetitions of larger priority index prior to multiplexing UCI in a PUSCH transmission of smaller priority index, if any. For example, the UE may multiplex HARQ-ACK information in a PUSCH transmission, if a PUCCH transmission with HARQ-ACK information of a first priority index overlaps with one or more PUSCH transmissions of a second priority index that is different than the first priority index.

The UE may support multiplexing information of different priorities in a PUCCH/PUSCH transmission. A PUCCH transmission with HARQ-ACK information, without repetitions, with smaller priority index may overlap with a PUCCH transmission only with HARQ-ACK information, without repetitions, with larger priority index. A PUCCH transmission without repetitions that includes HARQ-ACK information of smaller priority index may overlap with a PUCCH transmission without repetitions using a PUCCH resource with PUCCH format 2/3/4 with HARQ-ACK information and SR of larger priority index. A PUCCH transmission with HARQ-ACK information, without repetitions, with smaller or larger priority index may overlap, respectively, with a PUSCH transmission with larger or smaller priority index. The UE may multiplex HARQ-ACK information of different priority indexes and SR information of larger priority index, if any, in a same PUCCH transmission of larger priority index, and/or multiplex HARQ-ACK information the UE would provide in a PUCCH transmission of smaller or larger priority index in a PUSCH transmission of larger or smaller priority index, respectively. The UE may drop CSI and/or SR carried in the PUCCH transmission of smaller priority index, if any. The UE may drop negative SR carried in the PUCCH transmission of larger priority index, if any, if the UE would multiplex the HARQ-ACK information of larger priority index in a PUSCH transmission of smaller priority index. The UE may drop HARQ-ACK information of smaller priority index if the UE would multiplex the HARQ-ACK information of smaller priority index in a PUSCH transmission where the UE multiplexes Part 1 CSI reports and Part 2 CSI reports of larger priority index. The UE may drop Part 2 CSI reports of smaller priority index if the UE would multiplex the HARQ-ACK information of smaller and larger priority indexes in a PUSCH transmission where the UE multiplexes Part 1 CSI reports and Part 2 CSI reports of smaller priority index.

The UE may not support multiplexing information of different priorities in a PUCCH/PUSCH transmission. The UE may transmit the following channels that would overlap in time (e.g., if a channel transmission is with repetitions, the following are applicable per repetition): a first PUCCH transmission of larger priority index and a second PUCCH transmission of smaller priority index; a first PUCCH transmission of larger priority index and a second PUSCH transmission of smaller priority index when the UE cannot simultaneously transmit the first PUCCH and second PUSCH; and/or a first PUCCH transmission of smaller priority index and a second PUSCH transmission of larger priority index when the UE cannot simultaneously transmit the first PUCCH and second PUSCH. The UE may transmit the PUCCH or the PUSCH of the larger priority index. The UE may not transmit (e.g., drop) a PUCCH or a PUSCH of smaller priority index.

A UE may determine overlapping for PUCCH and/or PUSCH transmissions of different priority indexes (e.g., other than PUCCH transmissions with SL HARQ-ACK reports), including with repetitions, if any. If the UE is not provided with a configuration parameter enabling multiplexing of data/UCI with different priority (e.g., UCI-MuxWithDifferentPriority), the UE may first resolve overlapping for PUCCH and/or PUSCH transmissions of smaller priority index. If a transmission of a first PUCCH of larger priority index scheduled by a DCI format in a PDCCH reception would overlap in time with a repetition of a transmission of a second PUSCH or a second PUCCH of smaller priority index, the UE may cancel the repetition of a transmission of the second PUSCH or the second PUCCH before the first symbol that would overlap with the first PUCCH transmission. If a transmission of a first PUSCH of larger priority index scheduled by a DCI format in a PDCCH reception would overlap in time with a repetition of the transmission of a second PUCCH of smaller priority index, the UE may cancel the repetition of the transmission of the second PUCCH before the first symbol that would overlap with the first PUSCH transmission. The overlapping may be applicable before or after resolving overlapping among channels of larger priority index, if any. The UE may expect that the transmission of the first PUCCH or the first PUSCH, respectively, would not start before a processing time T_{proc,2} after a last symbol of the corresponding PDCCH reception. The processing time T_{proc,2} may be the PUSCH preparation time for a corresponding UE processing capability (e.g., assuming d_{2,1}=d₁), based on μ and N₂ and d₁ is determined by a reported UE capability.

A UE may determine overlapping for PUCCH transmissions with SL HARQ-ACK reports and PUSCH of smaller priority index, including repetitions if any. The UE may resolve the overlapping PUCCH other than PUCCH transmissions with SL HARQ-ACK reports and/or PUSCH transmissions. The PUSCH may include no UCI. The UE may resolve the overlapping for PUCCH transmissions with SL HARQ-ACK reports and PUSCH of smaller priority index. The UE may determine overlapping for PUCCH transmissions with SL HARQ-ACK reports and PUSCH of larger priority index only, including repetitions if any. The UE may resolve the overlapping PUCCH other than PUCCH transmissions with SL HARQ-ACK reports and/or PUSCH transmissions. The UE may not transmit the PUCCH with SL HARQ-ACK reports. A UE may not expect that a PUCCH carrying SL HARQ-ACK reports overlaps with PUSCH with aperiodic or semi-persistent CSI reports. A UE may not expect to be scheduled to transmit a PUCCH or a PUSCH with smaller priority index that would overlap in time with a PUCCH of larger priority index with HARQ-ACK information only in response to a PDSCH reception without a corresponding PDCCH, e.g., unless the UE is provided UCI-MuxWithDifferentPriority. A UE may not expect to be scheduled to transmit a PUCCH of smaller priority index that would overlap in time with a PUSCH of larger priority index with SP-CSI report(s) without a corresponding PDCCH, e.g., unless the UE is provided UCI-MuxWithDifferentPriority.

A UE may multiplex UCIs with same priority index in a PUCCH or a PUSCH before considering limitations for UE transmission, e.g., due to TDD slot formats. A PUCCH or a PUSCH is assumed to have a same priority index as a priority index of UCIs a UE multiplexes in the PUCCH or the PUSCH. The multiplexing or prioritization for overlapping channels may be for overlapping channels with same priority index and/or for overlapping channels with a PUCCH carrying SL HARQ-ACK information.

The UE may determine a priority value of a PUCCH transmission comprising/including SL HARQ-ACK information. The UE may perform prioritization between SL HARQ-ACK information in a first PUCCH and DL HARQ-ACK or SR or CSI in a second PUCCH. In an example, the second PUCCH may have a priority index 1. In an example, the UE may be configured with a threshold for SL priority (e.g., sl-PriorityThreshold-UL-URLLC). The UE may transmit the first PUCCH if a smallest priority value of the first PUCCH is smaller than the threshold (sl-Priority Threshold-UL-URLLC); otherwise, the UE may transmit the second PUCCH. In an example, the UE may not be configured with a threshold for SL priority (e.g., sl-PriorityThreshold-UL-URLLC). The UE may transmit the second PUCCH. In an example, the second PUCCH may have a priority index 0. The UE may transmit the first PUCCH if the smallest priority value of the first PUCCH is smaller than threshold (sl-PriorityThreshold); otherwise, the UE may transmit the second PUCCH. When the UE determines to transmit the second PUCCH, the UE determines a single resource for multiplexing UCI in the second PUCCH.

The UE may determine a first priority index or value (e.g., 0 or 1) for the UL transmission (e.g., a PUSCH transmission or a PUCCH transmission or a PRACH transmission or a SRS transmission) based on above. The UE may determine a second priority value (e.g., 1,2, . . . , 8) for the SL transmission that overlaps in time with the UL transmission. For example, the second priority may be a physical layer (e.g., layer 1) priority of the sidelink transmission. For example, the UE may determine the second priority based on logical channel priorities of the sidelink transmission. For example, for a PSSCH transmission comprising a transport block (TB) comprising data/information (e.g., MAC-PDU and/or MAC-CE) of one or more logical channel with different logical channel priorities, the second priority (e.g., PHY priority of the TB) may be equal to a highest priority among the logical channel priorities multiplexed in the TB.

The UE may transmit the SL transmission and the UL transmission simultaneously. The UE may be capable of simultaneous transmission of the SL and the UL transmission. The UE may perform prioritization between the SL transmission and the UL transmission.

The UE may perform prioritization between SL transmission and UL transmission (e.g., other than a PRACH, or a PUSCH scheduled by an UL grant in a RAR and its retransmission, or a PUSCH corresponding to Type-2 random access procedure and its retransmission, or a PUCCH with sidelink HARQ-ACK information report). The UE may determine that the SL transmission has higher priority than the UL transmission. For example, the UL transmission may be for a PUSCH or for a PUCCH with priority index 1. For example, the UE may be configured/provided with a first threshold for SL and UL prioritization (e.g., sl-PriorityThreshold-UL-URLLC). For example, the SL transmission may have a higher priority than the UL transmission if the priority value of the SL transmission is smaller than the first threshold for SL and UL prioritization (sl-PriorityThreshold-UL-URLLC). For example, the UL transmission has higher priority than the SL transmission if the priority value of the SL transmission is equal to or larger than the first threshold for SL and UL prioritization (sl-PriorityThreshold-UL-URLLC). For example, the RRC configuration parameters may provide the first threshold for SL and UL prioritization.

In an example, The UE may determine that the UL transmission has higher priority than the SL transmission. For example, the RRC configuration parameters may not provide the first threshold for SL and UL prioritization (e.g., the sl-PriorityThreshold-UL-URLLC parameter may be absent or disabled).

In an example, the UE may determine that the SL transmission has higher priority than the UL transmission, e.g., if the priority value of the SL transmission(s) is smaller than a second SL priority threshold (e.g., sl-Priority Threshold). The UE may determine that the UL transmission has higher priority than the SL transmission, e.g., if the priority value of the SL transmission(s) is equal to or larger than the second SL priority threshold (e.g., sl-Priority Threshold). For example, the RRC configuration parameters may provide the second SL priority threshold.

In an example, a PRACH transmission, and/or a PUSCH scheduled by an UL grant in a RAR and its retransmission, and/or a PUSCH for Type-2 random access procedure and its retransmission, and/or a PUCCH with HARQ-ACK information in response to success RAR, and/or a PUCCH indicated by a DCI format 1_0 with CRC scrambled by a corresponding TC-RNTI may have higher priority than a SL transmission.

In an example, a PUCCH transmission with a sidelink HARQ-ACK information report may have higher priority than a SL transmission, e.g., if a priority value of the PUCCH is smaller than a priority value of the SL transmission. In an example, the SL transmission may have higher priority than the PUCCH transmission with the sidelink HARQ-ACK information report, e.g., if the priority value of the PUCCH transmission is larger than the priority value of the SL transmission.

In an example, a PUCCH transmission with a sidelink HARQ-ACK information report may have higher priority than a PSFCH/S-SS/PSBCH block reception, e.g., if a priority value of the PUCCH is smaller than a priority value of the SL reception. In an example, if the priority value of the PUCCH transmission is larger than the priority value of the PSFCH/S-SS/PSBCH block reception, the SL reception may have higher priority.

In an example, when one or more SL transmissions from a UE overlap in time with multiple non-overlapping UL transmissions from the UE, the UE may perform the SL transmissions, e.g., if at least one SL transmission is prioritized over all UL transmissions subject to the UE processing timeline with respect to the first SL transmission and the first UL transmission.

In an example, when one or more UL transmissions from a UE overlap in time with multiple non-overlapping SL transmissions, the UE may perform the UL transmissions, e.g., if at least one UL transmission is prioritized over all SL transmissions subject to the UE processing timeline with respect to the first SL transmission and the first UL transmission.

In an example, when one SL transmission overlaps in time with one or more overlapping UL transmissions, the UE may perform the SL transmission, e.g., if the SL transmission is prioritized over all UL transmissions subject to both the UE multiplexing and processing timelines with respect to the first SL transmission and the first UL transmission. For example, the UE processing timeline with respect to the first SL transmission and the first UL transmission may be same as when one or more SL transmissions overlap in time with multiple non-overlapping UL transmissions.

In an example, when one SL transmission overlaps in time with one or more overlapping UL transmissions, the UE may perform the UL transmission, e.g., if at least one UL transmission is prioritized over the SL transmission subject to both the UE multiplexing and/or processing timelines with respect to the first SL transmission and the first UL transmission. For example, the UE processing timeline with respect to the first SL transmission and the first UL transmission may be same as when one or more SL transmissions overlap in time with multiple non-overlapping UL transmissions.

In an example, the UE may not be capable of simultaneous transmissions on the UL carrier and on the SL carrier. In an example, the UE may determine simultaneous transmissions on the UL carrier and on the SL carrier. For example, the UE would simultaneously transmit on the UL and on the SL in a carrier or in two respective carriers. The UE may transmit only on the link, UL or SL, with the higher priority. For example, the UE may determine a first priority for the UL transmission on the UL carrier. The UE may determine a second priority for the SL transmission on the SL carrier. The UE may drop one of the UL transmission and the SL transmission that has a lower priority (e.g., priority-based dropping). In an example, the UL transmission may have a higher priority than the SL transmission (e.g., the first priority>the second priority), and the UE may only transmit the UL transmission (e.g., drop the SL transmission). In an example, the UL transmission may have a lower priority than the SL transmission (e.g., the first priority<the second priority), and the UE may only transmit the SL transmission (e.g., drop the UL transmission).

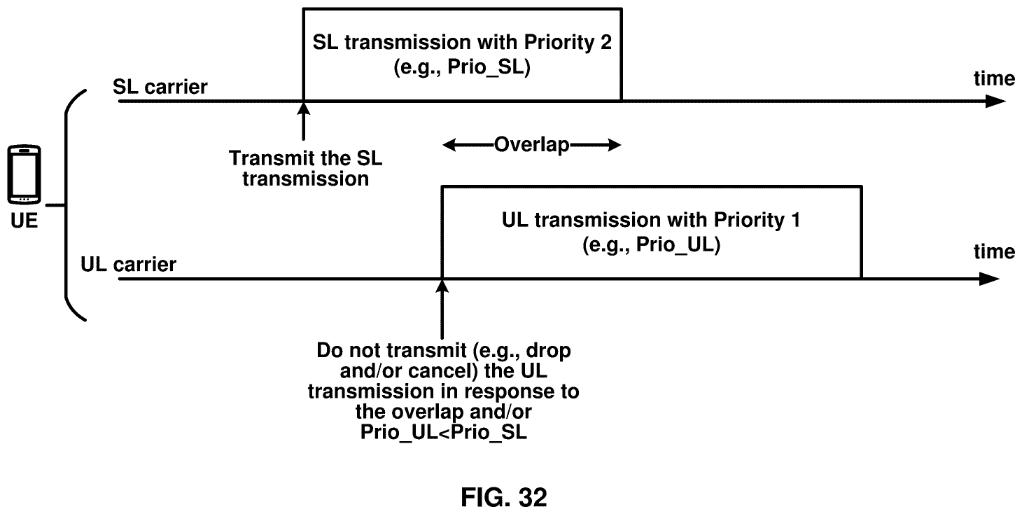

FIG. 32 shows an example of simultaneous UL and SL transmissions. The UE may be configured/scheduled with simultaneous UL and SL transmissions. For example, the UE may determine an UL transmission on an UL carrier, and a SL transmission on a SL carrier. The UL carrier and the SL carrier may be the same. The UL carrier and the SL carrier may overlap. The UL carrier and the SL carrier may be the different, e.g., in a same or different band/frequency. The UL transmission and the SL transmission may overlap, e.g., fully or partially, in time domain. For example, the UE may determine that at least one symbol of the SL transmission (transmission occasion) overlaps with at least one symbol of the UL transmission (transmission occasion).

In the example of FIG. 32, the UE may not be capable of simultaneous transmissions on the UL carrier and on the SL carrier. The UE may determine a first priority for the UL transmission (e.g., Priority 1 or Prio_UL). The UE may determine a second priority for the SL transmission (e.g., Priority 2 or Prio_SL). The UE may determine that the second priority is higher than the first priority. The UE may determine to drop/cancel the UL transmission with the lower priority, e.g., in response to the overlap in one or more symbols with the higher priority SL transmission. As shown in the figure, the UE may transmit only the SL transmission, e.g., in response to Prio_SL>Prio_UL. The total transmission power may be the same in all symbols of the SL transmission. For example, the UE may drop the entire/whole UL transmission (e.g., comprising all symbols of the UL transmission occasion).

In another example, the UE may determine that the first priority of the UL transmission is higher than the second priority of the SL transmission. The UE may determine to drop/cancel the SL transmission with the lower priority, e.g., in response to the overlap in one or more symbols with the higher priority UL transmission. The UE may transmit only the UL transmission, e.g., in response to Prio_SL<Prio_UL. For example, the UE may drop the entire/whole SL transmission (e.g., comprising all symbols of the SL transmission occasion).

In an example, a UE may simultaneously transmit on the UL and on the SL. For example, the UL transmission and the SL transmission may be in a carrier (e.g., same/shared carrier). In an example, or the UL transmission and the SL transmission may be in two respective carriers: the UL carrier and the SL carrier. The UL carrier and the SL carrier may be in a same band (e.g., intra-band) or in different bands (e.g., inter-band). The UL carrier and the SL carrier may partially or fully overlap in frequency domain.

In an example, the UE may be capable of simultaneous transmissions on the UL carrier and on the SL carrier. In an example, the UE may determine simultaneous transmissions on the UL carrier and on the SL carrier. For example, the UE would simultaneously transmit on the UL and on the SL in a carrier or in two respective carriers. The UE may perform power sharing (semi-static or dynamic power sharing) between the SL transmission and the UL transmission. For example, the UE may determine the total sidelink transmission power and the total uplink transmission power. The UE may perform power allocation/control/adjustment of sidelink and uplink to ensure that the total transmit power of sidelink and uplink is not larger than the UE's maximum transmit power/threshold. For example, the maximal transmission power may be bounded by total power of the Uu link and sidelink maximal power. For example, no further power splitting may be needed between Uu and sidelink. The SL transmission power may be constant/consistent in the overlapping and/or the non-overlapping portions/symbols of the SL transmission occasion. In an example, the UL transmission power may be constant/consistent in the overlapping and/or the non-overlapping portions/symbols of the UL transmission occasion. Assuming look-ahead operation, for a given slot in a serving cell, it a UE may know whether and how a symbol pattern in the slot of the serving cell and another symbol pattern in another serving cell overlap in time. The UE may determine the SL and UL transmission power correspondingly.

In an example, the UE may be capable of simultaneous transmissions on the UL carrier and on the SL carrier. For example, the UL carrier and the SL carrier may or may not be the same. For example, the UL carrier and the SL carrier may or may not overlap in frequency domain. For example, the UL carrier and the SL carrier may or may not be in the same band/frequency. The UE may determine a SL transmission on the SL carrier and an UL transmission on the UL carrier. The UE would transmit on the UL and on the SL in the two respective carriers. The transmission on the UL may overlap with the transmission on the SL over a time period, e.g., at least over/in one symbol. The UE may determine a first transmission power for the SL transmission. The UE may determine a second transmission power for the UL transmission. The UE may determine that the total UE transmission power (e.g., sum of the first transmission power and the second transmission power) over the time period would exceed a maximum transmission power threshold, e.g., PCMAX.

In an example, the UE may transmit transmission with the higher priority using the determined power. For example, the UE may perform, power reduction/control/adjustment for the transmission with lower priority, such that the total UE transmission power would not exceed a threshold.

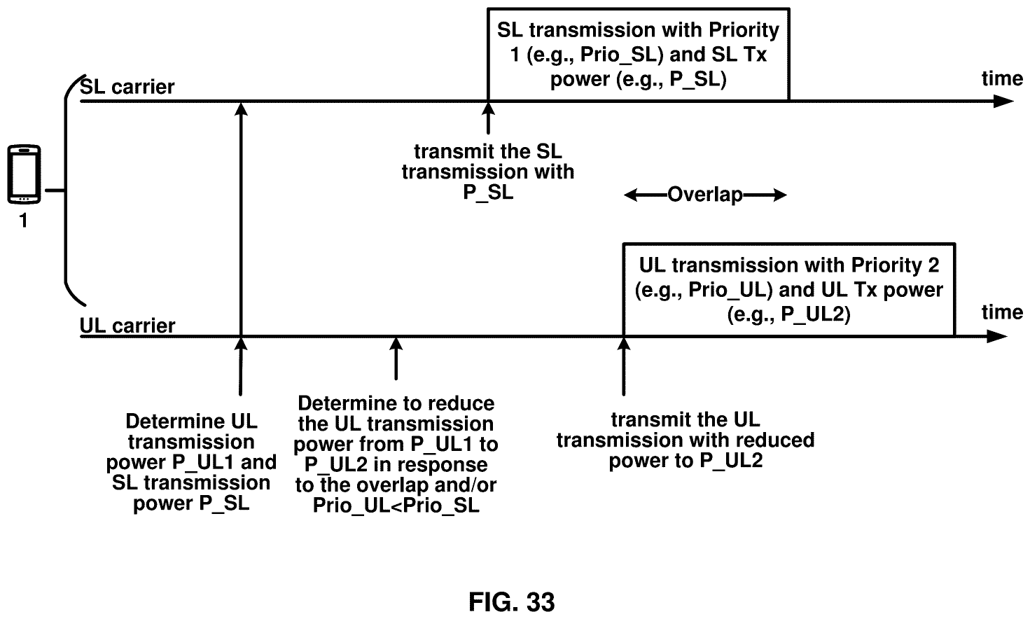

FIG. 33 shows an example of power reduction for simultaneous UL and SL transmissions. The UE may be configured/scheduled with simultaneous UL and SL transmissions. For example, the UE may determine an UL transmission on an UL carrier, and a SL transmission on a SL carrier. The UL carrier and the SL carrier may be the same. The UL carrier and the SL carrier may overlap. The UL carrier and the SL carrier may be the different, e.g., in a same or different band/frequency. The UL transmission and the SL transmission may overlap, e.g., fully or partially, in time domain. For example, the UE may determine that at least one symbol of the SL transmission (transmission occasion) overlaps with at least one symbol of the UL transmission (transmission occasion).

The UE may determine a first transmission power for the SL transmission (P_SL). The UE may determine a second transmission power for the UL transmission (P_UL1). The UE may determine that the total UE transmission power (e.g., sum of the first transmission power and the second transmission power) over the time period would exceed a maximum transmission power threshold, e.g., PCMAX. In an example, the UE may transmit the transmission with the higher priority using the determined power. For example, the UE may perform, power reduction/control/adjustment for the transmission with lower priority, such that the total UE transmission power would not exceed a threshold.

In the example of FIG. 33, the UE may be capable of simultaneous transmissions on the UL carrier and on the SL carrier. The UE may determine a first priority for the SL transmission (e.g., Priority 1 or Prio_SL). The UE may determine a second priority for the UL transmission (e.g., Priority 2 or Prio_UL). The UE may determine that the first priority is higher than the second priority. The UE may determine to reduce the power for the UL transmission, e.g., prior to the start of the UL transmission, if the SL transmission has higher priority than the UL transmission (Prio_SL>Prio_UL), so that the total UE transmission power would not exceed the threshold, PCMAX. The UE may reduce the transmission power of the UL transmission with the lower priority, from the second transmission power (P_UL1) to a third transmission power (P_UL2) e.g., in response to the overlap in one or more symbols with the higher priority SL transmission, and/or in response to the total transmission power of the UL transmission and the SL transmission exceeding the maximum power/threshold. As shown in the figure, the UE may transmit the SL transmission with the first transmission power (P_SL), e.g., in response to Prio_SL>Prio_UL. The total transmission power may be the same in all symbols of the SL transmission. The UE may transmit the UL transmission with the third transmission power (P_UL2), e.g., in response to Prio_SL>Prio_UL. The total transmission power may be the same in all symbols of the UL transmission. The total transmission power of SL and UL may not exceed the maximum power threshold (e.g., P_SL+P_UL2=<P_CMAX).

The example procedures shown in FIG. 32 and FIG. 33 may be referred to as de-prioritization of the UL transmission, which may comprise dropping (not transmitting) the UL transmission and/or reducing transmission power of the UL transmission. In these examples, the UL transmission has a lower priority than the overlapping SL transmission, and thus, is de-prioritized. For example, the SL transmission with the higher priority than the UL transmission may be prioritized, e.g., transmitted and/or transmitted with the determined/required/original power.

In another example, the UE may determine that the first priority of the SL transmission is lower than the second priority of the UL transmission. The UE may determine reduce the power for the SL transmission, e.g., prior to the start of the SL transmission, if the UL transmission has higher priority than the SL transmission (Prio_UL>Prio_SL), so that the total UE transmission power would not exceed the threshold, PCMAX. The UE may reduce the transmission power of the SL transmission with the lower priority, from the first transmission power (P_SL1) to a fourth transmission power (P_SL2) e.g., in response to the overlap in one or more symbols with the higher priority UL transmission, and/or in response to the total transmission power of the UL transmission and the SL transmission exceeding the maximum power/threshold. The UE may transmit the UL transmission with the second transmission power (P_UL1, original/determined UL transmission power), e.g., in response to Prio_UL>Prio_SL. The UE may transmit the SL transmission with the fourth transmission power (P_SL2, reduced SL transmission power), e.g., in response to Prio_UL>Prio_SL. The total transmission power may be the same in all symbols of the SL transmission. The total transmission power of SL and UL may not exceed the maximum power threshold (e.g., P_SL2+P_UL1=<P_CMAX).

In an example, a UE may be configured for simultaneous uplink and sideilnk (e.g., NR V2X sidelink and NR uplink) transmissions, e.g., for intra-band and/or inter-band con-current operation. The UE may set/determine its configured maximum output power P_{CMAX,c,NR} and P_{CMAX,c,V2X} for the configured NR uplink carrier and the configured NR V2X carrier, respectively, and its total configured maximum output power P_{CMAX,c}.

In an example, the configured maximum output power P_{CMAX c,NR} (p) in slot p for the configured uplink carrier may be set within the bounds: P_{CMAX_L,c,NR} (p)≤P_{CMAX,c,NR} (p)≤P_{CMAX_H,c,NR} (p), where P_{CMAX_L,c,NR} and P_{CMAX_H,c,NR} are the limits for a serving cell c. The second configuration parameters may indicate the location and bandwidth of the SL carrier; one or more sidelink channels and/or signals in a sidelink resource pool of the sidelink carrier; and a maximum output power (e.g., P_{CMAX c,SL} Or P_{CMAX c,V2X}) for the sidelink carrier. The configured maximum output power P_{CMAX c,V2X} (q) in slot q for the configured NR V2X carrier may be set within the bounds: P_{CMAX,c,V2X} (q)≤P_{CMAX_H,c,V2X} (q), where P_{CMAX_H,c,V2X} is the limit.

In an example, a UE/base station may determine a total UE configured maximum output power P_{CMAX}. For example, the total UE configured maximum output power P_{CMAX} (p,q) in a slot p of NR uplink carrier and a slot q of NR V2X sidelink that overlap in time may be set/determined within the following bounds (e.g., for synchronous and asynchronous operation): P_{CMAX_L} (p,q)≤P_{CMAX} (p,q)≤P_{CMAX_H} (p,q), where P_{CMAX_L} (p,q)=P_{CMAX_L,c,NR} (p), and P_{CMAX_H} (p,q)=10 log₁₀ [p_{CMAX_H,c,NR} (p)+p_{CMAX_H,c,V2X} (q)], and where p_{CMAX_H,c,V2X} and p_{CMAX_H,c,NR} are the limits P_{CMAX_H,c,V2X} (q) and P_{CMAX_H,c,NR} (p) expressed in linear scale.

In the existing technology, if a SL transmission overlaps with an UL transmission, the UE may drop/cancel the lower priority transmission. However, for sidelink operation in unlicensed/shared spectrum (e.g., SL-U), if an UL transmission overlaps with a CPE of a sidelink transmission, the UE and BS behaviour is not defined. For example, embodiment enables avoiding cancellation/dropping of an entire UL transmission that overlaps with a CPE of a SL transmission. Based on the embodiments, both UL and SL transmissions may be transmitted despite the overlap with the CPE.

Sidelink transmissions are slot-based. In the existing technology, the SL/UL conflict may be limited to a SL slot level. But in SL-U, due to CPE being extended to the previous SL slot (e.g., physical slot and/or logical slot), the impact may be considerably increased, such that the legacy behavior may not be efficient anymore. For example, the sidelink transmission in a first slot (e.g., sidelink slot) may overlap with a first uplink transmission, and the CPE of the sidelink transmission in a second slot (e.g., sidelink slot) immediately preceding the first slot (e.g., the previous/adjacent physical slot), may overlap with a second uplink transmission. Following the existing technology may result in dropping/cancellation of both first and second uplink transmissions, although CPE is a short transmission (maximum 1 or 2 symbol duration) not conveying any information. In another example, the sidelink transmission may be prioritized the overlap conflict with the first uplink transmission, however, the CPE may not be deprioritized the overlap conflict with the second uplink transmission. This may result in dropping/cancellation of both the sidelink transmission and first uplink transmission. Therefore, there is a need to address the overlap of SL CPE transmission with an uplink transmission in time, such that excessive dropping/cancellation is avoided.

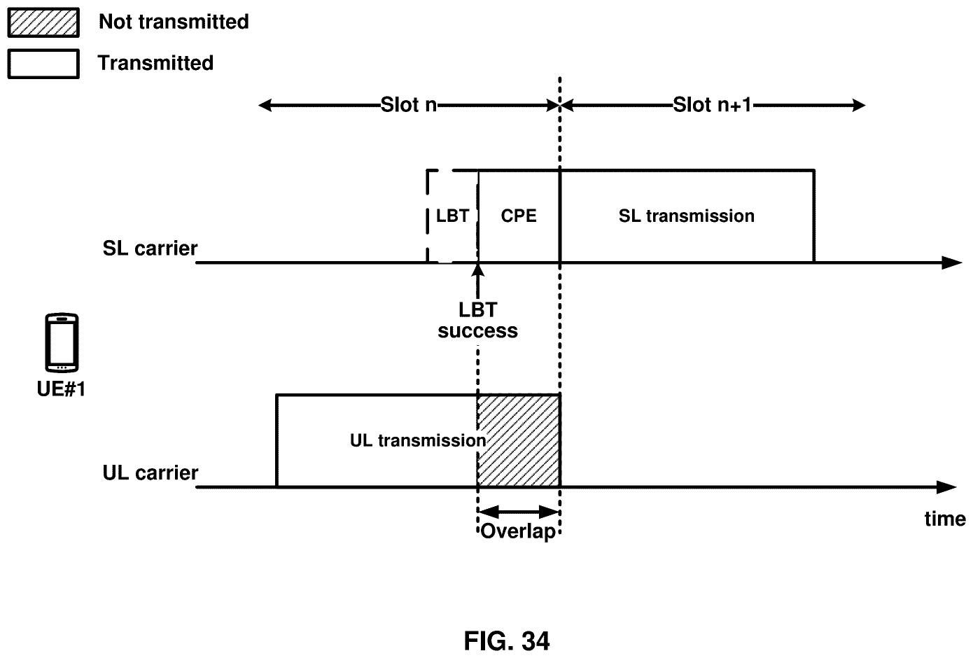

FIG. 34 shows an example of the sidelink CPE (CPE of a SL transmission) overlapping with an UL transmission. As shown in FIG. 34, a SL transmission in a first SL slot (e.g., slot n+1) may have a CPE in a latest preceding slot (e.g., previous physical/logical SL slot, slot n). For example, a starting symbol of the sidelink transmission may be in slot n+1, and a CPE starting position of the sidelink transmission may be in slot n. For example, the UE may perform a LBT procedure prior to the starting symbol of the sidelink transmission. For example, the LBT may be successful, before the starting symbol of the sidelink transmission, in slot n. The UE may transmit the CPE from the CPE starting position until the starting symbol of the sidelink transmission. The sidelink transmission may comprise PSCCH/PSSCH and/or PSFCH and/or S-SSB transmission.

As shown in FIG. 34, the CPE transmission in SL slot n, may overlap in time with an uplink transmission. The uplink transmission may comprise PUSCH and/or PUCCH and/or SRS and/or PRACH transmission. In the existing technology, the overlap may result in full cancellation/dropping of the UL transmission, e.g., if the SL transmission and/or the CPE of SL transmission has a higher priority than the UL transmission, although the UL transmission ends before the starting symbol of the SL transmission in slot n+1.

The uplink transmission may be in a third UL slot of an uplink carrier (e.g., a slot based on a SCS/numerology of the UL carrier). For example, the third uplink slot may fully or partially overlap with the second sidelink slot (slot n). For example, the sidelink transmission may be in a sidelink carrier, and the uplink transmission may be in an uplink carrier. The sidelink carrier and the uplink carrier may be different (e.g., may be in different bands and/or may have different center frequency and/or bandwidth). The UL carrier and the SL carrier may or may not have a same SCS/numerology. For example, the third UL slot and the second SL slot may fully overlap, e.g., if the UL carrier and the SL carrier have the same SCS/numerology and/or the UL TA is (almost) zero.

In an example, the CPE may overlap with an uplink transmission in the previous slot (e.g., SL slot overlapping with an UL slot), which may result in dropping the entire UL transmission in the previous slot based on the existing technology. In SL-U (mode 1 and/or mode 2), the BS is not aware of whether there is a CPE or not (e.g., depending on whether there is a COT or not, and/or depending on the LBT type of the SL transmission), and/or the duration of the CPE (e.g., indicated by a COT initiating UE, and/or based on the priority of the SL transmission, and/or based on presence of other reservations, etc., which are not known to the BS). Therefore, the BS cannot schedule UL transmissions avoiding overlap with SL CPE. And, following the existing technology, the SL UE may frequently drop UL transmissions overlapping in time with a CPE of a SL transmission. This is inefficient and may reduce the reliability and throughput of the uplink, and result in excessive retransmissions and increased latency.

Embodiments disclose mechanisms to avoid full and/or duplicated dropping of UL transmissions due to a CPE of a SL transmission. In an embodiment, as illustrated in FIG. 34, a SL UE may only omit (e.g., based on puncturing and/or rate-matching) one or more symbols (e.g., last symbols or first symbols) of the uplink transmission if the UL transmission overlaps (e.g., only) in time with CPE of a SL transmission. In an embodiment, the UE may determine prioritization between UL transmission and a SL CPE transmission independently from the corresponding SL transmission. In an embodiment, a priority of the CPE of a SL transmission may be different than the priority of the sidelink transmission. In an embodiment, the UE may determine a LBT failure and/or continue the SL LBT procedure if the SL CPE overlaps in time with an UL transmission. Embodiments enhance simultaneous transmission of UL and SL in unlicensed spectrum by handling the CPE transmission properly and/or independently than the SL transmission. Embodiments help reduce dropping/cancellation and/or power reduction of simultaneous UL and SL transmissions caused by CPE.

In an example, the UE may omit the one or more symbols of the UL transmission that overlap in time with the SL CPE. However, the BS is not aware of whether there is a SL CPE overlapping with the UL transmission and/or how long the SL CPE is and/or where the CPE starting position is and/or how long the overlap is. Therefore, the BS may not be able to successfully receive the UL transmission, e.g., because the BS may not know the resulting TB size after omitting/puncturing/rate-matching.

In an embodiment, the UE may omit (e.g., based on puncturing and/or rate-matching) one or more symbols of the uplink transmission if the UL transmission overlaps in time with CPE of a SL transmission. In embodiment, a number of the one or more symbols of the UL transmission that are omitted may be fixed, e.g., pre-defined and/or pre-configured. In an embodiment, the UE may omit a first number of symbols of the UL transmission based on a first/default/maximum/minimum SL CPE duration. In an embodiment, the UE may omit the first number of symbols of the UL transmission based on a first/default/earliest/last starting position of the CPE. In embodiment, a number of the one or more symbols of the UL transmission that are omitted may be indicated/reported to the BS. In an embodiment, the UE may indicate the actual SL CPE length/duration and/or the actual starting position of the CPE to the BS, e.g., via PUSCH and/or PUCCH. In an embodiment, the UE may omit (e.g., based on puncturing and/or rate-matching) one or more symbols of the uplink transmission that overlap in time with the actual CPE transmission of the SL transmission.

In an embodiment, a wireless device (UE, e.g., Tx UE) may receive from a base station an RRC message comprising configuration parameters of a cell. The configuration parameters may indicate a SCS and/or numerology for an uplink bandwidth part (e.g., the active UL BWP) of an uplink carrier of the cell. The UE may determine frames, subframes, and slot boundaries of the UL BWP in the UL carrier. The configuration parameters may comprise uplink channels configurations (e.g., PUSCH configuration and/or PUCCH configuration and/or SRS configuration and/or PRACH configuration, etc.). The uplink carrier may be configured for operation with shared spectrum (e.g., unlicensed cell). The uplink carrier may not be configured for operation with shared spectrum (e.g., licensed cell).

The wireless device may receive from the base station a DCI comprising an uplink grant, a PRACH order, or a downlink grant. The DCI may indicate an UL transmission, e.g., PUSCH, PUCCH, PRACH, or SRS. The UL grant may indicate a PUSCH transmission via the UL BWP of the UL carrier. The PRACH order may indicate a PRACH/preamble transmission via the UL BWP of the UL carrier. The DL grant may indicate a PUCCH transmission via the UL BWP of the UL carrier. The DCI may comprise an information field, e.g., a TDRA field, indicating a first uplink slot of the uplink BWP/carrier for the uplink transmission. The field may indicate a starting symbol(S) and/or a length (L) for the uplink transmission in the first UL slot.

The UE may determine, based on the field in the DCI, the starting symbol of the UL transmission in the first UL slot. The UE may determine a length of the UL transmission, starting from the starting symbol. The UE may determine an ending symbol of the UL transmission based on the starting symbol and the length of the UL transmission (e.g., S+L). The ending symbol of UL transmission may be in the first UL slot.

The UE may determine a number of one or more symbols, e.g., in the first UL slot, for the uplink transmission. For example, the one or more symbols may be consecutive. For example, the one or more symbols may start from (including) the starting symbol. For example, the one or more symbols may end at (including) the ending symbol. The number of the one or more symbols may be given by the length of the uplink transmission (L). The number of the symbols may be indicated by the BS (e.g., via DCI and/or MAC-CE and/or RRC message).

The UE may determine one or more parameters for the UL transmission based on the number of the one or more symbols, e.g., TBS, and/or PUCCH format, and/or reference signal pattern/position (e.g., DMRS), etc. The UE may determine a TB size (TBS) for transmission of a transport block via the uplink transmission (e.g., via PUSCH transmission). The UE may determine a UCI size and/or a PUCCH format for transmission of uplink control information via the uplink transmission. The UE may determine a PRACH format for transmission of a preamble via the uplink transmission.

The UE and the BS may have a common understanding of the one or more parameters for the UL transmission, such that the BS can successfully receive and decode the UL transmission based on the one or more parameters.

The uplink transmission may be a semi-static transmission, e.g., configured/scheduled via SIB and/or RRC message. The uplink transmission may be/comprise a configured grant uplink transmission, and/or a periodic PUCCH/SRS/CSI report, and/or PRACH. For example, a RRC message and/or a DCI may indicate the radio resources for the uplink transmission, including the first slot and/or the starting symbol and/or the length.

The UE may determine a first priority (e.g., physical priority, or transmission priority) for the uplink transmission, e.g., based on one or more logical channels and/or MAC-CEs and/or control information multiplexed in the uplink transmission. In an example, the first priority of the uplink transmission may be 0 (e.g., low priority) or 1 (e.g., high priority).

The wireless device (UE, e.g., Tx UE) may receive from the base station an RRC message comprising sidelink configuration parameters. For example, the UE may be in coverage area of a cell comprising a SL carrier (e.g., mode 1 operation). The sidelink configuration parameters may indicate a SCS and/or numerology for a sidelink bandwidth part (e.g., the active SL BWP) of a sidelink carrier. The UE may determine frames, subframes, and slot boundaries of the SL BWP in the SL carrier. The sidelink configuration parameters may comprise sidelink channels configurations of a resource pool in the SL BWP, e.g., PSSCH configuration and/or PSCCH configuration and/or PSFCH configuration and/or S-SSB configuration, etc. The sidelink carrier may be configured for operation with shared spectrum (e.g., unlicensed carrier). The sidelink carrier may not be configured for operation with shared spectrum (e.g., licensed carrier).

The UE may determine that the UL frame/subframe boundary and the SL frame/subframe boundary are aligned (e.g., except for TA value of the UL carrier).

An uplink slot may refer to a slot corresponding to the uplink carrier/BWP.

In an example, a first SCS/numerology of the UL BWP/carrier may be the same as (equal to) a second SCS/numerology of the SL BWP/carrier. In an example, a first SCS/numerology of the UL BWP/carrier may be larger/greater than a second SCS/numerology of the SL BWP/carrier. In an example, a first SCS/numerology of the UL BWP/carrier may be smaller than a second SCS/numerology of the SL BWP/carrier.

The wireless device may receive from the base station a DCI comprising a sidelink grant. The DCI may indicate a sidelink transmission, e.g., PSSCH/PSCCH and/or PSFCH. The SL grant may indicate a PSSCH transmission via the SL BWP of the SL carrier. The DCI may comprise an information field, e.g., a TDRA field, indicating a first sidelink slot of the sidelink BWP/carrier for the sidelink transmission. The field may indicate a starting symbol(S) and/or a length (L) for the sidelink transmission in the first UL slot. In an example, the sidelink configuration parameters of the resource pool may indicate the starting symbol and/or length for the sidelink transmission (e.g., PSSCH transmissions) in the resource pool.

In an example, multiple (e.g., 2) starting symbols may be (pre-) configured for sidelink transmissions (e.g., PSSCH/PSCCH and/or PSFCH/S-SSB transmissions) in the resource pool. For example, the UE may determine to use the earliest starting symbol, and perform a first LBT/channel access procedure prior to the earliest staring symbol. For example, if the first LBT fails, the UE may determine to use a next (e.g., second) starting symbol, and perform a second LBT/channel access procedure prior to the next/second staring symbol, and so on.

A first starting symbol of the sidelink transmission may be one of {symbol #0, symbol #1, symbol #2, . . . , symbol #6} of a sidelink slot. For example, a default location of the first starting symbol (e.g., if no (pre) configuration is indicated), may be symbol #0. A second starting symbol of the sidelink transmission may be one of {symbol #3, symbol #4, symbol #5, symbol #6, symbol #7} of the sidelink slot. For example, the second starting symbol may be (pre-) configured to be later than the first starting symbol. For example, within a slot, the number of symbols used for PSCCH/PSSCH transmission from the second starting symbol may not be smaller than 6. For example, a PSCCH/PSSCH transmission starting from the first or the second starting symbol shall have the same ending symbol within the slot. Symbol indexes in a slot (a sidelink slot) starts from #0.

A sidelink slot may refer to a slot corresponding to the sidelink carrier/BWP/resource pool.

The UE may determine the radio resources (e.g., including the starting symbol and/or length) of the sidelink transmission in the first sidelink slot based on the sidelink grant. For example, the UE may receive a DCI indicating the sidelink grant (e.g., in mode 1). In an example, the UE (e.g., MAC layer of the UE) may select a resource for the sidelink transmission (e.g., in mode 2). The UE may determine to transmit a TB and/or control information and/or reference signal via the sidelink transmission in the first sidelink slot.

The sidelink configuration parameters may comprise parameters for shared channel access (e.g., sidelink access configuration, or sl-AccessConfigList), e.g., for operation in a cell/carrier configured in shared spectrum. The parameters for sidelink shared channel access may indicate a list of CPEs applicable to sidelink transmissions in the sidelink carrier/BWP/resource pool. For example, the parameters may indicate a list of combinations of CPE, CAPC, and SL channel access type applicable to sidelink transmissions. For example, the parameters may indicate one or more starting positions of CPE applicable to sidelink transmission. For example, the parameters may indicate one or more durations of CPE applicable to sidelink transmission.

The UE may determine a CPE and/or CAPC and/or LBT type for the sidelink transmission in the first sidelink slot. The LBT type and/or CPE and/or CAPC of the sidelink transmission may be determined by the UE, e.g., based on one or more criteria/conditions. For example, the UE may determine the LBT type and/or CPE (e.g., starting position and/or duration of the CPE) for the sidelink transmission based on whether the sidelink transmission is within a COT or not. For example, if the sidelink transmission is not within a COT (e.g., a shared COT), the UE may determine a first LBT type (e.g., Type1) and/or no CPE or a first CPE starting point/duration. For example, if the sidelink transmission is within a COT (e.g., a shared COT), the UE may determine a second LBT type (e.g., Type2A/2B/2C) and/or a second CPE starting point/duration.

For example, the UE may determine the LBT type and/or CPE for the sidelink transmission based on the channel type (e.g., whether it is PSSCH/PSCCH or PSFCH or S-SSB). For example, the UE may determine the LBT type and/or CPE for the sidelink transmission based on whether the resource of the sidelink transmission has been reserved by another UE or not. For example, the UE may determine the LBT type and/or CPE for the sidelink transmission based on a bandwidth of the sidelink transmission. For example, if the sidelink transmission is on all resource block of an RB set (e.g., full bandwidth), the UE may determine a first CPE starting point/duration (e.g., based on random selection). For example, if the sidelink transmission is on fewer than all resource blocks of an RB set (e.g., partial bandwidth), the UE may determine a second CPE starting point/duration (e.g., a default/common CPE starting position/duration).

In an example, the UE may receive a COT sharing indication (e.g., COT structure, or COT information) from a second UE. For example, the UE may receive a SCI and/or a MAC-CE indicated by a SCI that comprise the COT sharing indication. The COT sharing indication may comprise a field indicating a CPE to be used b the UE within the COT. For example, the COT sharing indication may indicate a CPE duration and/or a CPE starting position for a transmission of the UE in the shared COT.

Throughout this disclosure, the term CPE may be used to refer to a CPE starting point/position and/or CPE duration/length.

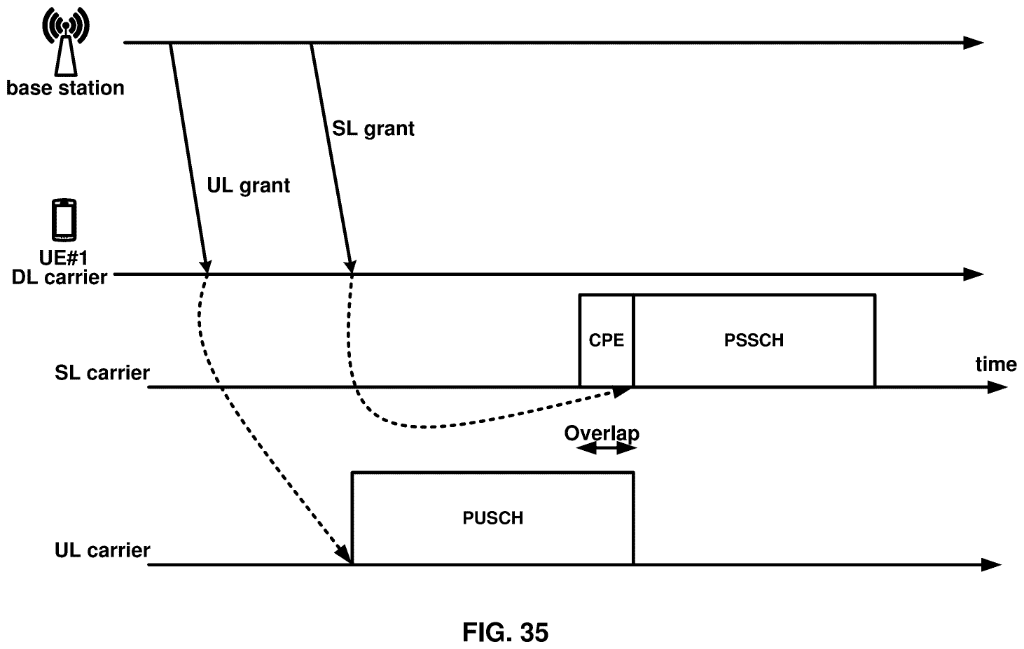

FIG. 35 shows an example of sidelink and uplink transmission. The UE may receive an UL grant indicating an UL transmission (e.g., PUSCH transmission) via an uplink carrier. The UE may receive a SL grant indicating a sidelink transmission (e.g., PSSCH transmission) via a sidelink carrier. The UL carrier and the SL carrier may be the same carrier. The UL carrier and the SL carrier may have a same center frequency. The UL carrier and the SL carrier may be in a same frequency band. The UL carrier and the SL carrier may be in different frequency bands.

The UE may determine a CPE of a first OFDM symbol of the SL transmission. As shown in FIG. 35, the CPE of the SL transmission may overlap in time with the UL transmission (e.g., partially). In an example, the SL transmission may only overlap with the UL transmission in the CPE of the first OFDM symbol (e.g., not any other portion of the SL transmission may overlap with the UL transmission).

For example, the CPE of the SL transmission may start before a starting symbol/location of the sidelink transmission. For example, the CPE starting position may be in one or more symbols before/preceding the starting symbol of the SL transmission. For example, the UL transmission may not overlap in time with the symbols allocated to the sidelink transmission excluding the CPE (e.g., from/including the staring symbol to the ending symbol). For example, the UL transmission may end before the starting symbol of the SL transmission.

In an embodiment, the UE may not be capable of simultaneous transmission of the UL transmission and the SL CPE transmission, during the overlap, in the respective carriers. For example, the UE may determine to transmit only one of the UL transmission and the sidelink CPE transmission during/based on the overlap.

In an embodiment, the UE may only transmit the UL transmission, if the UL transmission only overlaps in time with a CPE of the SL transmission. In an embodiment, the UE may only transmit the UL transmission during the overlap, if the UL transmission only overlaps in time with a CPE of the SL transmission. In an embodiment, the UE may only transmit the UL transmission during a period based on the overlap, if the UL transmission only overlaps in time with a CPE of the SL transmission. In an embodiment, the UE may only not transmit the SL CPE (e.g., only cancel or drop the CPE of the SL transmission), if the UL transmission only overlaps with a CPE of the SL transmission. In an embodiment, the UE may transmit the SL transmission, if the UL transmission only overlaps with a CPE of the SL transmission. In an embodiment, the UE may transmit the SL transmission from a later/second/next starting symbol, if the UL transmission only overlaps with a CPE of a first/earliest starting symbol of the SL transmission. In an embodiment, the UE may transmit the SL transmission without the CPE, or with a shorter CPE (from a later CPE starting position), if the UL transmission only overlaps with a CPE of the SL transmission.

In an embodiment, the UE may only transmit the UL transmission during the overlap, if the UL transmission only overlaps in time with a CPE of the SL transmission and the UL transmission has a higher priority than the SL transmission. In an embodiment, the UE may only transmit the UL transmission during the overlap, if the UL transmission only overlaps in time with a CPE of the SL transmission and the UL transmission has a higher priority than the CPE of the SL transmission.

In an embodiment, a CPE of a transmission may have a fixed priority, e.g., irrespective of the priority of the transmission itself. For example, a CPE of a SL transmission may have a fixed priority, e.g., irrespective of the priority of the SL transmission. In an embodiment, the CPE may (always) have a lowest priority of all transmissions. In an embodiment, the CPE may (always) have a highest priority of all transmissions. In an embodiment, the CPE of a transmission may have a same priority as the transmission. In an embodiment, the CPE of a SL transmission may have a same priority as the SL transmission. In an embodiment, a priority of a CPE is equal to a priority of a COT comprising the CPE.

In an embodiment, the UE may only transmit the CPE, if the UL transmission only overlaps in time with a CPE of the SL transmission. In an embodiment, the UE may only transmit the CPE during the overlap, if the UL transmission only overlaps in time with a CPE of the SL transmission. In an embodiment, the UE may not transmit a portion of the UL transmission (e.g., only cancel or drop or remove or omit or puncture the UL transmission), if the UL transmission only overlaps with a CPE of the SL transmission. The portion of the UL transmission may be based on the overlap with the CPE. For example, the portion may comprise one or more symbols of the UL transmission that overlap in time with the CPE transmission. For example, the portion may be a fixed number of last symbols of the UL transmission (e.g., at the end of the UL transmission). In an embodiment, the UE may transmit the uplink transmission until (e.g., excluding) a symbol that overlaps in time with the CPE transmission. In an embodiment, the UE may shorten the duration/length of the uplink transmission (e.g., based on rate-matching) to avoid the overlap with the CPE transmission. In an embodiment, the UE may not transmit the UL transmission (e.g., cancel or drop or remove or omit or puncture the UL transmission) during a period, if the UL transmission only overlaps with a CPE of the SL transmission. In an embodiment, the period may be equal to the duration of the overlap in time. In an embodiment, the period may be a default duration, e.g., based on a default CPE duration and/or a default CPE starting position. In an embodiment, the period may be a maximum duration, e.g., based on a maximum CPE duration and/or an earliest CPE starting position.

In an embodiment, the UE may transmit the CPE and the SL transmission, if the UL transmission only overlaps with a CPE of the SL transmission. In an embodiment, the UE may transmit the SL transmission including the CPE, if the UL transmission only overlaps with a CPE of the SL transmission.

In an embodiment, the UE may only transmit the CPE, if the UL transmission only overlaps in time with a CPE of the SL transmission and the UL transmission has a lower priority than the SL transmission. In an embodiment, the UE may only transmit the CPE, if the UL transmission only overlaps in time with a CPE of the SL transmission and the UL transmission has a lower priority than the CPE of the SL transmission.

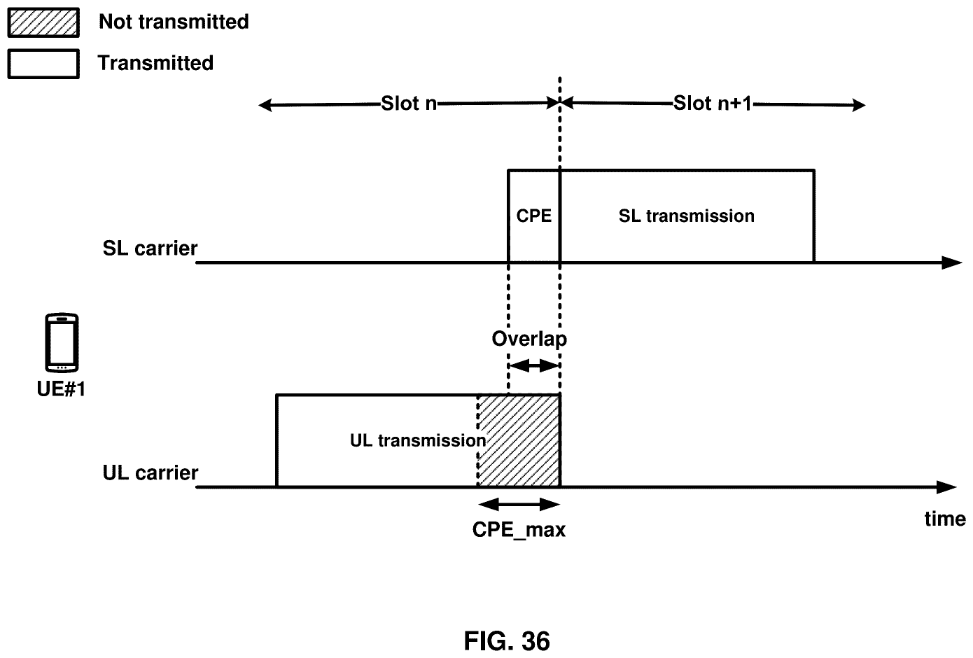

FIG. 36 shows an example of UL transmission overlapping with a CPE of a SL transmission. As shown in the figure, the SL transmission may be in a first sidelink slot: slot n+1 (e.g., sidelink slot n+1). The CPE of a starting OFDM symbol of the SL transmission may be in a second sidelink slot, e.g., previous (immediately preceding) sidelink slot: slot n. For example, the slots may be physical slots. For example, the slots may be logical slots. The sidelink slots may be based on a SCS/numerology of the SL carrier. The CPE of the SL transmission may overlap in time with an UL transmission, e.g., in a same carrier or a different UL carrier. For example, the UL transmission may be in a first UL slot that overlaps with sidelink slot n. the UL slot may be based on a SCS/numerology of the UL carrier.

As shown in FIG. 36, the UE may omit/remove the UL transmission in response to overlapping with the CPE. For example, if the UL transmission overlaps in time (e.g., only) with the CPE of the SL transmission, the UE omits/drops/removes/punctures the UL transmission during a period. In order to establish a common understanding about the size of the UL transmission with the BS, the period of the UL transmission that is omitted/removed/punctured is fixed or pre-defined or (pre-) configured. For example, the period is a maximum duration of CPE durations configured by RRC for the SL resource pool/BWP/carrier. For example, the period is a default duration of CPE durations configured by RRC for the SL resource pool/BWP/carrier. For example, the period is a default duration pre-defined for the corresponding SCS/numerology of the SL carrier and/or UL carrier.

In an example, the period starts from a default or pre-defined or (pre-) configured CPE starting position and ends in the (including the end of) the UL transmission. In an example, the period starts from a default or pre-defined or (pre-) configured CPE starting position until the end of the first UL slot. In an example, the period starts from a default or pre-defined or (pre-) configured CPE starting position until the end of the second sidelink slot (slot n).

As shown in FIG. 36, the UE may transmit the CPE during the overlap in the second sidelink slot.

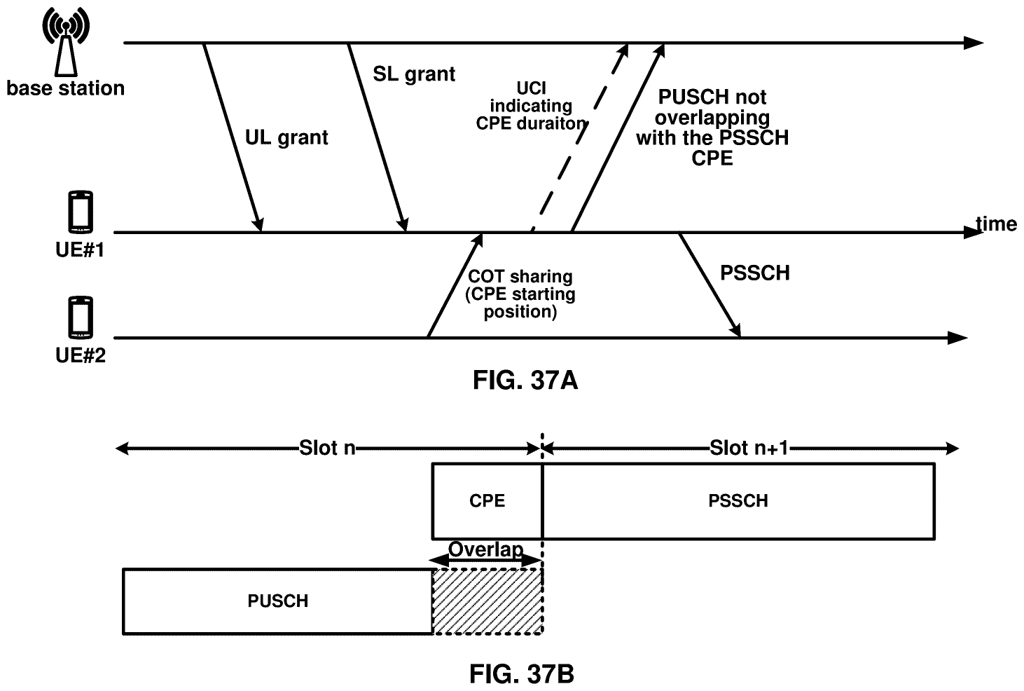

FIG. 37A and FIG. 37B show an example of simultaneous UL transmission and CPE transmission of a SL transmission. As shown in FIG. 37A, the UE may receive an UL grant indicating a PUSCH transmission in a first UL slot of an UL carrier. The UE may receive a SL grant indicating a PSSCH transmission in a first SL slot of a SL carrier. As shown in FIG. 37B, the SL transmission (e.g., PSSCH) may be in the first sidelink slot: slot n+1 (e.g., sidelink slot n+1). The CPE of a starting OFDM symbol of the SL transmission may be in a second sidelink slot, e.g., previous (immediately preceding) sidelink slot: slot n. For example, the slots may be physical slots. For example, the slots may be logical slots. The sidelink slots may be based on a SCS/numerology of the SL carrier. The CPE of the SL transmission may overlap in time with the UL transmission, e.g., in a same carrier or a different UL carrier. For example, the UL transmission may be in the first UL slot that overlaps with sidelink slot n. The UL slot may be based on a SCS/numerology of the UL carrier.

As shown in FIG. 37A, the UE may receive a COT sharing indication for the SL transmission. The UE may determine to transmit the SL transmission (the PSSCH) in the shared COT. The COT sharing indication may indicate a LBT type and/or CAPC and/or CPE for the SL transmission within the COT. The UE may determine a CPE starting point and/or CPE duration for the SL transmission based on the COT sharing indication. The CPE of the sidelink transmission may overlap in the with the UL transmission.

As shown in FIG. 37B, the UE may omit/remove the UL transmission in response to overlapping with the CPE. For example, if the UL transmission overlaps in time (e.g., only) with the CPE of the SL transmission, the UE omits/drops/removes/punctures the UL transmission during a period. In order to establish a common understanding about the size of the UL transmission with the BS, the UE report the CPE duration to the BS. For example, the BS may know the starting symbol of the SL transmission based on the SL grant. The UE may send/transmit a signal (e.g., a UCI) to the BS indicating the CPE starting point and/or CPE duration of the first/starting OFDM symbol of the SL transmission. For example, the UE may transmit the UCI via the UL transmission (PUSCH). For example, the UE may indicate the CPE via a second UL transmission, e.g., a PUCCH in another UL carrier. In an embodiment, the UE indicates to the BS, via UL signaling, the period during which the one or more symbols (e.g., last symbol(s) of the UL transmission are omitted/removed/punctured. The UE may then transmit the PUSCH until the overlap, or until the start of the period. The PUSCH transmission may not comprise any symbols overlapping in time with the CPE transmission. The BS may successfully receive the PUSCH. The UE may also transmit the CPE of the sidelink transmission. The UE may transmit the PSSCH including the CPE. Thus, not only the UL transmission is survived, but also the SL transmission is performed within the COT and the COT continuity in the sidelink is maintained (COT is not interrupted due to CPE).

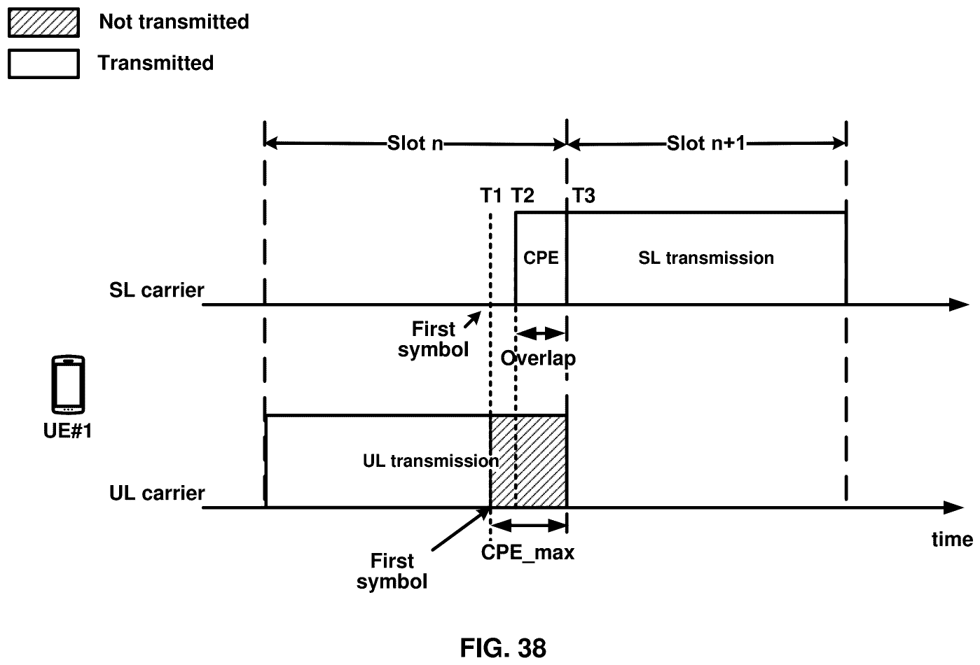

FIG. 38 shows an example of puncturing UL transmission overlapping with a SL CPE. As shown in this example, the UL transmission ends before T3, the start of the first slot (e.g., SL slot n+1), and the SL transmission starts from T3. The CPE of the sidelink transmission starts from T2, the CPE starting position in the second slot (e.g., SL slot n). The UL transmission overlaps in the second slot with the CPE of the SL transmission (e.g., from T2 to T3). In an embodiment, the UE determines a first symbol of the UL transmission, e.g., starting at T1. The first symbol may be based on the UL SCS/numerology. The UE may determine the first symbol (or T1) based on a period (e.g., a default or maximum CPE duration). For example, the period may be pre-defined and/or (pre-) configured, e.g., via RRC signaling. For example, the period may comprise the time interval between T1 and T3 (the start of the first OFDM symbol of the SL transmission without the CPE). The UE may determine T1 (or the first symbol of the UL transmission) based on the period. For example, T1 may be the earliest CPE starting position configured in the second slot for the SL transmission, that is overlapped with the UL transmission. As shown in FIG. 38, the UE may stop/end the UL transmission at/before T1 and/or before the first symbol. The UE may omit/drop/remove/puncture the UL transmission after T1/the first symbol (e.g., if the UL transmission has a lower priority than the CPE and/or the SL transmission). The UE may omit/drop/remove/puncture the UL transmission based on the period (e.g., the maximum CPE duration).

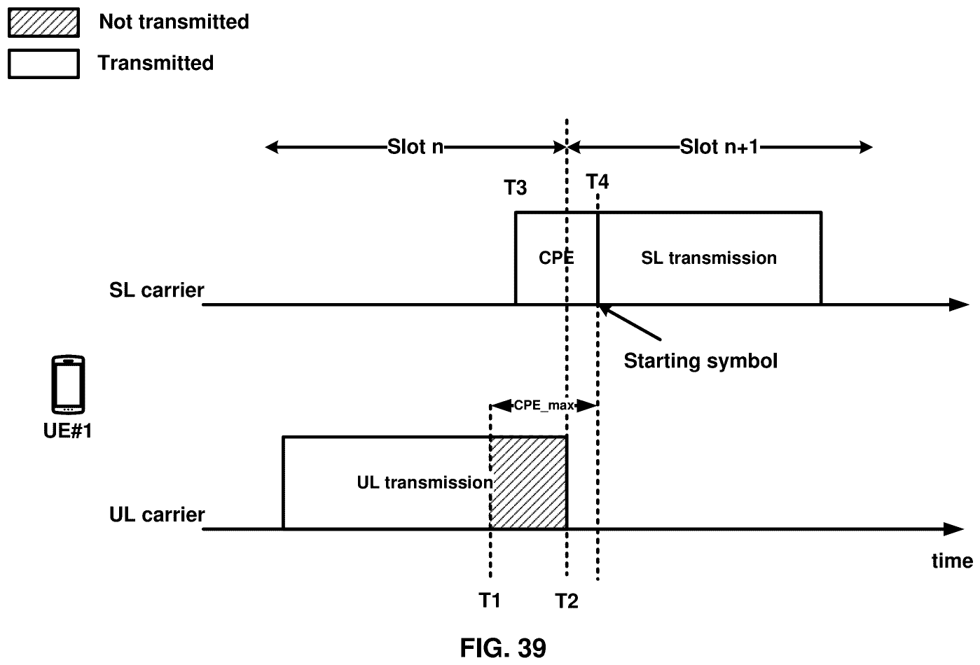

FIG. 39 shows an example of puncturing UL transmission overlapping with a SL CPE. As shown in this example, the UL transmission ends before T2, e.g., the end of the second slot (e.g., SL slot n). The SL transmission starts from T4 (e.g., a first starting symbol in SL slot n+1). The CPE of the sidelink transmission starts from T3, the CPE starting position in the second slot (e.g., SL slot n). The UL transmission overlaps in the second slot with the CPE of the SL transmission (e.g., from T3 to T2). In an embodiment, the UE determines a first symbol of the UL transmission, e.g., starting at T1. The first symbol may be based on the UL SCS/numerology. The UE may determine the first symbol (or T1) based on a period (e.g., a default or maximum CPE duration). For example, the period may be pre-defined and/or (pre-) configured, e.g., via RRC signaling. For example, the period may comprise the time interval between T1 and T4 (the start of the first OFDM symbol of the SL transmission without the CPE). The UE may determine T1 (or the first symbol of the UL transmission) based on the period. For example, T1 may be the earliest CPE starting position configured in the second slot for the SL transmission, that is overlapped with the UL transmission. As shown in FIG. 39, the UE may stop/end the UL transmission at/before T1 and/or before the first symbol. The UE may omit/drop/remove/puncture the UL transmission after T1/the first symbol. The UE may omit/drop/remove/puncture the UL transmission based on the period (e.g., the maximum CPE duration).

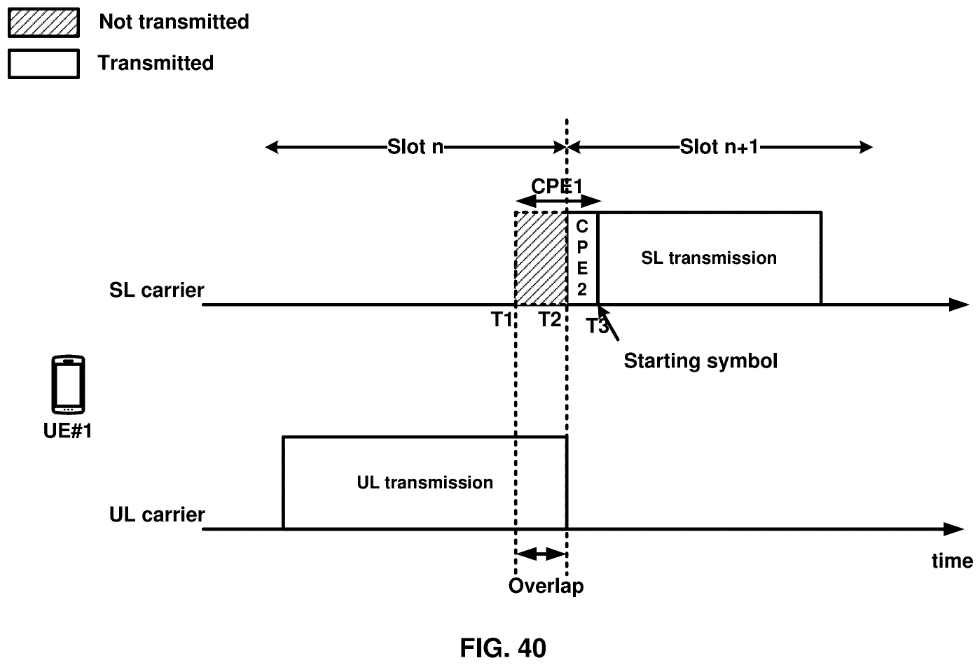

FIG. 40 shows an example of UL transmission overlapping with a SL CPE transmission. As shown in this example, the UL transmission ends before T2, e.g., the end of the second slot (e.g., SL slot n). The SL transmission starts from T3 (e.g., a first starting symbol in SL slot n+1). The first CPE (CPE1) of the sidelink transmission starts from T1, the CPE starting position in the second slot (e.g., SL slot n). The first CPE transmission (CPE1) in this example starts in the second slot and end in the first slot. The UL transmission overlaps in the second slot with the original CPE of the SL transmission (e.g., from T1 to T2). In an embodiment, the UE only transmits the UL transmission in the second slot, e.g., during the overlap period. In an embodiment, the UE drops/cancels the first CPE in response to the overlap (e.g., if the UL transmission has a higher priority than the CPE and/or the SL transmission). In an embodiment, the UE continues the LBT procedure after T1 and until T2 (end of the UL transmission). For example, if the LBT is successful at T2, the UE may transmit a second CPE of the first OFDM symbol of the SL transmission (e.g., CPE2), in the first slot (SL slot n+1). In an example, the COT continuity may still be maintained by transmitting CPE2. The UE may transmit the SL transmission starting from T3.

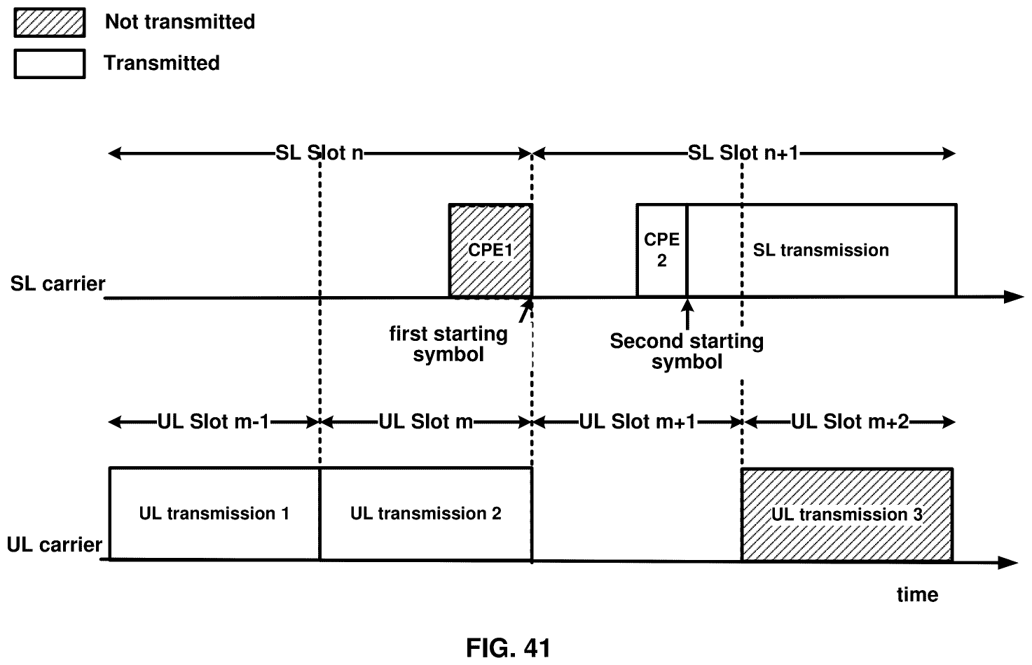

FIG. 41 shows an example of simultaneous UL and SL transmission with CPE. In this example, the UL SCS numerology is greater than (e.g., twice) the SL SCS/numerology. The SL transmission may be scheduled/configured in a first SL slot (SL slot n+1) from a first starting symbol. The SL transmission in SL slot n+1 may overlap with an UL transmission 3 in UL slot m+2. Based on the existing technology, the UE may only transmit the SL transmission and/or drops/cancels the UL transmission 3, e.g., since the SL transmission has a higher priority than the UL transmission 3. The first CPE (CPE1) of the SL transmission may be in a second SL slot (SL slot n) before the first slot. The first CPE may overlap with a second UL transmission (UL transmission 2) in a second UL slot (UL slot m). In an embodiment, the UE may drop/cancel the first CPE transmission in response to the overlap. For example, the UE may transmit the UL transmission 2 in UL slot m (SL slot n). For example, the UL transmission 2 may have a higher priority than the SL transmission and/or the first CPE. The UE may determine to transmit the SL transmission from aa second starting symbol in SL slot n+1. The UE may transmit a second CPE (CPE2) of the SL transmission before the second starting symbol. The second CPE may not overlap with an UL transmission. The UE may transmit the SL transmission and the second CPE in the first SL slot.

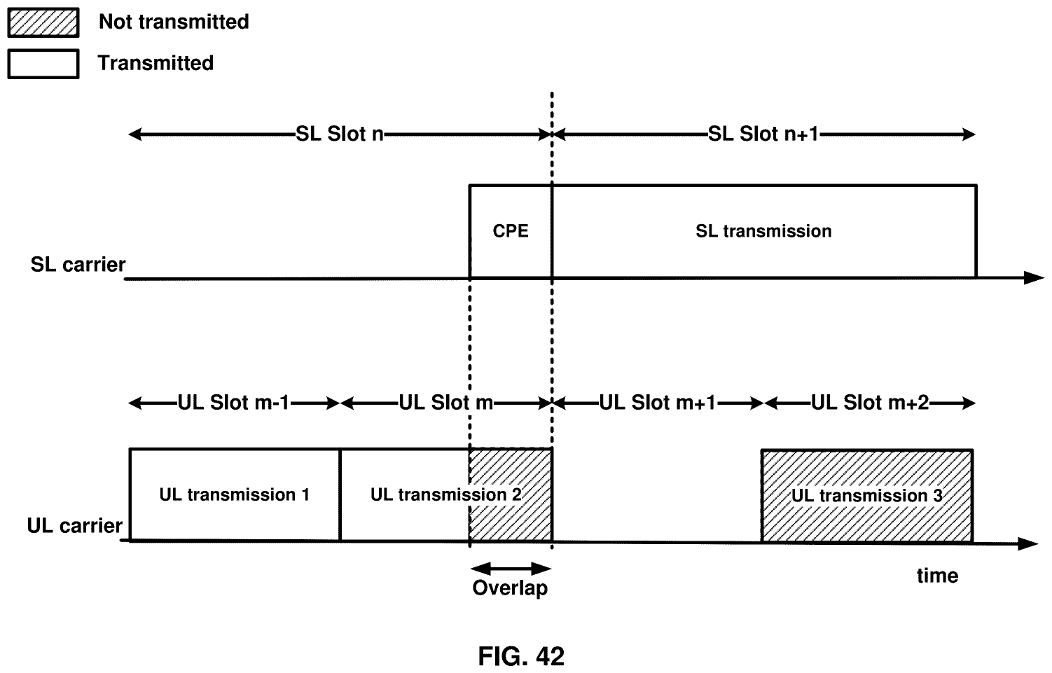

FIG. 42 shows an example of simultaneous UL and SL transmission with CPE. In this example, the UL SCS numerology is greater than (e.g., twice) the SL SCS/numerology. The SL transmission may be scheduled/configured in a first SL slot (SL slot n+1) from a first starting symbol. The SL transmission in SL slot n+1 may overlap with an UL transmission 3 in UL slot m+2. Based on the existing technology, the UE may only transmit the SL transmission and/or drops/cancels the UL transmission 3, e.g., since the SL transmission has a higher priority than the UL transmission 3. The CPE of the SL transmission may be in a second SL slot (SL slot n) before the first slot. The CPE may overlap with a second UL transmission (UL transmission 2) in a second UL slot (UL slot m). In an embodiment, the UE may omit/remove/puncture the second UL transmission during a period associated with the overlap. For example, the UL transmission 2 may have a lower priority than the SL transmission and/or the first CPE. T For example, the period may be the time interval that the second UL transmission overlaps with the CPE. For example, the period may be pre-defined duration at the end of the second UL transmission and/or the second UL slot.

In some embodiments, the UE may be capable of simultaneous UL and SL transmissions. In examples of FIG. 36 to FIG. 42, instead of dropping/removing/omitting/canceling/puncturing one more symbols of a transmission (e.g., SL CPE and/or UL transmission), the UE may reduce the corresponding transmission power.

In an example, a wireless device may receive a radio resource control (RRC) message (e.g., SIB 12 and/or RRCReconfiguration Sidelink) comprising a sidelink configuration parameter (e.g., sl-AccessConfigListDCI-2-1 and/or sl-AccessConfigListDCI-2-2) indicating one or more durations of cyclic prefix extension (CPE) for sidelink transmissions. For example, the sidelink configuration parameter may indicate a list of combinations of CPEs, CAPC, and/or SL channel access type (e.g., LBT type) applicable to one or more DCI formats scheduling the sidelink transmissions. For example, the sidelink configuration parameter may indicate one or more starting positions for CPE of a sidelink transmission in/within one or more symbols before a starting symbol of the sidelink transmission. The UE may determine the one or more durations of CPE (e.g., 16 μs, 25 μs, 34 μs, 43 μs, 52 μs, 61 μs, etc.) based on the one or more starting positions. The sidelink transmission may comprise PSSCH, PSCCH, PSFCH, and/or S-SSB.

The wireless device may determine to transmit a sidelink transmission in a first sidelink slot and/or a first CPE of the sidelink transmission in a second sidelink slot preceding the first sidelink slot. In response to a transmission of the first CPE overlapping with an uplink transmission in the second sidelink slot, the wireless device may determine a first symbol in the second sidelink slot based on the one or more durations of CPE. The wireless device may transmit in the second sidelink slot the uplink transmission until a start of the first symbol. The wireless device may transmit in the second sidelink slot the CPE after the start of the first symbol.

A wireless device may determine that a transmission of a cyclic prefix extension (CPE) of a sidelink transmission overlaps in time with an uplink transmission. In response to the overlap, the wireless device may end/terminate the uplink transmission before a start of the overlap. In response to the overlap, the wireless device may omit/eliminate/puncture the uplink transmission after a start of the overlap.

A wireless device may determine that a transmission of a cyclic prefix extension (CPE) of a sidelink transmission in a first slot overlaps with an uplink transmission in a second slot (immediately) preceding the first slot. In response to the overlap, the wireless device may end/terminate the uplink transmission before a start of the overlap. In response to the overlap, the wireless device may end/terminate the uplink transmission before an end of the second slot.

A wireless device may determine that a transmission of a cyclic prefix extension (CPE) of a sidelink transmission in a first slot overlaps with an uplink transmission in a second slot (immediately) preceding the first slot. In response to the overlap and during one or more symbols of the second slot, the wireless device may transmit at least one of the CPE and the uplink transmission. A number of the one or more symbols may be based on one or more durations of CPE.

The wireless device may receive a radio resource control (RRC) message comprising a sidelink configuration parameter indicating the one or more durations of cyclic prefix extension (CPE) for sidelink transmissions. The one or more durations of CPE comprises a predefined duration, the wireless device may determine the number of the one or more symbols based on the predefined duration. The wireless device may determine the one or more symbols based on a maximum duration among the one or more durations of CPE.

The wireless device may determine to transmit the sidelink transmission in the first slot. The wireless device may determine to transmit the CPE of the sidelink transmission in the second sidelink slot preceding the first sidelink slot. The CPE may comprise an extension of a first orthogonal frequency division multiplexing (OFDM) symbol allocated for the sidelink transmission in a time interval preceding the first OFDM symbol. The one or more symbols may be located at the end of the second slot, e.g., within/in one or more last symbols of the second slot. The one or more symbols may comprise a first symbol of the second slot, wherein the first symbol may be an earliest symbol of the one or more symbols. The wireless device may determine the first symbol based on the one or more durations of CPE. The wireless device may transmit, in the second slot, the uplink transmission until a start of the first symbol. The wireless device may transmit, in the second slot, the CPE of the sidelink transmission after a start of the first symbol.

The wireless device may transmit the CPE during at least one of the one or more symbols in the second slot. The wireless device may omit/puncture/remove the uplink transmission during the one or more symbols. For example, a priority of the CPE may be higher than a priority of the uplink transmission. For example, a priority of the sidelink transmission may be higher than a priority of the uplink transmission. The wireless device may transmit the uplink transmission during the one or more symbols in the second slot. The wireless device may omit/puncture/remove the transmission of CPE during the one or more symbols. The wireless device may transmit the sidelink transmission in the first slot. For example, a priority of the CPE may be lower than a priority of the uplink transmission. For example, a priority of the sidelink transmission may be lower than a priority of the uplink transmission.

The wireless device may transmit both the uplink transmission and the CPE in the second slot, based on a simultaneous transmission capability of the wireless device. The wireless device may reduce a transmission power of the CPE, based on a priority of the CPE being lower than a priority of the uplink transmission. The wireless device may not reduce a transmission power of the sidelink transmission. The wireless device may reduce a transmission power of the uplink transmission, based on a priority of the CPE being higher than a priority of the uplink transmission.

In an embodiment, the one or more durations of CPE may comprise a first duration of the CPE of the sidelink transmission. The wireless device may omit/puncture/remove the uplink transmission during the first duration. The wireless device may transmit to a base station an uplink control information indicating the first duration.

The first slot and the second slot may be sidelink (logical/physical) slots. The wireless device may receive a radio resource control (RRC) message comprising configuration parameters of a sidelink resource pool in a sidelink carrier. The configuration parameters may indicate sidelink slots, comprising the first slot and the second slot, for sidelink transmissions in the sidelink resource pool. The wireless device may select a first duration of the CPE of the sidelink transmission from the one or more durations of CPE. The CPE may be for/associated with a listen before talk (LBT) procedure of the first sidelink transmission.

A wireless device may receive a radio resource control (RRC) message comprising a sidelink configuration parameter indicating one or more durations of cyclic prefix extension (CPE) for sidelink transmissions. The wireless device may determine to transmit a sidelink transmission in a first slot and/or a first CPE of the sidelink transmission in a second slot preceding the first slot. In response to a transmission of the first CPE overlapping with an uplink transmission in the second slot, the wireless device may omit/remove one or more symbols of the uplink transmission in the second slot, wherein a number of the one or more symbols is based on the one or more durations of CPE. The wireless device may transmit in the second slot the uplink transmission without/excluding the one or more symbols; and/or the first CPE.

A wireless device may receive a radio resource control (RRC) message comprising a sidelink configuration parameter indicating one or more durations of cyclic prefix extension (CPE) for sidelink transmissions. The wireless device may determine to transmit a sidelink transmission in a first slot; and/or a first CPE of the sidelink transmission in a second slot preceding the first slot. In response to a transmission of the first CPE overlapping with an uplink transmission in the second slot, the wireless device may drop/cancel/skip/omit the transmission of the first CPE in the second slot. In response to a transmission of the first CPE overlapping with an uplink transmission in the second slot, the wireless device may transmit the UL transmission in the second slot. The wireless device may transmit, based on a successful listen before talk (LBT) procedure, the sidelink transmission in the first slot.

In an example, an index of a starting symbol of the sidelink transmission in the first slot may be greater than zero (e.g., sidelink physical/logical symbol).

A wireless device may receive an uplink grant indicating an uplink transmission via an uplink carrier; and/or a sidelink grant indicating a sidelink transmission in a first sidelink slot via a sidelink carrier, wherein a cyclic prefix extension (CPE) of the sidelink transmission overlaps, in a second slot preceding the first slot with the uplink transmission. The wireless device may determine a first power for the uplink transmission and/or a second power for the sidelink transmission. The wireless device may transmit, based on the overlap, the uplink transmission with the first power; and/or the sidelink transmission with the second power; and/or the CPE with a third power that is less than the second power.

A wireless device may receive a radio resource control (RRC) message comprising configuration parameters of a sidelink resource pool in a sidelink carrier. The configuration parameters may indicate a location of a starting symbol of a slot in the sidelink resource pool, and/or one or more starting positions for cyclic prefix extension (CPE) before a sidelink transmission in the sidelink resource pool. The wireless device may determine a first CPE, starting from an earliest starting position of the one or more starting positions, for a first sidelink transmission in a first sidelink slot of the sidelink carrier, wherein the first CPE is in the first sidelink slot. The wireless device may transmit the first CPE and the first sidelink transmission in the first sidelink slot.

A base station (e.g., gNB) may transmit to a wireless device, a radio resource control (RRC) message comprising configuration parameters of a sidelink resource pool in a sidelink carrier, the configuration parameters indicating one or more starting positions for cyclic prefix extension (CPE) of a sidelink transmission in the sidelink resource pool. The base station may transmit a sidelink grant indicating a sidelink transmission in a first sidelink slot, and/or an uplink grant indicating an uplink transmission overlapping with a second sidelink slot preceding/before the first sidelink slot. The uplink transmission may end before an earliest CPE starting position of the one or more starting positions, before the sidelink transmission. The base station may receive an UL transport block via the uplink transmission and/or a SL acknowledgement via a PUCCH.

A wireless device may receive a radio resource control (RRC) message comprising configuration parameters of a sidelink resource pool in a sidelink carrier, the configuration parameters indicating one or more durations of cyclic prefix extension (CPE) for sidelink transmissions in the sidelink resource pool. The wireless device may determine a first duration, of the one or more durations, of a first CPE for a first sidelink transmission in a first sidelink slot of the sidelink carrier. For example, the first duration may overlap, in a second sidelink slot preceding the first sidelink slot, with an uplink transmission in an uplink carrier. The wireless device may determine based on a second duration, of the one or more durations, prior to the first sidelink transmission, a third duration overlapping with the uplink transmission in the second slot. The wireless device may transmit during the third duration, at least one of the first CPE and the uplink transmission in the second sidelink slot. The wireless device may transmit only the first CPE during the overlap in the second sidelink slot. The wireless device may omit the uplink transmission based on the overlap, e.g., during a duration comprising the overlap in time. The wireless device may omit the uplink transmission for a CPE duration. The CPE duration may be predefined/preconfigured. The CPE duration may be a maximum duration of the one or more CPEs indicated by the configuration parameters.

The wireless device may transmit only the uplink transmission during the overlap in the second sidelink slot. The wireless device may omit/cancel/remove/drop the first CPE based on the overlap, e.g., during the overlap in the second sidelink slot. The wireless device may transmit the first sidelink transmission in the first sidelink slot. The wireless device may reduce a transmission power for the uplink transmission, based on the first CPE having a higher priority than the uplink transmission. The wireless device may reduce a transmission power for the first CPE, based on the uplink transmission having a higher priority than the first CPE. The wireless device may not reduce a transmission power for the first sidelink transmission.

An example method comprising: determining, by a wireless device, a transmission of a cyclic prefix extension (CPE) of a sidelink transmission overlaps with an uplink transmission; and in response to the overlap, ending the uplink transmission before a start of the overlap.

An example method comprising: determining, by a wireless device, a transmission of a cyclic prefix extension (CPE) of a sidelink transmission in a first slot overlaps with an uplink transmission in a second slot preceding the first slot; and in response to the overlap, ending the uplink transmission before a start of the overlap.

An example method comprising: receiving, by a wireless device, a radio resource control (RRC) message comprising a sidelink configuration parameter indicating one or more durations of cyclic prefix extension (CPE) for sidelink transmissions; determining to transmit: a sidelink transmission in a first sidelink slot; and a first CPE of the sidelink transmission in a second sidelink slot preceding the first sidelink slot; in response to a transmission of the first CPE overlapping with an uplink transmission in the second sidelink slot, determining a first symbol in the second sidelink slot based on the one or more durations of CPE; and transmitting in the second sidelink slot: the uplink transmission until a start of the first symbol; and the CPE after the start of the first symbol.

An example method comprising: determining, by a wireless device, a transmission of a cyclic prefix extension (CPE) of a sidelink transmission in a first slot overlaps with an uplink transmission in a second slot preceding the first slot; and in response to the overlap and during one or more symbols of the second slot, transmitting at least one of the CPE and the uplink transmission, wherein a number of the one or more symbols is based on one or more durations of CPE.

Any one of the above example methods, further comprising receiving a radio resource control (RRC) message comprising a sidelink configuration parameter indicating the one or more durations of cyclic prefix extension (CPE) for sidelink transmissions.

Any one of the above example methods, wherein the one or more durations of CPE comprises a predefined duration.

Any one of the above example methods, further comprising determining the number of the one or more symbols based on the predefined duration.

Any one of the above example methods, further comprising determining the one or more symbols based on a maximum duration among the one or more durations of CPE.

Any one of the above example methods, further comprising determining to transmit the sidelink transmission in the first slot.

Any one of the above example methods, further comprising determining to transmit the CPE of the sidelink transmission in the second sidelink slot preceding the first sidelink slot.

Any one of the above example methods, wherein the CPE comprises an extension of a first orthogonal frequency division multiplexing (OFDM) symbol allocated for the sidelink transmission in a time interval preceding the first OFDM symbol.

Any one of the above example methods, wherein the one or more symbols are located at the end of the second slot.

Any one of the above example methods, wherein the one or more symbols comprise a first symbol of the second slot, wherein the first symbol is an earliest symbol of the one or more symbols.

Any one of the above example methods, further comprising determining the first symbol based on the one or more durations of CPE.

Any one of the above example methods, further comprising transmitting, in the second slot, the uplink transmission until a start of the first symbol.

Any one of the above example methods, further comprising transmitting, in the second slot, the CPE of the sidelink transmission after a start of the first symbol.

Any one of the above example methods, further comprising transmitting the CPE during at least one of the one or more symbols in the second slot.

Any one of the above example methods, further comprising omitting the uplink transmission during the one or more symbols.

Any one of the above example methods, wherein a priority of the CPE is higher than a priority of the uplink transmission.

Any one of the above example methods, wherein a priority of the sidelink transmission is higher than a priority of the uplink transmission.

Any one of the above example methods, further comprising transmitting the uplink transmission during the one or more symbols in the second slot.

Any one of the above example methods, further comprising omitting the transmission of CPE during the one or more symbols.

Any one of the above example methods, further comprising transmitting the sidelink transmission in the first slot.

Any one of the above example methods, wherein a priority of the CPE is lower than a priority of the uplink transmission.

Any one of the above example methods, wherein a priority of the sidelink transmission is lower than a priority of the uplink transmission.

Any one of the above example methods, further comprising transmitting both the uplink transmission and the CPE in the second slot, based on a simultaneous transmission capability of the wireless device.

Any one of the above example methods, further comprising reducing a transmission power of the CPE, based on a priority of the CPE being lower than a priority of the uplink transmission.

Any one of the above example methods, further comprising not reducing a transmission power of the sidelink transmission.

Any one of the above example methods, further comprising reducing a transmission power of the uplink transmission, based on a priority of the CPE being higher than a priority of the uplink transmission.

Any one of the above example methods, wherein the one or more durations of CPE comprise a first duration of the CPE of the sidelink transmission.

Any one of the above example methods, further comprising omitting the uplink transmission during the first duration.

Any one of the above example methods, further comprising transmitting to a base station an uplink control information indicating the first duration.

Any one of the above example methods, wherein the first slot and the second slot are sidelink slots.

Any one of the above example methods, further comprising receiving a radio resource control (RRC) message comprising configuration parameters of a sidelink resource pool in a sidelink carrier, the configuration parameters indicating sidelink slots, comprising the first slot and the second slot, for sidelink transmissions in the sidelink resource pool.

Any one of the above example methods, further comprising selecting a first duration of the CPE of the sidelink transmission from the one or more durations of CPE.

Any one of the above example methods, wherein the CPE is for a listen before talk (LBT) procedure of the first sidelink transmission.

An example method comprising: receiving, by a wireless device, a radio resource control (RRC) message comprising a sidelink configuration parameter indicating one or more durations of cyclic prefix extension (CPE) for sidelink transmissions; determining to transmit: a sidelink transmission in a first slot; and a first CPE of the sidelink transmission in a second slot preceding the first slot; in response to a transmission of the first CPE overlapping with an uplink transmission in the second slot: dropping the transmission of the first CPE in the second slot; and transmitting the UL transmission in the second slot; and transmitting, based on a successful listen before talk (LBT) procedure, the sidelink transmission in the first slot.

The above example, wherein an index of a starting symbol of the sidelink transmission in the first slot is greater than zero.

An example method comprising: receiving, by a wireless device: an uplink grant indicating an uplink transmission via an uplink carrier; and a sidelink grant indicating a sidelink transmission in a first sidelink slot via a sidelink carrier, wherein a cyclic prefix extension (CPE) of the sidelink transmission overlaps, in a second slot preceding the first slot with the uplink transmission; determining: a first power for the uplink transmission; and a second power for the sidelink transmission; transmitting, based on the overlap: the uplink transmission with the first power; the sidelink transmission with the second power; and the CPE with a third power that is less than the second power.

A method comprising: receiving, by a wireless device, a radio resource control (RRC) message comprising configuration parameters of a sidelink resource pool in a sidelink carrier, the configuration parameters indicating: a location of a starting symbol of a slot in the sidelink resource pool; and one or more starting positions for cyclic prefix extension (CPE) before a sidelink transmission in the sidelink resource pool; determining a first CPE, starting from an earliest starting position of the one or more starting positions, for a first sidelink transmission in a first sidelink slot of the sidelink carrier, wherein the first CPE is in the first sidelink slot; and transmitting the first CPE and the first sidelink transmission in the first sidelink slot.

A method comprising: transmitting, by a base station to a wireless device, a radio resource control (RRC) message comprising configuration parameters of a sidelink resource pool in a sidelink carrier, the configuration parameters indicating one or more starting positions for cyclic prefix extension (CPE) of a sidelink transmission in the sidelink resource pool; transmitting: a sidelink grant indicating a sidelink transmission in a first sidelink slot; and an uplink grant indicating an uplink transmission overlapping with a second sidelink slot preceding the first sidelink slot, wherein the uplink transmission ends before an earliest CPE starting position of the one or more starting positions, before the sidelink transmission; and receiving a transport block via the uplink transmission.

What is claimed is:

1. A method comprising:
receiving, by a wireless device, one or more radio resource control (RRC) messages comprising one or more configuration parameters, indicating:
a plurality of cyclic prefix extension (CPE) starting positions for physical sidelink shared channel (PSSCH) transmissions on a sidelink bandwidth part (BWP) with a first numerology, wherein a plurality of CPE durations are based on the plurality of CPE starting positions; and
a plurality of priorities for the PSSCH transmissions on the sidelink BWP, wherein one or more CPE starting positions, of the plurality of CPE starting positions, are configured for each priority of the plurality of priorities;
receiving a physical downlink control channel (PDCCH) indicating a starting symbol of a PSSCH transmission on the sidelink BWP;
determining, for the PSSCH transmission with a first priority of the plurality of priorities, a first symbol based on a first CPE duration, wherein:
the first symbol is before the first CPE duration from the starting symbol of the PSSCH transmission;
the first CPE duration is based on a first CPE starting position, of the plurality of CPE starting positions, that is pre-defined for the PSSCH transmissions with the plurality of priorities; and
the first symbol is after a processing time from a last symbol of the PDCCH; and
transmitting a sidelink transmission comprising:
the PSSCH transmission; and
a CPE with a second CPE duration of the plurality of CPE durations, wherein the second CPE duration is based on a second CPE starting position, of the plurality of CPE starting positions, configured for the first priority.

2. The method of claim 1, wherein the first CPE starting position is associated with the first numerology among a plurality of numerologies.

3. The method of claim 1, wherein the first CPE duration is greater than or equal to each CPE duration of the plurality of CPE durations.

4. The method of claim 1, wherein the CPE is a cyclic prefix extension of the starting symbol of the PSSCH transmission.

5. The method of claim 1, wherein each CPE duration, of the plurality of CPE durations, is based on a corresponding CPE starting position, of the plurality of CPE starting positions.

6. The method of claim 1, further comprising selecting the second CPE starting position from one or more first CPE starting positions, of the plurality of CPE starting positions, configured for the first priority.

7. The method of claim 1, wherein the PDCCH comprises downlink control signal (DCI) comprising a sidelink grant indicating the starting symbol of the PSSCH transmission.

8. A wireless device comprising:
one or more processors; and
memory storing instructions that, when executed by the one or more processors, cause the wireless device to:
receive one or more radio resource control (RRC) messages comprising one or more configuration parameters, indicating:
a plurality of cyclic prefix extension (CPE) starting positions for physical sidelink shared channel (PSSCH) transmissions on a sidelink bandwidth part (BWP) with a first numerology, wherein a plurality of CPE durations are based on the plurality of CPE starting positions; and
a plurality of priorities for the PSSCH transmissions on the sidelink BWP, wherein one or more CPE starting positions, of the plurality of CPE starting positions, are configured for each priority of the plurality of priorities;
receive a physical downlink control channel (PDCCH) indicating a starting symbol of a PSSCH transmission on the sidelink BWP;
determine, for the PSSCH transmission with a first priority of the plurality of priorities, a first symbol based on a first CPE duration, wherein:
the first symbol is before the first CPE duration from the starting symbol of the PSSCH transmission;
the first CPE duration is based on a first CPE starting position, of the plurality of CPE starting positions, that is pre-defined for the PSSCH transmissions with the plurality of priorities; and
the first symbol is after a processing time from a last symbol of the PDCCH; and
transmit a sidelink transmission comprising:
the PSSCH transmission; and
a CPE with a second CPE duration of the plurality of CPE durations, wherein the second CPE duration is based on a second CPE starting position, of the plurality of CPE starting positions, configured for the first priority.

9. The wireless device of claim 8, wherein the first CPE starting position is associated with the first numerology among a plurality of numerologies.

10. The wireless device of claim 8, wherein the first CPE duration is greater than or equal to each CPE duration of the plurality of CPE durations.

11. The wireless device of claim 8, wherein the CPE is a cyclic prefix extension of the starting symbol of the PSSCH transmission.

12. The wireless device of claim 8, wherein each CPE duration, of the plurality of CPE durations, is based on a corresponding CPE starting position, of the plurality of CPE starting positions.

13. The wireless device of claim 8, wherein the instructions further cause the wireless device to select the second CPE starting position from one or more first CPE starting positions, of the plurality of CPE starting positions, configured for the first priority.

14. The wireless device of claim 8, wherein the PDCCH comprises downlink control signal (DCI) comprising a sidelink grant indicating the starting symbol of the PSSCH transmission.

15. A non-transitory computer-readable medium comprising instructions that, when executed by one or more processors of a wireless device, cause the wireless device to:
receive one or more radio resource control (RRC) messages comprising one or more configuration parameters, indicating:
a plurality of cyclic prefix extension (CPE) starting positions for physical sidelink shared channel (PSSCH) transmissions on a sidelink bandwidth part (BWP) with a first numerology, wherein a plurality of CPE durations are based on the plurality of CPE starting positions; and
a plurality of priorities for the PSSCH transmissions on the sidelink BWP, wherein one or more CPE starting positions, of the plurality of CPE starting positions, are configured for each priority of the plurality of priorities;
receive a physical downlink control channel (PDCCH) indicating a starting symbol of a PSSCH transmission on the sidelink BWP;
determine, for the PSSCH transmission with a first priority of the plurality of priorities, a first symbol based on a first CPE duration, wherein:
the first symbol is before the first CPE duration from the starting symbol of the PSSCH transmission;
the first CPE duration is based on a first CPE starting position, of the plurality of CPE starting positions, that is pre-defined for the PSSCH transmissions with the plurality of priorities; and
the first symbol is after a processing time from a last symbol of the PDCCH; and
transmit a sidelink transmission comprising:
the PSSCH transmission; and
a CPE with a second CPE duration of the plurality of CPE durations, wherein the second CPE duration is based on a second CPE starting position, of the plurality of CPE starting positions, configured for the first priority.

16. The non-transitory computer-readable medium of claim 15, wherein the first CPE starting position is associated with the first numerology among a plurality of numerologies.

17. The non-transitory computer-readable medium of claim 15, wherein the first CPE duration is greater than or equal to each CPE duration of the plurality of CPE durations.

18. The non-transitory computer-readable medium of claim 15, wherein the CPE is a cyclic prefix extension of the starting symbol of the PSSCH transmission.

19. The non-transitory computer-readable medium of claim 15, wherein each CPE duration, of the plurality of CPE durations, is based on a corresponding CPE starting position, of the plurality of CPE starting positions.

20. The non-transitory computer-readable medium of claim 15, wherein the instructions further cause the wireless device to select the second CPE starting position from one or more first CPE starting positions, of the plurality of CPE starting positions, configured for the first priority.
